(19) United States
(12) Patent Application Publication
(10) Pub. No.: US 2024/0051822 A1
(43) Pub. Date: Feb. 15, 2024

(54) SYNGAS COMPOSITIONS

(71) Applicant: Eastman Chemical Company, Kingpsort, TN (US)

(72) Inventors: Bruce Roger DeBruin, Gray, TN (US); Michael Paul Ekart, Kingsport, TN (US); William Lewis Trapp, Kingsport, TN (US)

(73) Assignee: Eastman Chemical Company, Kingsport, TN (US)

(21) Appl. No.: 17/996,689

(22) PCT Filed: Apr. 13, 2021
(86) PCT No.: PCT/US2021/027009

§ 371 Date: Oct. 20, 2022

Related U.S. Application Data
(60) Provisional application No. 63/008,913, filed on Apr. 13, 2020.
(60) Provisional application No. 63/008,915, filed on Apr. 13, 2020.
(60) Provisional application No. 63/008,917, filed on Apr. 13, 2020.
(60) Provisional application No. 63/008,918, filed on Apr. 13, 2020.
(60) Provisional application No. 63/008,921, filed on Apr. 13, 2020.

(51) Int. Cl. C01B 3/36

(52) U.S. Cl. CPC C01B 3/36; C01B 2203/1211; C01B 2203/025; C01B 2203/1628; C01B 2203/1614

(57) ABSTRACT

Raw synthesis gas (syngas) compositions are provided herein. The syngas compositions are generally formed from a partial oxidation reaction with a plastic feedstock within a PDX gasifier. The raw syngas compositions may by characterized by a desirable ratio of carbon monoxide to hydrogen and/or less impurities than syngas compositions formed using other feedstocks, such as natural gas or coal.

### BACKGROUND

Synthesis gas, also known as syngas, generally is a mixture of carbon monoxide and hydrogen that can be used to produce a wide range of chemicals, such as ammonia, methanol, and synthetic hydrocarbons. Syngas can be produced from many sources, including natural gas, coal, and biomass, by reaction with steam (steam reforming), carbon dioxide (dry reforming), or oxygen (partial oxidation). Currently fossil fuels are the predominant feedstock for syngas production. However, fossil fuel usage is increasingly disfavored as industries strive to develop greener alternatives. Moreover, fossil fuel feedstocks can produce raw syngas comprising high levels of sulfur, mercury, and/or other materials that collect in slag.

Waste materials, especially non-biodegradable waste materials, can negatively impact the environment when disposed of in landfills after a single use. Thus, from an environmental standpoint, it is desirable to recycle as much waste material as possible. However, there still exist streams of low value waste that are nearly impossible or economically unfeasible to recycle with conventional recycling technologies. In addition, some conventional recycling processes produce waste streams that are themselves not economically feasible to recover or recycle, resulting in additional waste streams that must be disposed of or otherwise handled.

Thus, a need exists for alternative feedstocks from which syngas can be produced. It would also be beneficial for such alternative feedstocks to include recycled materials thereby reducing the need to landfill such materials, while simultaneously generating raw syngas having reduced levels of materials typically found in fossil fuels, such as sulfur, mercury, and other materials.

### SUMMARY

In one or more aspects, the present technology concerns a raw syngas composition.

In one particular aspect, the raw syngas composition comprises: not more than 1000 ppmw sulfur, at least 1000 ppmw of soot and not more than 50,000 ppmw of soot; and either (a) not more than 10% by volume carbon dioxide on a dry basis or (b) not more than 5000 ppmw by volume methane on a dry basis.

In another aspect, the raw syngas composition comprises: a molar ratio of hydrogen (H₂) to carbon monoxide of 0.7 to 1.5 and not more than 11% by volume carbon dioxide on a dry basis.

In yet another aspect, the raw syngas composition comprises not more than 1000 ppm by volume methane on a dry basis, and either (a) not more than 1000 ppmw sulfur or (b) not more than 50,000 ppmw soot.

In still another aspect, the raw syngas composition comprises a molar ratio of hydrogen (H₂) to carbon monoxide of 0.7 to 1.5, not more than 200 ppmw halides, and not more than 0.01 ppmw mercury (Hg) and/or not more than 1 ppmw arsine (AsH₃).

In another aspect, the raw syngas composition comprises not more than 1000 ppm by volume of methane on a dry basis, and at least 10 ppmw and not more than 200 ppmw antimony on a dry basis and/or at least 5 ppmw and not more than 40,000 ppmw titanium on a dry basis.

In still another aspect, the raw syngas composition comprises least 1000 ppmw of soot and not more than 50,000 of soot on a dry basis, at least 10 ppmw and not more than 200 ppmw antimony on a dry basis and/or at least 5 ppmw and not more than 40,000 ppmw titanium on a dry basis, and not more than 200 ppmw halides.

In yet another aspect, the raw syngas composition comprises a molar ratio of hydrogen (H₂) to carbon monoxide of 0.7 to 1.5, at least 10 ppmw and not more than 200 ppmw antimony on a dry basis and/or at least 5 ppmw and not more than 40,000 ppmw titanium on a dry basis, and not more than 200 ppmw halides.

In a further aspect, the present technology concerns a method of forming a raw syngas composition from a plastic material. The method comprises introducing a feedstock comprising the plastic material and molecular oxygen into a partial oxidation (PDX) gasifier. A partial oxidation reaction is performed, and optionally, one or more side reactions, within the gasifier by reacting at least a portion of the plastic material and molecular oxygen to form a raw syngas composition according to any embodiment described herein.

### BRIEF DESCRIPTION OF THE DRAWINGS

FIG. 1 is a block flow diagram illustrating the main steps of a process and facility for chemically recycling waste plastic according to embodiments of the present technology;

FIG. 2 is a block flow diagram illustrating a separation process and zone for separating mixed plastic waste according to embodiments of the present technology;

FIG. 3 is a block flow diagram illustrating an exemplary liquification zone of the chemical recycling facility shown in FIG. 1 according to embodiments of the present technology;

FIG. 4 is a schematic diagram of a POx reactor according to embodiments of the present technology;

FIG. 5A is a schematic diagram of a POx reactor in which an atomization fluid is introduced into the plastic-containing feedstock before the feedstock is fed into the gasification zone;

FIG. 5B is a schematic diagram of a POx reactor in which an atomization fluid is separately added to the gasification zone of the reactor;

FIG. 6 is a schematic diagram of a POx reactor equipped with a gasifier feed injector assembly through which gasification feedstock and oxidizer gas streams may be introduced into the gasifier reactor vessel;

FIG. 7 is a schematic diagram of a feed injector assembly comprising a multi-lumen injector nozzle;

FIG. 8A is a schematic diagram of an exemplary injector assembly comprising inner and outer nozzles, with the inner nozzle carrying a liquid gasification feedstock stream;

FIG. 8B is a is a schematic diagram of an exemplary injector assembly comprising inner and outer nozzles having tapered end segments;

FIG. 8C is a is a schematic diagram of an exemplary injector assembly comprising inner and outer nozzles, the inner nozzle comprising a screen fixed to the inner nozzle end segment; and

FIG. 9 is a schematic diagram illustrating various definitions of the term “separation efficiency” as used herein.

### DETAILED DESCRIPTION

In an embodiment or in combination with any embodiment mentioned herein, a large-scale facility capable of chemically recycling a variety of waste materials, including various types of plastics, in an economically viable manner is provided. In one or more embodiments, such a facility is capable of minimizing the production of further waste streams to both enhance efficiency of production and minimize environmental impact, while still providing commercially-valuable end products, including synthesis gas (syngas) produced by partial oxidation gasification.

When a numerical sequence is indicated, it is to be understood that each number is modified the same as the first number or last number in the numerical sequence or in the sentence, e.g. each number is “at least,” or “up to” or “not more than” as the case may be; and each number is in an “or” relationship. For example, “at least 10, 20, 30, 40, 50, 75 wt. % . . . ” means the same as “at least 10 wt. %, or at least 20 wt. %, or at least 30 wt. %, or at least 40 wt. %, or at least 50 wt. %, or at least 75 wt. %,” etc.; and “not more than 90 wt. %, 85, 70, 60 . . . ” means the same as “not more than 90 wt. %, or not more than 85 wt. %, or not more than 70 wt. % . . . .” etc.; and “at least 1%, 2%, 3%, 4%, 5%, 6%, 7%, 8%, 9% or 10% by weight . . . ” means the same as “at least 1 wt. %, or at least 2 wt. %, or at least 3 wt. % . . . ” etc.; and “at least 5, 10, 15, 20 and/or not more than 99, 95, 90 weight percent” means the same as “at least 5 wt. %, or at least 10 wt. %, or at least 15 wt. % or at least 20 wt. % and/or not more than 99 wt. %, or not more than 95 wt. %, or not more than 90 weight percent . . . ” etc.; or “at least 0.689, 3.48, 5.17 MPa (100, 500, 750 psi) . . . ” means the same as “at least 0.689 MPa (100 psi), or at least 3.48 MPa (500 psi), or at least 5.17 MPa (750 psi) . . . ” etc.; and “at or below seven millimeters (7 mm), six millimeters (6 mm), five millimeters (5 mm), at a distance of 0.25, 0.5, 0.75, or 1 m (meter) . . . ” means the same as “at or below seven millimeters (7 mm), or at or below six millimeters (6 mm), or at or below five millimeters (5 mm), at a distance of 0.25 meters, or at a distance of 0.5 meters, or at a distance of 0.75 meters, or at a distance of 1 m (meter) . . . ” etc.; and “ . . . not more than 50,000 (20,000, or 15,000) ppmw . . . ” means the same as “ . . . not more than 50,000 ppmw, or not more than 20,000 ppmw, or not more than 15,000 ppmw . . . .” etc.

All concentrations or amounts are by weight unless otherwise stated.

### Overall Chemical Recycling Facility

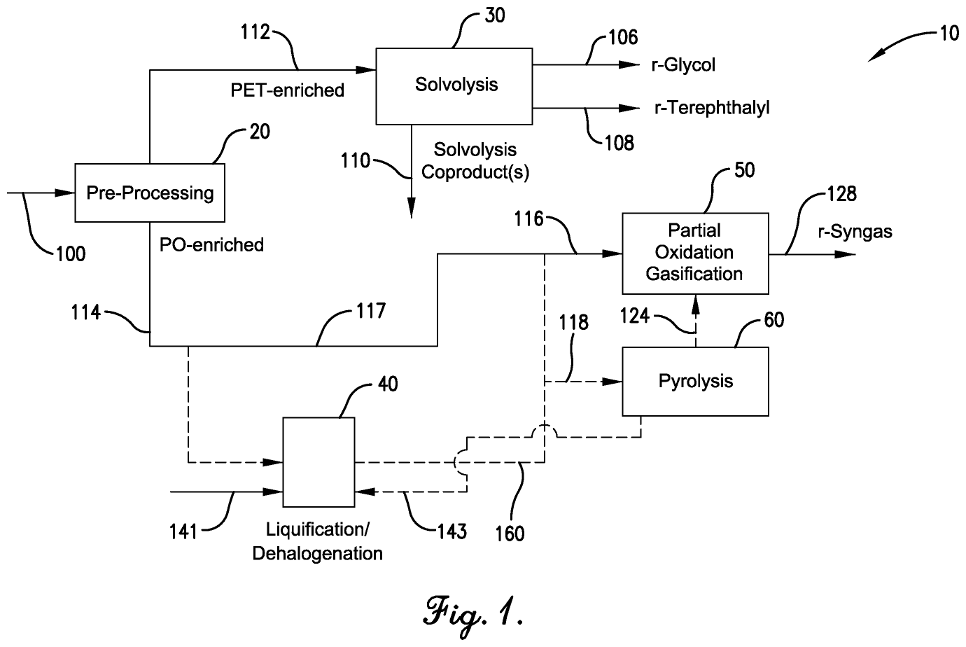

Turning now to FIG. 1, the main steps of a process for chemically recycling waste plastic in a chemical recycling facility 10 are shown. It should be understood that FIG. 1 depicts one exemplary embodiment of the present technology. Certain features depicted in FIG. 1 may be omitted and/or additional features described elsewhere herein may be added to the system depicted in FIG. 1.

As shown in FIG. 1, these steps generally include a pre-processing step/facility 20, and at least one (or at least two or more) of a solvolysis step/facility 30, a partial oxidation (PDX) gasification step/facility 50, and a pyrolysis step/facility 60. Although shown as including all of these steps or facilities, it should be understood that a chemical recycling process and facility according to one or more embodiments of the present technology can include at least two, three, four, five, or all of these steps/facilities in various combinations for the chemical recycling of plastic waste and, in particular, mixed plastic waste. Chemical recycling processes and facilities as described herein may be used to convert waste plastic to recycle content products or chemical intermediates used to form a variety of end use materials. The waste plastic fed to the chemical recycling facility/process can be mixed plastic waste (MPW), pre-sorted waste plastic, and/or pre-processed waste plastic.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen and carbon monoxide) that are useful by themselves and/or are useful as feedstocks to another chemical production process or processes. A “chemical recycling facility,” is a facility for producing a recycle content product via chemical recycling of waste plastic. As used herein, the terms “recycle content” and “r-content” mean being or comprising a composition that is directly and/or indirectly derived from waste plastic.

As used herein, the term “directly derived” means having at least one physical component originating from waste plastic, while “indirectly derived” means having an assigned recycle content that i) is attributable to waste plastic, but ii) that is not based on having a physical component originating from waste plastic.

Chemical recycling facilities are not mechanical recycling facilities. As used herein, the terms “mechanical recycling” and “physical recycling” refer to a recycling process that includes a step of melting waste plastic and forming the molten plastic into a new intermediate product (e.g., pellets or sheets) and/or a new end product (e.g., bottles). Generally, mechanical recycling does not substantially change the chemical structure of the plastic being recycled. In one embodiment or in combination with any of the mentioned embodiments, the chemical recycling facilities described herein may be configured to receive and process waste streams from and/or that are not typically processable by a mechanical recycling facility.

Although described herein as being part of a single chemical recycling facility, it should be understood that one or more of the preprocessing facility 20, the solvolysis facility 30, the pyrolysis facility 60, and the partial oxidation (PDX) gasification facility 50 may be located in a different geographical location and/or be operated by a different commercial entity. Each of the preprocessing facility 20, the solvolysis facility 30, the pyrolysis facility 60, and the partial oxidation (PDX) gasification facility 50 may be operated by the same entity, while, in other cases, one or more of the preprocessing facility 20, the solvolysis facility 30, the pyrolysis facility 60, and the partial oxidation (PDX) gasification facility 50 may be operated by a different commercial entity.

In an embodiment or in combination with any embodiment mentioned herein, the chemical recycling facility 10 may be a commercial-scale facility capable of processing significant volumes of mixed plastic waste. As used herein, the term “commercial scale facility” refers to a facility having an average annual feed rate of at least 500 pounds per hour, averaged over one year. The average feed rate to the chemical recycling facility (or to any one of the preprocessing facility 20, the solvolysis facility 30, the pyrolysis facility 60, and the PDX gasification facility 50) can be at least 750, at least 1,000, at least 1,500, at least 2,000, at least 2,500, at least 3,000, at least 3,500, at least 4,000, at least 4,500, at least 5,000, at least 5,500, at least 6,000, at least 6,500, at least 7,500, at least 10,000, at least 12,500, at least 15,000, at least 17,500, at least 20,000, at least 22,500, at least 25,000, at least 27,500, at least 30,000 or at least 32,500 pounds per hour and/or not more than 1,000,000, not more than 750,000, not more than 500,000, not more than 450,000, not more than 400,000, not more than 350,000, not more than 300,000, not more than 250,000, not more than 200,000, not more than 150,000, not more than 100,000, not more than 75,000, not more than 50,000, or not more than 40,000 pounds per hour. When a facility includes two or more feed streams, the average annual feed rate is determined based on the combined weight of the feed streams.

Additionally, it should be understood that each of the preprocessing facility 20, the solvolysis facility 30, the pyrolysis facility 60, and the PDX gasification facility 50 may include multiple units operating in series or parallel. For example, the pyrolysis facility 60 may include multiple pyrolysis reactors/units operating in parallel and each receiving a feed comprising waste plastic. When a facility is made up of multiple individual units, the average annual feed rate to the facility is calculated as the sum of the average annual feed rates to all of the common types of units within that facility.

Additionally, in an embodiment or in combination with any embodiment mentioned herein, the chemical recycling facility 10 (or any one of the preprocessing facility 20, the solvolysis facility 30, the pyrolysis facility 60, and the PDX gasification facility 50) may be operated in a continuous manner. Additionally, or in the alternative, at least a portion of the chemical recycling facility 10 (or any of the preprocessing facility 20, the solvolysis facility 30, the pyrolysis facility 60, and the PDX gasification facility 50) may be operated in a batch or semi-batch manner. In some cases, the facility may include a plurality of tanks between portions of a single facility or between two or more different facilities to manage inventory and ensure consistent flow rates into each facility or portion thereof.

In addition, two or more of the facilities shown in FIG. 1 may also be co-located with one another. In an embodiment or in combination with any embodiment mentioned herein, at least two, at least three, at least four, at least five, at least six, or all of the facilities may be co-located. As used herein, the term “co-located” refers to facilities in which at least a portion of the process streams and/or supporting equipment or services are shared between the two facilities. When two or more of the facilities shown in FIG. 1 are co-located, the facilities may meet at least one of the following criteria (i) through (v): (i) the facilities share at least one non-residential utility service; (ii) the facilities share at least one service group; (iii) the facilities are owned and/or operated by parties that share at least one property boundary; (iv) the facilities are connected by at least one conduit configured to carry at least one process material (e.g., solid, liquid and/or gas fed to, used by, or generated in a facility) from one facility to another; and (v) the facilities are within 64 km (40 miles), within 56 km (35 miles), within 48 km (30 miles), within 32 km (20 miles), within 24 km (15 miles), within 19 km (12 miles), within 16 km (10 miles), within 13 km (8 miles), within 8 km (5 miles), within 3.2 km (2 miles), or within 1.6 km (1 mile) of one another, measured from their geographical center. At least one, at least two, at least three, at least four, or all of the above statements (i) through (v) may be true.

Regarding (i), examples of suitable utility services include, but are not limited to, steam systems (co-generation and distribution systems), cooling water systems, heat transfer fluid systems, plant or instrument air systems, nitrogen systems, hydrogen systems, non-residential electrical generation and distribution, including distribution above 8000V, non-residential wastewater/sewer systems, storage facilities, transport lines, flare systems, and combinations thereof.

Regarding (ii), examples of service groups and facilities include, but are not limited to, emergency services personnel (fire and/or medical), a third-party vendor, a state or local government oversight group, and combinations thereof. Government oversight groups can include, for example, regulatory or environmental agencies, as well as municipal and taxation agencies at the city, county, and state level.

Regarding (iii), the boundary may be, for example, a fence line, a property line, a gate, or common boundaries with at least one boundary of a third-party owned land or facility.

Regarding (iv), the conduit may be a fluid conduit that carries a gas, a liquid, a solid/liquid mixture (e.g., slurry), a solid/gas mixture (e.g., pneumatic conveyance), a solid/liquid/gas mixture, or a solid (e.g., belt conveyance). In some cases, two units may share one or more conduits selected from the above list. Fluid conduits may be used to transport process streams or utilities between the two units. For example, an outlet of one facility (e.g., the solvolysis facility 30) may be fluidly connected via a conduit with an inlet of another facility (e.g., the PDX gasification facility 50). In some cases, an interim storage system for the materials being transported within the conduit between the outlet of one facility and the inlet of another facility may be provided. The interim storage system may comprise, for example, one or more tanks, vessels (open or closed), buildings, or containers that are configured to store the material carried by the conduit. In some cases, the interim storage between the outlet of one facility and the inlet of another can be not more than 90, not more than 75, not more than 60, not more than 40, not more than 30, not more than 25, not more than 20, not more than 15, not more than 10, not more than 5, not more than 2 days or not more than 1 day.

Turning again to FIG. 1, a stream 100 of waste plastic, which can be mixed plastic waste (MPW), may be introduced into the chemical recycling facility 10. As used herein, the terms “waste plastic” and “plastic waste” refer to used, scrap, and/or discarded plastic materials, such as plastic materials typically sent to a landfill. Other examples of waste plastic (or plastic waste) include used, scrap, and/or discarded plastic materials typically sent to an incinerator. The waste plastic stream 100 fed to the chemical recycling facility 10 may include unprocessed or partially processed waste plastic. As used herein, the term “unprocessed waste plastic” means waste plastic that has not be subjected to any automated or mechanized sorting, washing, or comminuting. Examples of unprocessed waste plastic include waste plastic collected from household curbside plastic recycling bins or shared community plastic recycling containers. As used herein, the term “partially processed waste plastic” means waste plastic that has been subjected to at least one automated or mechanized sorting, washing, or comminuting step or process. Partially processed waste plastics may originate from, for example, municipal recycling facilities (MRFs) or reclaimers. When partially processed waste plastic is provided to the chemical recycling facility 10, one or more preprocessing steps may be skipped. Waste plastic may comprise at least one of post-industrial (or pre-consumer) plastic and/or post-consumer plastic.

As used herein, the terms “mixed plastic waste” and “MPW” refer to a mixture of at least two types of waste plastics including, but not limited to the following plastic types: polyethylene terephthalate (PET), one or more polyolefins (PO), and polyvinylchloride (PVC). In an embodiment or in combination with any embodiment mentioned herein, MPW includes at least two distinct types of plastic, with each type of plastic being present in an amount of at least 1, at least 2, at least 5, at least 10, at least 15, or at least 20 weight percent, based on the total weight of plastic in the MPW.

In an embodiment or in combination with any embodiment mentioned herein, MPW comprises at least 1, at least 2, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, or at least 99 weight percent PET and/or at least 1, at least 2, at least 5, at least 10, at least 15, or at least 20 weight percent PO, based on the total weight of plastic in the MPW. In one embodiment or more embodiments, MPW may also include minor amounts of one or more types of plastic components other than PET and PO (and optionally PVC) that total less than 50, less than 45, less than 40, less than 35, less than 30, less than 25, less than 20, less than 15, less than 10, less than 5, less than 2, or less than 1 weight percent, based on the total weight of plastic in the MPW.

In an embodiment or in combination with any embodiment mentioned herein, the MPW comprises at least 20, at least 25, at least 30, at least 35, at least 40, at least 45, at least 50, at least 55, at least 60, at least 65, at least 70, at least 75, at least 80, at least 85, at least 90, or at least 95 weight percent PET, based on the total weight of the stream. Alternatively, or in addition, the MPW comprises not more than 99.9, not more than 99, not more than 97, not more than 92, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, or not more than 5 weight percent PET, based on the total weight of the stream.

The MPW stream can include non-PET components in an amount of at least 0.1, at least 0.5, at least 1, at least 2, at least 5, at least 7, at least 10, at least 15, at least 20, at least 25, at least 30, or at least 35 and/or not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, or not more than 7 weight percent, based on the total weight of the stream. Non-PET components can be present in an amount between 0.1 and 50 weight percent, 1 and 20 weight percent, or 2 and 10 weight percent, based on the total weight of the stream. Examples of such non-PET components can include, but are not limited to, ferrous and non-ferrous metals, inerts (such as rocks, glass, sand, etc.), plastic inerts (such as titanium dioxide, silicon dioxide, etc.), olefins, adhesives, compatibilizers, biosludge, cellulosic materials (such as cardboard, paper, etc.), and combinations thereof.

In an embodiment or in combination with any embodiment mentioned herein, all or a portion of the MPW can originate from a municipal source or comprise municipal waste. The municipal waste portion of the MPW can include, for example, PET in an amount of from 45 to 95 weight percent, 50 to 90 weight percent, or 55 to 85 weight percent, based on the total weight of the municipal waste stream (or portion of the stream).

In an embodiment or in combination with any embodiment mentioned herein, all or a portion of the MPW can originate from a municipal recycling facility (MRF) and may include, for example, PET in an amount of from 65 to 99.9 weight percent, 70 to 99 weight percent, or 80 to 97 weight percent, based on the total weight of the stream. The non-PET components in such streams may include, for example, other plastics in an amount of at least 1, at least 2, at least 5, at least 7, or at least 10 weight percent and/or not more than 25, not more than 22, not more than 20, not more than 15, not more than 12, or not more than 10 weight percent, based on the total weight of the stream, or such may be present in an amount in the range of from 1 to 22 weight percent, 2 to 15 weight percent, or 5 to 12 weight percent, based on the total weight of the stream. In an embodiment or in combination with any embodiment mentioned herein, the non-PET components can include other plastics in an amount in the range of from 2 to 35 weight percent, 5 to 30 weight percent, or 10 to 25 weight percent, based on the total weight of the stream, particularly when, for example, the MPW includes colored sorted plastics.

In an embodiment or in combination with any embodiment mentioned herein, all or a portion of the MPW can originate from a reclaimer facility and may include, for example, PET in an amount of from 85 to 99.9 weight percent, 90 to 99.9 weight percent, or 95 to 99 weight percent, based on the total weight of the stream. The non-PET components in such streams may include, for example, other plastics in an amount of at least 1, at least 2, at least 5, at least 7, or at least 10 weight percent and/or not more than 25, not more than 22, not more than 20, not more than 15, not more than 12, or not more than 10 weight percent, based on the total weight of the stream, or such may be present in an amount in the range of from 1 to 22 weight percent, 2 to 15 weight percent, or 5 to 12 weight percent, based on the total weight of the stream.

As used herein, the term “plastic” may include any organic synthetic polymers that are solid at 25° C. and 1 atmosphere of pressure. In an embodiment or in combination with any embodiment mentioned herein, the polymers may have a number average molecular weight (Mn) of at least 75, or at least 100, or at least 125, or at least 150, or at least 300, or at least 500, or at least 1000, or at least 5,000, or at least 10,000, or at least 20,000, or at least 30,000, or at least 50,000 or at least 70,000 or at least 90,000 or at least 100,000 or at least 130,000 Daltons. The weight average molecular weight (Mw) of the polymers can be at least 300, or at least 500, or at least 1000, or at least 5,000, or at least 10,000, or at least 20,000, or at least 30,000 or at least 50,000, or at least 70,000, or at least 90,000, or at least 100,000, or at least 130,000, or at least 150,000, or at least 300,000 Daltons.

Examples of suitable plastics can include, but are not limited to, aromatic and aliphatic polyesters, polyolefins, polyvinyl chloride (PVC), polystyrene, polytetrafluoroethylene, acrylobutadienestyrene (ABS), cellulosics, epoxides, polyamides, phenolic resins, polyacetal, polycarbonates, polyphenylene-based alloys, poly(methyl methacrylate), styrene-containing polymers, polyurethane, vinyl-based polymers, styrene acrylonitrile, thermoplastic elastomers other than tires, and urea containing polymers and melamines.

Examples of polyesters can include those having repeating aromatic or cyclic units such as those containing a repeating terephthalate, isophthalate, or naphthalate units such as PET, modified PET, and PEN, or those containing repeating furanate repeating units. Polyethylene terephthalate (PET) is also an example of a suitable polyester. As used herein, “PET” or “polyethylene terephthalate” refers to a homopolymer of polyethylene terephthalate, or to a polyethylene terephthalate modified with one or more acid and/or glycol modifiers and/or containing residues or moieties of other than ethylene glycol and terephthalic acid, such as isophthalic acid, 1,4-cyclohexanedicarboxylic acid, diethylene glycol, 2,2,4,4-tetramethyl-1,3-cyclobutanediol (TMCD), cyclohexanedimethanol (CHDM), propylene glycol, isosorbide, 1,4-butanediol, 1,3-propane diol, and/or neopentyl glycol (NPG).

Also included within the definition of the terms “PET” and “polyethylene terephthalate” are polyesters having repeating terephthalate units (whether or not they contain repeating ethylene glycol-based units) and one or more residues or moieties of a glycol including, for example, TMCD, CHDM, propylene glycol, or NPG, isosorbide, 1,4-butanediol, 1,3-propane diol, and/or diethylene glycol, or combinations thereof. Examples of polymers with repeat terephthalate units can include, but are not limited to, polypropylene terephthalate, polybutylene terephthalate, and copolyesters thereof. Examples of aliphatic polyesters can include, but are not limited to, polylactic acid (PLA), polyglycolic acid, polycaprolactones, and polyethylene adipates. The polymer may comprise mixed aliphatic-aromatic copolyesters including, for example, mixed terephthalates/adipates.

In an embodiment or in combination with any embodiment mentioned herein, the waste plastic may comprise at least one type of plastic that has repeat terephthalate units with such a plastic being present in an amount of at least 1, at least 2, at least 5, at least 10, at least 15, at least 20, at least 25, or at least 30 and/or not more than 45, not more than 40, not more than 35, not more than 30, not more than 25, not more than 20, not more than 15, not more than 10, not more than 5, or not more than 2 weight percent, based on the total weight of the stream, or it can be present in the range of from 1 to 45 weight percent, 2 to 40 weight percent, or 5 to 40 weight percent, based on the total weight of the stream. Similar amounts of copolyesters having multiple cyclohexane dimethanol moieties, 2,2,4,4-tetramethyl-1,3-cyclobutanediol moieties, or combinations thereof may also be present.

In an embodiment or in combination with any embodiment mentioned herein, the waste plastic may comprise at least one type of plastic that has repeat terephthalate units with such a plastic being present in an amount of at least 30, at least 35, at least 40, at least 45, at least 50, at least 55, at least 60, at least 65, at least 70, at least 75, at least 80, at least 85, or at least 90 and/or not more than 99.9, not more than 99, not more than 97, not more than 95, not more than 90, or not more than 85 weigh percent, based on the total weight of the stream, or it can be present in the range of from 30 to 99.9 weight percent, 50 to 99.9 weight percent, or 75 to 99 weight percent, based on the total weight of the stream.

In an embodiment of in combination with any embodiment mentioned herein, the waste plastic may comprise terephthalate repeat units in an amount of at least 1, at least 5, at least 10, at least 15, at least 20, at least 25, at least 30, at least 35, at least 40, or at least 45 and/or not more than 75, not more than 72, not more than 70, not more than 60, or not more than 65 weight percent, based on the total weight of the plastic in the waste plastic stream, or it may include terephthalate repeat units in an amount in the range of from 1 to 75 weight percent, 5 to 70 weight percent, or 25 to 75 weight percent, based on the total weight of the stream.

Examples of specific polyolefins may include low density polyethylene (LDPE), high density polyethylene (HDPE), atactic polypropylene, isotactic polypropylene, syndiotactic polypropylene, crosslinked polyethylene, amorphous polyolefins, and the copolymers of any one of the aforementioned polyolefins. The waste plastic may include polymers including linear low-density polyethylene (LLDPE), polymethylpentene, polybutene-1, and copolymers thereof. The waste plastic may comprise flashspun high density polyethylene.

The waste plastic may include thermoplastic polymers, thermosetting polymers, or combinations thereof. In an embodiment or in combination with any embodiment mentioned herein, the waste plastic can include at least 0.1, at least 1, at least 2, at least 5, at least 10, at least 15, at least 20, at least 25, or at least 30 and/or not more than 45, not more than 40, not more than 35, not more than 30, not more than 25, not more than 20, not more than 15, not more than 10, not more than 5, or not more than 2 weight percent of one or more thermosetting polymers, based on the total weight of the stream, or it can be present in an amount of 0.1 to 45 weight percent, 1 to 40 weight percent, 2 to 35 weight percent, or 2 to 20 weight percent, based on the total weight of the stream.

Alternatively, or in addition, the waste plastic may include at least 0.1, at least 1, at least 2, at least 5, at least 10, at least 15, at least 20, at least 25, or at least 30 and/or not more than 45, not more than 40, not more than 35, not more than 30, not more than 25, not more than 20, not more than 15, not more than 10, not more than 5, or not more than 2 weight percent of cellulose materials, based on the total weight of the stream, or it can be present in an amount in the range of from 0.1 to 45 weight percent, 1 to 40 weight percent, or 2 to 15 weight percent, based on the total weight of the stream. Examples of cellulose materials may include cellulose acetate, cellulose diacetate, cellulose triacetate, cellulose acetate propionate, cellulose acetate butyrate, as well as regenerated cellulose such as viscose. Additionally, the cellulose materials can include cellulose derivatives having an acyl degree of substitution of less than 3, not more than 2.9, not more than 2.8, not more than 2.7, or not more than 2.6 and/or at least 1.7, at least 1.8, or at least 1.9, or from 1.8 to 2.8, or 1.7 to 2.9, or 1.9 to 2.9.

In an embodiment or in combination with any embodiment mentioned herein, the waste plastic may comprise STYROFOAM or expanded polystyrene.

The waste plastic may originate from one or more of several sources. In an embodiment or in combination with any embodiment mentioned herein, the waste plastic may originate from plastic bottles, diapers, eyeglass frames, films, packaging materials, carpet (residential, commercial, and/or automotive), textiles (clothing and other fabrics) and combinations thereof.

In an embodiment or in combination with any embodiment mentioned herein, the waste plastic (e.g., MPW) fed to the chemical recycling facility may include one or more plastics having or obtained from plastics having a resin ID code numbered 1-7 with the chasing arrow triangle established by the SPI. The waste plastic may include one or more plastics that are not generally mechanically recycled. Such plastics can include, but are not limited to, plastics with the resin ID code 3 (polyvinyl chloride), resin ID code 5 (polypropylene), resin ID code 6 (polystyrene), and/or resin ID code 7 (other). In an embodiment or in combination with any embodiment mentioned herein, plastics having at least 1, at least 2, at least 3, at least 4, or at least 5 of the resin ID codes 3-7 or 3, 5, 6, 7, or a combination thereof may be present in the waste plastic in an amount of at least 0.1, at least 0.5, at least 1, at least 2, at least 3, at least 5, at least 7, at least 10, at least 12, at least 15, at least 20, at least 25, at least 30, at least 35, or at least 40 and/or not more than 90, not more than 85, not more than 80, not more than 75, not more than 70, not more than 65, not more than 60, not more than 55, not more than 50, not more than 45, not more than 40, or not more than 35 weight percent, based on the total weight of all plastics, or it could be in an amount of 0.1 to 90 weight percent, 1 to 75 weight percent, or 2 to 50 weight percent, based on the total weight of plastics.

In an embodiment or in combination with any embodiment mentioned herein, at least 5, at least 10, at least 15, at least 20, at least 25, at least 30, or at least 35 and/or not more than 60, not more than 55, not more than 50, not more than 45, not more than 40, not more than 35, not more than 30, not more than 25, not more than 20, not more than 15, not more than 10, or not more than 5 weight percent of the total plastic components in the waste plastic fed to the chemical recycling facility may comprise plastics not having a resin ID code 3, 5, 6, and/or 7 (e.g., where a plastic is not classified). At least 0.1, at least 0.5, at least 1, at least 2, at least 3, at least 4, at least 5, at least 10, at least 15, at least 20, at least 25, at least 30, or at least 35 and/or not more than 60, not more than 55, not more than 50, not more than 45, not more than 40, not more than 35, not more than 30, not more than 25, not more than 20, not more than 15, not more than 10, or not more than 5 weight percent of the total plastic components in the waste plastic fed to the chemical recycling facility 10 may comprise plastics not having a resin ID code 4-7, or it can be in the range of 0.1 to 60 weight percent, 1 to 55 weight percent, or 2 to 45 weight percent, based on the total weight of plastic components.

In an embodiment or in combination with any embodiment mentioned herein, the waste plastic (e.g., MPW) fed to the chemical recycling facility may comprise plastic that is not classified as resin ID codes 3-7 or ID codes 3, 5, 6, or 7. The total amount of plastic not classified as resin ID code 3-7 or ID codes 3, 5, 6, or 7 plastics in the waste plastic can be at least 0.1, at least 0.5, at least 1, at least 2, at least 3, at least 4, at least 5, at least 10, at least 15, at least 20, at least 25, at least 30, at least 35, at least 40, at least 45, at least 50, at least 55, at least 60, at least 65, at least 70, or at least 75 and/or not more than 95, not more than 90, not more than 85, not more than 80, not more than 75, not more than 70, not more than 65, not more than 60, not more than 55, not more than 50, not more than 45, not more than 40, or not more than 35 weight percent, based on the total weight of plastic in the waste plastic stream, or it can be in the range of from 0.1 to 95 weight percent, 0.5 to 90 weight percent, or 1 to 80 weight percent, based on the total weight of plastic in the waste plastic stream.

In one embodiment or in combination with any of the mentioned embodiments, the MPW comprises plastics having or obtained from plastics having at least 30, at least 35, at least 40, at least 45, at least 50, at least 55, at least 60, at least 65, at least 70, at least 75, at least 80, at least 85, at least 90, at least 95, or at least 99 weight percent of at least one, at least two, at least three, or at least four different kinds of resin ID codes.

In one embodiment or in combination with any of the mentioned embodiments, the MPW comprises multi-component polymers. As used herein, the term “multi-component polymers” refers to articles and/or particulates comprising at least one synthetic or natural polymer combined with, attached to, or otherwise physically and/or chemically associated with at least one other polymer and/or non-polymer solid. The polymer can be a synthetic polymer or plastic, such as PET, olefins, and/or nylons. The non-polymer solid can be a metal, such as aluminum, or other non-plastic solids as described herein. The multi-component polymers can include metalized plastics.

In one embodiment or in combination with any of the mentioned embodiments, the MPW comprises multi-component plastics in the form of multi-layer polymers. As used herein, the term “multi-layer polymers” refers to multi-component polymers comprising PET and at least one other polymer and/or non-polymer solid physically and/or chemically associated together in two or more physically distinct layers. A polymer or plastic is considered a multi-layered polymer even though a transition zone may exist between two layers, such as may be present in adhesively adhered layers or co-extruded layers. An adhesive between two layers is not deemed to be a layer. The multi-layer polymers may comprise a layer comprising PET and a one or more additional layers at least one of which is a synthetic or natural polymer that is different from PET, or a polymer which has no ethylene terephthalate repeating units, or a polymer which has no alkylene terephthalate repeating units (a “non-PET polymer layer”), or other non-polymer solid.

Examples of non-PET polymer layers include nylons, polylactic acid, polyolefins, polycarbonates, ethylene vinyl alcohol, polyvinyl alcohol, and/or other plastics or plastic films associated with PET-containing articles and/or particulates, and natural polymers such as whey proteins. The multi-layer polymers may include metal layers, such as aluminum, provided that at least one additional polymer layer is present other than the PET layer. The layers may be adhered with adhesive bonding or other means, physically adjacent (i.e., articles pressed against the film), tackified (i.e., the plastics heated and stuck together), co-extruded plastic films, or otherwise attached to the PET-containing articles. The multi-layer polymers may comprise PET films associated with articles containing other plastics in the same or similar manner. The MPW may comprise multi-component polymers in the form of PET and at least one other plastic, such as polyolefins (e.g., polypropylene) and/or other synthetic or natural polymers, combined in a single physical phase. For example, the MPW comprises a heterogenous mixture comprising a compatibilizer, PET, and at least one other synthetic or natural polymer plastic (e.g., non-PET plastic) combined in a single physical phase. As used herein, the term “compatibilizer” refers to an agent capable of combining at least two otherwise immiscible polymers together in a physical mixture (i.e., blend).

In one embodiment or in combination with any of the mentioned embodiments, the MPW comprises not more than 20, not more than 10, not more than 5, not more than 2, not more than 1, or not more than 0.1 weight percent nylons, on a dry plastic basis. In one embodiment or in combination with any of the mentioned embodiments, the MPW comprises from 0.01 to 20, from 0.05 to 10, from 0.1 to 5, or from 1 to 2 weight percent nylons, on a dry plastic basis.

In one embodiment or in combination with any of the mentioned embodiments, the MPW comprises not more than 40, not more than 20, not more than 10, not more than 5, not more than 2, or not more than 1 weight percent multi-component plastics, on a dry plastic basis. In one embodiment or in combination with any of the mentioned embodiments, the MPW comprises from 0.1 to 40, from 1 to 20, or from 2 to 10 weight percent multi-component plastics, on a dry plastic basis. In one embodiment or in combination with any of the mentioned embodiments, the MPW comprises not more than 40, not more than 20, not more than 10, not more than 5, not more than 2, or not more than 1 weight percent multi-layer plastics, on a dry plastic basis. In one embodiment or in combination with any of the mentioned embodiments, the MPW comprises from 0.1 to 40, from 1 to 20, or from 2 to 10 weight percent multi-layer plastics, on a dry plastic basis.

In one embodiment or in combination with any of the mentioned embodiments, the MPW feedstock to the chemical recycling facility 10 in stream 100 comprises not more than 20, not more than 15, not more than 12, not more than 10, not more than 8, not more than 6, not more than 5, not more than 4, not more than 3, not more than 2, or not more than 1 weight percent of biowaste materials, with the total weight of the MPW feedstock taken as 100 weight percent on a dry basis. The MPW feedstock comprises from 0.01 to 20, from 0.1 to 10, from 0.2 to 5, or from 0.5 to 1 weight percent of biowaste materials, with the total weight of the MPW feedstock taken as 100 weight percent on a dry basis. As used herein, the term “biowaste” refers to material derived from living organisms or of organic origin. Exemplary biowaste materials include, but are not limited to, cotton, wood, saw dust, food scraps, animals and animal parts, plants and plant parts, and manure.

In one embodiment or in combination with any of the mentioned embodiments, the MPW feedstock comprises not more than 20, not more than 15, not more than 12, not more than 10, not more than 8, not more than 6, not more than 5, not more than 4, not more than 3, not more than 2, or not more than 1 weight percent of manufactured cellulose products, with the total weight of the MPW feedstock taken as 100 weight percent on a dry basis. The MPW feedstock comprises from 0.01 to 20, from 0.1 to 10, from 0.2 to 5, or from 0.5 to 1 weight percent of manufactured cellulose products, with the total weight of the MPW feedstock taken as 100 weight percent on a dry basis. As used herein, the term “manufactured cellulose products” refers to nonnatural (i.e., manmade or machine-made) articles, and scraps thereof, comprising cellulosic fibers. Exemplary manufactured cellulose products include, but are not limited to, paper and cardboard.

In an embodiment or in combination with any embodiment mentioned herein, the waste plastic (e.g., MPW) fed to the chemical recycling facility can include at least 0.001, at least 0.01, at least 0.05, at least 0.1, or at least 0.25 weight percent and/or not more than 10, not more than 5, not more than 4, not more than 3, not more than 2, not more than 1, not more than 0.75, or not more than 0.5 weight percent of polyvinyl chloride (PVC) based on the total weight of plastics in the waste plastic feed.

Additionally, or in the alternative, the waste plastic (e.g., MPW) fed to the chemical recycling facility can include at least 0.1, at least 1, at least 2, at least 4, or at least 6 weight percent and/or not more than 25, not more than 15, not more than 10, not more than 5, or not more than 2.5 weight percent of non-plastic solids. Non-plastic solids may include inert filler materials (e.g., calcium carbonate, hydrous aluminum silicate, alumina trihydrate, calcium sulfate), rocks, glass, and/or additives (e.g., thixotropes, pigments and colorants, fire retardants, suppressants, UV inhibitors & stabilizers, conductive metal or carbon, release agents such as zinc stearate, waxes, and silicones).

In one embodiment or in combination with any of the mentioned embodiments, the MPW may comprise at least 0.01, at least 0.1, at least 0.5, or at least 1 and/or not more than 25, not more than 20, not more than 25, not more than 10, not more than 5, or not more than 2.5 weight percent of liquids, based on the total weight of the MPW stream or composition. The amount of liquids in the MPW can be in the range of from 0.01 to 25 weight percent, from 0.5 to 10 weight percent, or 1 to 5 weight percent, based on the total weight of the MPW stream 100.

In one embodiment or in combination with any of the mentioned embodiments, the MPW may comprise at least 35, at least 40, at least 45, at least 50, or at least 55 and/or not more than 65, not more than 60, not more than 55, not more than 50, not more than 45, not more than 40, or not more than 35 weight percent of liquids, based on the total weight of the waste plastic. The liquids in the waste plastic can be in the range of from 35 to 65 weight percent, 40 to 60 weight percent, or 45 to 55 weight percent, based on the total weight of the waste plastic.

In one embodiment or in combination with any of the mentioned embodiments, the amount of textiles (including textile fibers) in the MPW stream in line 100 can be at least 0.1 weight percent, or at least 0.5 weight percent, or at least 1 weight percent, or at least 2 weight percent, or at least 5 weight percent, or at least 8 weight percent, or at least 10 weight percent, or at least 15 weight percent, or at least 20 weight percent material obtained from textiles or textile fibers, based on the weight of the MPW. The amount of textiles (including textile fibers) in the MPW in stream 100 is not more than 50, not more than 40, not more than 30, not more than 20, not more than 15, not more than 10, not more than 8, not more than 5, not more than 2, not more than 1, not more than 0.5, not more than 0.1, not more than 0.05, not more than 0.01, or not more than 0.001 weight percent, based on the weight of the MPW stream 100. The amount of textiles in the MPW stream 100 can be in the range of from 0.1 to 50 weight percent, 5 to 40 weight percent, or 10 to 30 weight percent, based on the total weight of the MPW stream 100.

The MPW introduced into the chemical recycling facility 10 may contain recycle textiles. Textiles may contain natural and/or synthetic fibers, rovings, yarns, nonwoven webs, cloth, fabrics and products made from or containing any of the aforementioned items. Textiles can be woven, knitted, knotted, stitched, tufted, may include pressed fibers such as in felting, embroidered, laced, crocheted, braided, or may include nonwoven webs and materials. Textiles can include fabrics, and fibers separated from a textile or other product containing fibers, scrap or off-spec fibers or yarns or fabrics, or any other source of loose fibers and yarns. A textile can also include staple fibers, continuous fibers, threads, tow bands, twisted and/or spun yarns, gray fabrics made from yarns, finished fabrics produced by wet processing gray fabrics, and garments made from the finished fabrics or any other fabrics. Textiles include apparels, interior furnishings, and industrial types of textiles. Textiles can include post-industrial textiles (pre-consumer) or post-consumer textiles or both.

In one embodiment or in combination with any of the mentioned embodiments, textiles can include apparel, which can generally be defined as things humans wear or made for the body. Such textiles can include sports coats, suits, trousers and casual or work pants, shirts, socks, sportswear, dresses, intimate apparel, outerwear such as rain jackets, cold temperature jackets and coats, sweaters, protective clothing, uniforms, and accessories such as scarves, hats, and gloves. Examples of textiles in the interior furnishing category include furniture upholstery and slipcovers, carpets and rugs, curtains, bedding such as sheets, pillow covers, duvets, comforters, mattress covers; linens, tablecloths, towels, washcloths, and blankets. Examples of industrial textiles include transportation (auto, airplane, train, bus) seats, floor mats, trunk liners, and headliners; outdoor furniture and cushions, tents, backpacks, luggage, ropes, conveyor belts, calendar roll felts, polishing cloths, rags, soil erosion fabrics and geotextiles, agricultural mats and screens, personal protective equipment, bullet proof vests, medical bandages, sutures, tapes, and the like.

The nonwoven webs that are classified as textiles do not include the category of wet laid nonwoven webs and articles made therefrom. While a variety of articles having the same function can be made from a dry or wet laid process, an article made from a dry laid nonwoven web is classified as a textile. Examples of suitable articles that may be formed from dry laid nonwoven webs as described herein can include those for personal, consumer, industrial, food service, medical, and other end uses. Specific examples can include, but are not limited to, baby wipes, flushable wipes, disposable diapers, training pants, feminine hygiene products such as sanitary napkins and tampons, adult incontinence pads, underwear, or briefs, and pet training pads. Other examples include a variety of different dry or wet wipes, including those for consumer (such as personal care or household) and industrial (such as food service, health care, or specialty) use. Nonwoven webs can also be used as padding for pillows, mattresses, and upholstery, and batting for quilts and comforters. In the medical and industrial fields, nonwoven webs of the present invention may be used for consumer, medical, and industrial face masks, protective clothing, caps, and shoe covers, disposable sheets, surgical gowns, drapes, bandages, and medical dressings.

Additionally, nonwoven webs as described herein may be used for environmental fabrics such as geotextiles and tarps, oil and chemical absorbent pads, as well as building materials such as acoustic or thermal insulation, tents, lumber and soil covers and sheeting. Nonwoven webs may also be used for other consumer end use applications, such as for, carpet backing, packaging for consumer, industrial, and agricultural goods, thermal or acoustic insulation, and in various types of apparel.

The dry laid nonwoven webs as described herein may also be used for a variety of filtration applications, including transportation (e.g., automotive or aeronautical), commercial, residential, industrial, or other specialty applications. Examples can include filter elements for consumer or industrial air or liquid filters (e.g., gasoline, oil, water), including nanofiber webs used for microfiltration, as well as end uses like tea bags, coffee filters, and dryer sheets. Further, nonwoven webs as described herein may be used to form a variety of components for use in automobiles, including, but not limited to, brake pads, trunk liners, carpet tufting, and under padding.

The textiles can include single type or multiple type of natural fibers and/or single type or multiple type of synthetic fibers. Examples of textile fiber combinations include all natural, all synthetic, two or more type of natural fibers, two or more types of synthetic fibers, one type of natural fiber and one type of synthetic fiber, one type of natural fibers and two or more types of synthetic fibers, two or more types of natural fibers and one type of synthetic fibers, and two or more types of natural fibers and two or more types of synthetic fibers.

Natural fibers include those that are plant derived or animal derived. Natural fibers can be cellulosics, hemicellulosics, and lignins. Examples of plant derived natural fibers include hardwood pulp, softwood pulp, and wood flour; and other plant fibers including those in wheat straw, rice straw, abaca, coir, cotton, flax, hemp, jute, bagasse, kapok, Papyrus, ramie, rattan, vine, kenaf, abaca, henequen, sisal, soy, cereal straw, bamboo, reeds, esparto grass, bagasse, Sabai grass, milkweed floss fibers, pineapple leaf fibers, switch grass, lignin-containing plants, and the like. Examples of animal derived fibers include wool, silk, mohair, cashmere, goat hair, horsehair, avian fibers, camel hair, angora wool, and alpaca wool.

Synthetic fibers are those fibers that are, at least in part, synthesized or derivatized through chemical reactions, or regenerated, and include, but are not limited to, rayon, viscose, mercerized fibers or other types of regenerated cellulose (conversion of natural cellulose to a soluble cellulosic derivative and subsequent regeneration) such as lyocell (also known as TENCEL™), Cupro, Modal, acetates such as polyvinyl acetate, polyamides including nylon, polyesters such as PET, olefinic polymers such as polypropylene and polyethylene, polycarbonates, poly sulfates, poly sulfones, polyethers such as polyether-urea known as Spandex or elastane, polyacrylates, acrylonitrile copolymers, polyvinylchloride (PVC), polylactic acid, polyglycolic acid, sulfopolyester fibers, and combinations thereof.

Prior to entering the chemical recycling facility, the textiles can be size reduced via chopping, shredding, harrowing, confrication, pulverizing, or cutting to make size reduced textiles. The textiles can also be densified (e.g., pelletized) prior to entering the chemical recycling facility. Examples of processes that densify include extrusion (e.g., into pellets), molding (e.g., into briquettes), and agglomerating (e.g., through externally applied heat, heat generated by frictional forces, or by adding one or more adherents, which can be non-virgin polymers themselves). Alternatively, or in addition, the textiles can be in any of the forms mentioned herein and may be exposed to one or more of the previously mentioned steps in the pre-processing facility 20 prior to being processed in the remaining facilities of the chemical recycling facility 10 shown in FIG. 1.

In an embodiment or in combination with any embodiment mentioned herein, polyethylene terephthalate (PET) and one or more polyolefins (PO) in combination make up at least 50, at least 55, at least 60, at least 65, at least 70, at least 75, at least 80, at least 85, at least 90, at least 95, or at least 99 weight percent of the waste plastic (e.g., MPW) fed to the chemical recycling facility in stream 100 of FIG. 1. Polyvinylchloride (PVC) can make up at least 0.001, at least 0.01, at least 0.05, at least 0.1, at least 0.25, or at least 0.5 weight percent and/or not more than 10, not more than 5, not more than 4, not more than 3, not more than 2, not more than 1, not more than 0.75, or not more than 0.5 weight percent of the waste plastic, based on the total weight of the plastic in the waste plastic introduced into the chemical recycling facility 10.

In an embodiment or in combination with any embodiment mentioned herein, the waste plastic can comprise at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 weight percent of PET, based on the total weight of the plastic in the waste plastic introduced into the chemical recycling facility 10.

In an embodiment or in combination with any embodiment mentioned herein, the waste plastic can comprise at least 5, at least 10, at least 15, at least 20, at least 25, at least 30, at least 35, at least 40 and/or not more than 95, not more than 90, not more than 85, not more than 80, not more than 75, not more than 70, not more than 65, not more than 60, not more than 55, not more than 50, not more than 45, not more than 40, or not more than 35 weight percent PO, based on the total weight of the plastic in the waste plastic, or PO can be present in an amount in the range of from 5 to 75 weight percent, 10 to 60 weight percent, or 20 to 35 weight percent, based on the total weight of plastic in the waste plastic introduced into the chemical recycling facility 10.

The waste plastic (e.g., MPW) introduced into the chemical recycling facility may be provided from a variety of sources, including, but not limited to, municipal recycling facilities (MRFs) or reclaimer facilities or other mechanical or chemical sorting or separation facilities, manufacturers or mills or commercial production facilities or retailers or dealers or wholesalers in possession of post-industrial and pre-consumer recyclables, directly from households/businesses (i.e., unprocessed recyclables), landfills, collection centers, convenience centers, or on docks or ships or warehouses thereon. In an embodiment or in combination with any embodiment mentioned herein, the source of waste plastic (e.g. MPW) does not include deposit state return facilities, whereby consumers can deposit specific recyclable articles (e.g., plastic containers, bottles, etc.) to receive a monetary refund from the state. In an embodiment or in combination with any embodiment mentioned herein, the source of waste plastic (e.g. MPW) does include deposit state return facilities, whereby consumers can deposit specific recyclable articles (e.g., plastic containers, bottles, etc.) to receive a monetary refund from the state. Such return facilities are commonly found, for example, in grocery stores.

In an embodiment or in combination with any embodiment mentioned herein, the waste plastic may be provided as a waste stream from another processing facility, for example a municipal recycling facility (MRF) or reclaimer facility, or as a plastic-containing mixture comprising waste plastic sorted by a consumer and left for collection at a curbside, or at a central convenience station. In one or more of such embodiments, the waste plastic comprises one or more MRF products or co-products, reclaimer co-products, sorted plastic-containing mixtures, and/or PET-containing waste plastic from a plastic article manufacturing facility comprising at least 10, at least 20, at least 30, at least 40, at least 50, at least 60, at least 70, at least 80, or at least 90 weight percent PET and/or not more than 99.9, not more than 99, not more than 98, not more than 97, not more than 96, or not more than 95 weight percent PET, on a dry plastics basis, or it can be in the range of from 10 to 99.9 weight percent, 20 to 99 weight percent, 30 to 95 weight percent, or 40 to 90 weight percent PET, on a dry plastics basis.

In one or more of such embodiments, the waste plastic comprises a quantity of a PET-containing reclaimer coproduct or plastic-containing mixture comprising at least 1, at least 10, at least 30, at least 50, at least 60, at least 70, at least 80, or at least 90 weight percent and/or not more than 99.9, not more than 99, or not more than 90 weight percent PET, on a dry plastic basis, or it can be in the range of from 1 to 99.9 weight percent, 1 to 99 weight percent, or 10 to 90 weight percent PET, on a dry plastic basis. Reclaimer facilities may also include processes that produce high purity PET (at least 99 or at least 99.9 weight percent) reclaimer co-products but in a form that is undesirable to mechanical recycling facilities. As used herein, the term “reclaimer co-product” refers to any material separated or recovered by the reclaimer facility that is not recovered as a clear rPET product, including colored rPET. The reclaimer co-products described above and below are generally considered to be waste products and may sent to landfills.

In one or more of such embodiments, the waste plastic comprises a quantity of reclaimer wet fines comprising at least 20, at least 40, at least 60, at least 80, at least 90, at least 95, or at least 99 weight percent and/or not more than 99.9 weight percent PET, on a dry plastic basis. In one or more of such embodiments, the waste plastic comprises a quantity of colored plastic-containing mixture comprising at least 1, at least 10, at least 20, at least 40, at least 60, at least 80, or at least 90 and/or not more than 99.9 or not more than 99 weight percent PET, on a dry plastic basis. In one or more of such embodiments, the waste plastic comprises a quantity of eddy current waste stream comprising metal and at least 0.1, at least 1, at least 10, at least 20, at least 40, at least 60, or at least 80 weight percent and/or not more than 99.9, not more than 99, or not more than 98 weight percent PET, on a dry plastic basis. In one or more of such embodiments, the waste plastic comprises a quantity of reclaimer flake reject comprising at least 0.1, at least 1, at least 10, at least 20, at least 40, at least 60, or at least 80 weight percent and/or not more than 99.9, not more than 99, or not more than 98 weight percent PET, on a dry plastic basis, or it could be in the range of from 0.1 to 99.9 weight percent, 1 to 99 weight percent, or 10 to 98 weight percent PET, on a dry plastic basis. In one or more of such embodiments, the waste plastic comprises a quantity of dry fines comprising at least 50, at least 60, at least 70, at least 80, at least 90, at least 95, at least 99, at least 99.9 weight percent PET, on a dry plastic basis.

The chemical recycling facility 10 may also include infrastructure for receiving waste plastic (e.g., MPW) as described herein to facilitate delivery of the waste plastic by any suitable type of vehicle including, for example, trains, trucks, and/or ships. Such infrastructure may include facilities to assist with offloading the waste plastic from the vehicle, as well as storage facilities and one or more conveyance systems for transporting the waste plastic from the offloading zone to the downstream processing zones. Such conveyance systems may include, for example, pneumatic conveyors, belt conveyors, bucket conveyors, vibrating conveyors, screw conveyors, cart-on-track conveyors, tow conveyors, trolley conveyors, front-end loaders, trucks, and chain conveyors.

The waste (e.g., MPW) introduced into the chemical recycling facility 10 may be in several forms including, but not limited to, whole articles, particulates (e.g., comminuted, pelletized, fiber plastic particulates), bound bales (e.g., whole articles compressed and strapped), unbound articles (i.e., not in bales or packaged), containers (e.g., box, sack, trailer, railroad car, loader bucket), piles (e.g., on a concrete slab in a building), solid/liquid slurries (e.g., pumped slurry of plastics in water), and/or loose materials conveyed physically (e.g., particulates on a conveyor belt) or pneumatically (e.g., particulates mixed with air and/or inert gas in a convey pipe).

As used herein, the term “waste plastic particulates” refers to waste plastic having a D90 of less than 2.54 cm (1 inch). In an embodiment or in combination with any embodiment mentioned herein, the waste plastic particulates can be MPW particulates. A waste plastic or MPW particulate can include, for example, comminuted plastic particles that have been shredded or chopped, or plastic pellets. When whole or nearly whole articles are introduced into the chemical recycling facility 10 (or preprocessing facility 20), one or more comminuting or pelletizing steps may be used therein to form waste plastic particulates (e.g., MPW particulates). Alternatively, or in addition, at least a portion of the waste plastic introduced into the chemical recycling facility 10 (or preprocessing facility 20) may already be in the form of particulates.

The general configuration and operation of each of the facilities that may be present in the chemical recycling facility shown in FIG. 1 will now be described in further detail below, beginning with the preprocessing facility. Optionally, although not shown in FIG. 1, at least one of the streams from the chemical recycling facility may be sent to an industrial landfill or other similar type of processing or disposal facility.

### Preprocessing

As shown in FIG. 1, the unprocessed and/or partially processed waste plastic, such as mixed plastic waste (MPW), may first be introduced into a preprocessing facility 20 via stream 100. In preprocessing facility 20 the stream may undergo one or more processing steps to prepare it for chemical recycling. As used herein, the term “preprocessing” refers to preparing waste plastic for chemical recycling using one or more of the following steps: (i) comminuting; (ii) particulating; (iii) washing; (iv) drying; and (v) separation. As used herein, the term “preprocessing facility” refers to a facility that includes all equipment, lines, and controls necessary to carry out the preprocessing of waste plastic. Preprocessing facilities as described herein may employ any suitable method for carrying out the preparation of waste plastic for chemical recycling using one or more of these steps, which are described in further detail below.

### Comminuting & Particulating

In an embodiment or in combination with any embodiment mentioned herein, the waste plastic (e.g., MPW) may be provided in bales of unsorted or presorted plastic, or in other large, aggregated forms. The bales or aggregated plastics undergo an initial process in which they are broken apart. Plastic bales can be sent to a debaler machine that comprises, for example, one or more rotating shafts equipped with teeth or blades configured to break the bales apart, and in some instances shred, the plastics from which the bales are comprised. In one or more other embodiments, the bales or aggregated plastics can be sent to a guillotine machine where they are chopped into smaller sized pieces of plastic. The debaled and/or guillotined plastic solids can then be subjected to a sorting process in which various non-plastic, heavy materials, such as glass, metal, and rocks, are removed. This sorting process can be performed manually or by a machine. Sorting machines may rely upon optical sensors, magnets, eddy currents, pneumatic lifts or conveyors that separate based on drag coefficient, or sieves to identify and remove the heavy materials.

In an embodiment or in combination with any embodiment mentioned herein, the waste plastic feedstock comprises plastic solids having a D90 that is greater than 2.54 cm (one inch), greater than 1.91 cm (0.75 inch), or greater than 1.27 cm (0.5 inch), such as used containers. Alternatively, or in addition, the waste plastic feedstock may also comprise a plurality of plastic solids that, at one time, had at least one dimension of greater than one inch, but the solids may have been compacted, pressed, or otherwise aggregated into a larger unit, such as a bale. In such embodiments wherein at least a portion, or all, of the plastic solids have at least one dimension greater than 2.54 cm (one inch), greater than 1.91 cm (0.75 inch), or 1.27 cm (0.5 inch), the feedstock may be subjected to a mechanical size reduction operation, such as grinding/granulating, shredding, guillotining, chopping, or other comminuting process to provide MPW particles having a reduced size. Such mechanical size reduction operations can include a size reduction step other than crushing, compacting, or forming plastic into bales.

In one or more other embodiments, the waste plastic may already have undergone some initial separation and/or size-reduction process. In particular, the waste plastic may be in the form of particles or flakes and provided in some kind of container, such as a sack or box. Depending upon the composition of these plastic solids and what kind of preprocessing they may have been subjected to, the plastic feedstock may bypass the debaler, guillotine, and/or heavies removal station and proceed directly to the granulating equipment for further size reduction.

In an embodiment or in combination with any embodiment mentioned herein, the debaled or broken apart plastic solids may be sent to comminution or granulating equipment in which the plastic solids are ground, shredded, or otherwise reduced in size. The plastic materials can be made into particles having a D90 particle size of less than 2.54 cm (one inch), less than 1.91 cm (0.75 inch), or less than 1.27 cm (0.5 inch). In one or more other embodiments, the D90 particle size of the plastic materials exiting the granulating equipment is from 0.16 cm to 2.54 cm ( 1/16 inch to 1 inch), 0.32 cm to 1.91 cm (⅛ inch to ¾ inch), 0.64 cm to 1.59 cm (¼ inch to ⅝ inch), or 0.95 cm to 1.27 cm (⅜ inch to ½ inch).

### Washing & Drying

In an embodiment or in combination with any embodiment mentioned herein, the unprocessed or partially processed waste plastic provided to the chemical recycling facility may comprise various organic contaminants or residues that may be associated with the previous use of the waste plastic. For example, the waste plastic may comprise food or beverage soils, especially if the plastic material was used in food or beverage packaging. Accordingly, the waste plastic may also contain microorganism contaminants and/or compounds produced by the microorganisms. Exemplary microorganisms that may be present on the surfaces of the plastic solids making up the waste plastic include E. coli, salmonella, C. dificile, S. aureus, L. monocytogenes, S. epidermidis, P. aeruginosa, and P. fluorescens.

Various microorganisms can produce compounds that cause malodors. Exemplary odor-causing compounds include hydrogen sulfide, dimethyl sulfide, methanethiol, putrescine, cadaverine, trimethylamine, ammonia, acetaldehyde, acetic acid, propanoic acid, and/or butyric acid. Thus, it can be appreciated that the waste plastic could present odor nuisance concerns. Therefore, the waste plastic may be stored within an enclosed space, such as a shipping container, enclosed railcar, or enclosed trailer until it can be processed further. In certain embodiments, the unprocessed or partially processed waste plastic, once it reaches the site where processing (e.g., comminuting, washing, and sorting) of the waste plastic is to occur, can be stored with the enclosed spaces for no more than one week, no more than 5 days, no more than 3 days, no more than 2 days, or no more than 1 day.

In an embodiment or in combination with any embodiment mentioned herein, the preprocessing facility 20 may also include equipment for or the step of treating the waste plastic with a chemical composition that possesses antimicrobial characteristics, thereby forming treated particulate plastic solids. In some embodiments, this may include treating the waste plastic with sodium hydroxide, high pH salt solutions (e.g., potassium carbonate), or other antimicrobial composition.

Additionally, in an embodiment or in combination with any embodiment mentioned herein, the waste plastic (e.g., MPW) may optionally be washed to remove inorganic, non-plastic solids such as dirt, glass, fillers and other non-plastic solid materials, and/or to remove biological components such as bacteria and/or food. The resulting washed waste plastic may also be dried to a moisture content of not more than 5, not more than 3, not more than 2, not more than 1, not more than 0.5, or not more than 0.25 weight percent water (or liquid), based on the total weight of the waste plastic. The drying can be done in any suitable manner, including by the addition of heat and/or air flow, mechanical drying (e.g., centrifugal), or by permitting evaporation of the liquid to occur over a specified time.

### Separation

In an embodiment or in combination with any embodiment mentioned herein, the preprocessing facility 20 or step of the chemical recycling process or facility 10 may include at least one separation step or zone. The separation step or zone may be configured to separate the waste plastic stream into two or more streams enriched in certain types of plastics. Such separation is particularly advantageous when the waste plastic fed to the preprocessing facility 20 is MPW.

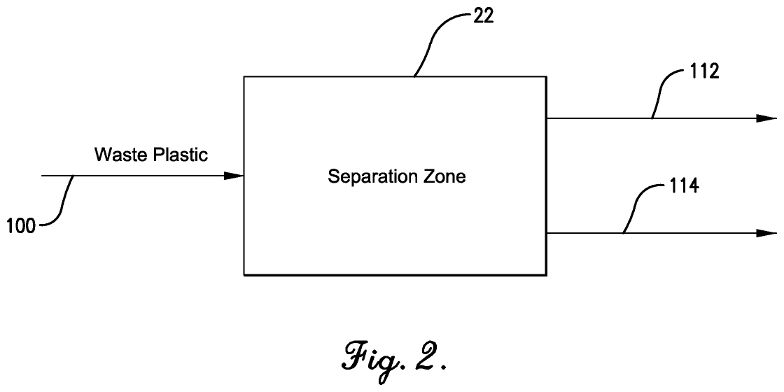

In an embodiment or in combination with any embodiment mentioned herein, the separation zone 22 (see FIG. 2) of the preprocessing facility 20 may separate the waste plastic (e.g., MPW) into a PET-enriched stream 112 and a PET-depleted stream 114 as shown in FIG. 2. As used herein, the term “enriched” means having a concentration (on an undiluted dry weight basis) of a specific component that is greater than the concentration of that component in a reference material or stream. As used herein, the term “depleted” means having a concentration (on an undiluted dry weight basis) of a specific component that is less than the concentration of that component in a reference material or stream. As used herein, all weight percentages are given on an undiluted dry weight basis, unless otherwise noted.

When the enriched or depleted component is a solid, concentrations are on an undiluted dry solids weight basis; when the enriched or depleted component is a liquid, concentrations are on an undiluted dry liquid weight basis; and when the enriched or depleted component is a gas, concentrations are on an undiluted dry gas weight basis. In addition, enriched and depleted can be expressed in mass balance terms, rather than as a concentration. As such, a stream enriched in a specific component can have a mass of the component that is greater than the mass of the component in a reference stream (e.g., feed stream or other product stream), while a stream depleted in a specific component can have a mass of the component that is less than the mass of the component in a reference stream (e.g., feed stream or other product stream).

Referring again to FIG. 2, the PET-enriched stream 112 of waste plastic withdrawn from the preprocessing facility 20 (or separation zone 22) may have a higher concentration or mass of PET than the concentration or mass of PET in the waste plastic feed stream 100 introduced into the preprocessing facility 20 (or separation zone 22). Similarly, the PET-depleted stream 114 withdrawn from the preprocessing facility 20 (or separation zone 22) may be PET-depleted and have a lower concentration or mass of PET than the concentration or mass of PET in the waste plastic introduced into the preprocessing facility 20 (or separation zone 22). The PET-depleted stream 114 may also be PO-enriched and have a higher concentration or mass of PO than the concentration or mass of PO in the waste plastic (e.g., MPW) stream introduced into the preprocessing facility 20 (or separation zone 22).

In an embodiment or in combination with any embodiment mentioned herein, when a MPW stream 100 is fed to the preprocessing facility 20 (or separation zone 22), the PET-enriched stream may be enriched in concentration or mass of PET relative to the concentration or mass of PET in the MPW stream, or the PET-depleted stream, or both, on an undiluted solids dry weight basis. For example, if the PET-enriched stream is diluted with liquid or other solids after separation, the enrichment would be on the basis of a concentration in the undiluted PET-enriched stream, and on a dry basis. In one embodiment or in combination with any of the mentioned embodiments, the PET-enriched stream 112 has a percent PET enrichment relative to the MPW feed stream (Feed-Based % PET Enrichment), the PET-depleted product stream 114 (Product-Based % PET Enrichment), or both that is at least 10, at least 20, at least 40, at least 50, at least 60, at least 80, at least 100, at least 125, at least 150, at least 175, at least 200, at least 225, at least 250, at least 300, at least 350, at least 400, at least 500, at least 600, at least 700, at least 800, at least 900, or at least 1000% as determined by the formula:

$$Feed - Based \% PET Enrichment = \frac{PETe - PETm}{PETm} \times 100$$

$$and$$

$$Product - Based \% PET Enrichment = \frac{PETe - PETd}{PETd} \times 100$$

where PETe is the concentration of PET in the PET-enriched product stream 112 on an undiluted dry weight basis;
PETm is the concentration of PET in the MPW feed stream 100 on a dry weight basis; and
PETd is the concentration of PET in the PET-depleted product stream 114 on a dry weight basis.

In an embodiment or in combination with any embodiment mentioned herein, when a stream comprising MPW 100 is fed to the preprocessing facility 20 (or separation zone 22), the PET-enriched stream is also enriched in halogens, such as fluorine (F), chlorine (CI), bromine (Br), iodine (I), and astatine (At), and/or halogen-containing compounds, such as PVC, relative to the concentration or mass of halogens in the MPW feed stream 100, or the PET-depleted product stream 114, or both. In one embodiment or in combination with any of the mentioned embodiments, the PET-enriched stream 112 has a percent PVC enrichment relative to the MPW feed stream 100 (Feed-Based % PVC Enrichment), the PET-depleted product stream (Product-Based % PVC Enrichment), or both that is at least 1, at least 3, at least 5, at least 7, at least 10, at least 15, at least 20, at least 40, at least 50, at least 60, at least 80, at least 100, at least 125, at least 150, at least 175, at least 200, at least 225, at least 250, at least 300, at least 350, at least 400, or at least 500% as determined by the formula:

$$Feed - Based \% PVC Enrichment = \frac{PVCe - PVCm}{PVCm} \times 100$$

$$and$$

$$Product - Based \% PVC Enrichment = \frac{PVCe - PVCd}{PVCd} \times 100$$

where PVCe is the concentration of PVC in the PET-enriched product stream 112 on an undiluted dry weight basis;
PVCm is the concentration of PVC in the MPW feed stream 100 on an undiluted dry weight basis; and
where PVCd is the concentration of PVC in the PET-depleted product stream 114 on an undiluted dry weight basis.

In one embodiment or in combination with any of the mentioned embodiments, when a MPW stream 100 is fed to the preprocessing facility 20 (or separation zone 22), the PET-depleted stream 114 is enriched in polyolefins relative to the concentration or mass of polyolefins in the MPW feed stream 100, the PET-enriched product stream 112, or both, on an undiluted solids dry basis. In one embodiment or in combination with any of the mentioned embodiments, the PET-depleted stream 114 has a percent polyolefin enrichment relative to the MPW feed stream 100 (Feed-Based % PO Enrichment), or relative to the PET-enriched product stream 112 (Product-Based % PO Enrichment), or both that is at least 10, at least 20, at least 40, at least 50, at least 60, at least 80, at least 100, at least 125, at least 150, at least 175, at least 200, at least 225, at least 250, at least 300, at least 350, at least 400, at least 500, at least 600, at least 700, at least 800, at least 900, or at least 1000% as determined by the formula:

$$Feed - Based \% PO Enrichment = \frac{POd - POm}{POm} \times 100$$

$$and$$

$$Product - Based \% PO Enrichment = \frac{POd - POe}{POe} \times 100$$

where POd is the concentration of polyolefins in the PET-depleted product stream 114 on an undiluted dry weight basis;
POm is the concentration of PO in the MPW feed stream 100 on a dry weight basis; and
POe is the concentration of PO in the PET-enriched product stream 112 on a dry weight basis.

In one embodiment or in combination with any other embodiments, when a MPW stream 100 is fed to the preprocessing facility 20 (or separation zone 22), the PET-depleted stream 114 is also depleted in halogens, such as fluorine (F), chlorine (CI), bromine (Br), iodine (I), and astatine (At), and/or halogen-containing compounds, such as PVC, relative to the concentration or mass of halogens in the MPW stream 100, the PET-enriched stream 112, or both. In one embodiment or in combination with any of the mentioned embodiments, the PET-depleted stream 114 has a percent PVC depletion, relative to the MPW feed stream 100 (Feed-Based % PVC Depletion) or the PET-enriched product stream 112 (Product-Based % PVC Depletion) that is at least 1, at least 3, at least 5, at least 7, at least 10, at least 15, at least 20, at least 25, at least 30, at least 35, at least 40, at least 50, at least 60, at least 65, at least 70, at least 75, at least 80, at least 85, or at least 90% as determined by the formula:

$$Feed - Based \% PVC Depletion = \frac{PVCm - PVCd}{PVCm} \times 100$$

$$and$$

$$Product - Based \% PVC Depletion = \frac{PVCe - PVCd}{PVCe} \times 100$$

where PVCm is the concentration of PVC in the MPW feed stream 100 on an undiluted dry weight basis;
PVCd is the concentration of PVC in the PET-depleted product stream 114 on an undiluted dry weight basis; and
PVCe is the concentration of PVC in the PET-enriched product stream 112 on an undiluted dry weight basis.

The PET-depleted stream 114 is depleted in PET relative to the concentration or mass of PET in the MPW stream 100, the PET-enriched stream 112, or both. In one embodiment or in combination with any of the mentioned embodiments, the PET-depleted stream 114 has a percent PET depletion, relative to the MPW feed stream 100 (Feed-Base % PET Depletion) or the PET-enriched product stream 112 (Product-Based % PET Depletion) that is at least 1, at least 3, at least 5, at least 7, at least 10, at least 15, at least 20, at least 25, at least 30, at least 35, at least 40, at least 50, at least 60, at least 65, at least 70, at least 75, at least 80, at least 85, or at least 90% as determined by the formula:

$$Feed - Based \% PET Depletion = \frac{PETm - PETd}{PETm} \times 100$$

$$and$$

$$Product - Based \% PET Depletion = \frac{PETe - PETd}{PETe} \times 100$$

where PETm is the concentration of PET in the MPW feed stream 100 on an undiluted dry weight basis;
PETd is the concentration of PET in the PET-depleted product stream 114 on an undiluted dry weight basis; and
PETe is the concentration of PET in the PET-enriched product stream 112 on an undiluted dry weight basis.

The percentage enrichment or depletion in any of the above embodiments can be an average over 1 week, or over 3 days, or over 1 day, and the measurements can be conducted to reasonably correlate the samples taken at the exits of the process to MPW bulk from which the sample of MPW is taking into account the residence time of the MPW to flow from entry to exit. For example, if the average residence time of the MPW is 2 minutes, then the outlet sample would be taken two minutes after the input sample, so that the samples correlate to one another.

In an embodiment or in combination with any embodiment mentioned herein, the PET-enriched stream exiting the separation zone 22 or the preprocessing facility 20 may include at least 50, at least 55, at least 60, at least 65, at least 70, at least 75, at least 80, at least 85, at least 90, at least 95, at least 97, at least 99, at least 99.5, or at least 99.9 weight percent PET, based on the total weight of plastic in the PET-enriched stream 112. The PET-enriched stream 112 may also be enriched in PVC and can include, for example, at least 0.1, at least 0.5, at least 1, at least 2, at least 3, at least 5 and/or not more than 10, not more than 8, not more than 6, not more than 5, not more than 3 weight percent of halogens, including PVC, based on the total weight of plastic in the PET-enriched stream, or it can be in the range of 0.1 to 10 weight percent, 0.5 to 8 weight percent, or 1 to 5 weight percent, based on the total weight of plastic in the PET-enriched stream. The PET-enriched stream may include at least 50, at least 55, at least 60, at least 65, at least 70, at least 75, at least 80, at least 85, at least 90, at least 95, at least 99, or at least 99.5 weight percent of the total amount of PET introduced into the preprocessing facility 20 (or separation zone 22).

The PET-enriched stream 112 may also be depleted in PO and/or heavier plastics such as polytetrafluoroethylene (PTFE), polyamide (PA 12, PA 46, PA 66), polyacrylamide (PARA), polyhydroxybutyrate (PHB), polycarbonate polybutylene terephthalate blends (PC/PBT), polyvinyl chloride (PVC), polyimide (PI), polycarbonate (PC), polyethersulfone (PESU), polyether ether ketone (PEEK), polyamide imide (PAI), polyethylenimine (PEI), polysulfone (PSU), polyoxymethylene (POM), polyglycolides (poly(glycolic acid), PGA), polyphenylene sulfide (PPS), thermoplastic styrenic elastomers (TPS), amorphous thermoplastic polyimide (TPI), liquid crystal polymer (LCP), glass fiber-reinforced PET, chlorinated polyvinyl chloride (CPVC), polybutylene terephthalate (PBT), polyphthalamide (PPA), polyvinylidene chloride (PVDC), ethylene tetrafluoroethylene (ETFE), polyvinylidene fluoride (PVDF), fluorinated ethylene propylene (FEP), polymonochlorotrifluoroethylene (PCTFE), and perfluoroalkoxy (PFA), any of which may include carbon, glass, and/or mineral fillers, and which have a density higher than PET and PVC.

In an embodiment or in combination with any embodiment mentioned herein, the PET-enriched stream 112 may comprise not more than 45, not more than 40, not more than 35, not more than 30, not more than 25, not more than 20, not more than 15, not more than 10, not more than 5, not more than 2, not more than 1, not more than 0.5 weight percent PO, based on the total weight of plastic in the PET-enriched stream 112. The PET-enriched stream 112 may comprise not more than 10, not more than 8, not more than 5, not more than 3, not more than 2, or not more than 1 weight percent of the total amount of PO introduced into the preprocessing facility 20 (or separation zone 22). The PET-enriched stream 112 may comprise not more than 45, not more than 40, not more than 35, not more than 30, not more than 25, not more than 20, not more than 15, not more than 10, not more than 5, not more than 2, not more than 1 weight percent of components other than PET, based on the total weight of the PET-enriched stream 112.

Additionally, or in the alternative, the PET-enriched stream 112 can include not more than 2, not more than 1, not more than 0.5, or not more than 0.1 weight percent of adhesives on a dry basis. Typical adhesives include carpet glue, latex, styrene butadiene rubber, and the like. Additionally, the PET-enriched stream 112 can include not more than 4, not more than 3, not more than 2, not more than 1, not more than 0.5, or not more than 0.1 weight percent plastic fillers and solid additives on a dry basis. Exemplary fillers and additives include silicon dioxide, calcium carbonate, talc, silica, glass, glass beads, alumina, and other solid inerts, which do not chemically react with the plastics or other components in the processes described herein.

In an embodiment or in combination with any embodiment mentioned herein, the PET-depleted (or PO-enriched) stream 114 exiting the separation zone 22 or the preprocessing facility 20 may include at least 50, at least 55, at least 60, at least 65, at least 70, at least 75, at least 80, at least 85, at least 90, at least 95, at least 97, at least 99, or at least 99.5 weight percent PO, based on the total weight of plastic in the PET-depleted (or PO-enriched) stream 114. The PET-depleted (or PO-enriched stream) may be depleted in PVC and can include, for example, not more than 5, not more than 2, not more than 1, not more than 0.5, not more than 0.1, not more than 0.05, or not more than 0.01 weight percent of halogens, including chorine in PVC, based on the total weight of plastic in the PET-depleted (or PO-enriched) stream. The PET-depleted or PO-enriched stream may include at least 50, at least 55, at least 60, at least 65, at least 70, at least 75, at least 80, at least 85, at least 90, at least 95, at least 99, or at least 99.9 weight percent of the total amount of PO introduced into the preprocessing facility 20 or separation facility 22.

The PO-enriched stream 114 may also be depleted in PET and/or other plastics, including PVC. In an embodiment or in combination with any embodiment mentioned herein, the PET-depleted (or PO-enriched stream) may comprise not more than 45, not more than 40, not more than 35, not more than 30, not more than 25, not more than 20, not more than 15, not more than 10, not more than 5, not more than 2, not more than 1, not more than 0.5 weight percent PET, based on the total weight of plastic in the PET-depleted or PO-enriched stream. The PO-enriched (or PET-depleted) stream 114 may comprise not more than 10, not more than 8, not more than 5, not more than 3, not more than 2, or not more than 1 weight percent of the total amount of PET introduced into the preprocessing facility.

In an embodiment or in combination with any embodiment mentioned herein, the PET-depleted or PO-enriched stream 114 may also comprise not more than 45, not more than 40, not more than 35, not more than 30, not more than 25, not more than 20, not more than 15, not more than 10, not more than 5, not more than 2, not more than 1 weight percent of components other than PO, based on the total weight of PET-depleted or PO-enriched stream 114. The PET-depleted or PO-enriched stream 114 comprises not more than 4, not more than 2, not more than 1, not more than 0.5, or not more than 0.1 weight percent of adhesives, based on the total weight of the stream.

In an embodiment or in combination with any embodiment mentioned herein, the PET-depleted or PO-enriched stream 114 may have a melt viscosity of at least 1, at least 5, at least 50, at least 100, at least 200, at least 300, at least 400, at least 500, at least 600, at least 700, at least 800, at least 900, at least 1000, at least 1500, at least 2000, at least 2500, at least 3000, at least 3500, at least 4000, at least 4500, at least 5000, at least 5500, at least 6000, at least 6500, at least 7000, at least 7500, at least 8000, at least 8500, at least 9000, at least 9500, or at least 10,000 poise, measured using a Brookfield R/S rheometer with V80-40 vane spindle operating at a shear rate of 10 rad/s and a temperature of 350° C. Alternatively, or in addition, the PET-depleted or PO-enriched stream may have a melt viscosity of not more than 25,000, not more than 24,000, not more than 23,000, not more than 22,000, not more than 21,000, not more than 20,000, not more than 19,000, not more than 18,000, or not more than 17,000 poise, (measured at 10 rad/s and 350° C.). Or the stream may have a melt viscosity in the range of from 1 to 25,000 poise, 500 to 22,000 poise, or 1000 to 17,000 poise (measured at 10 rad/s and 350° C.).

Any suitable type of separation device, system, or facility may be employed to separate the waste plastic into two or more streams enriched in certain types of plastics such as, for example, the PET-enriched stream 112 and the PO-enriched stream 114. Examples of suitable types of separation include mechanical separation and density separation, which may include sink-float separation and/or centrifugal density separation. As used herein, the term “sink-float separation” refers to a density separation process where the separation of materials is primarily caused by floating or sinking in a selected liquid medium, while the term “centrifugal density separation” refers to a density separation process where the separation of materials is primarily caused by centrifugal forces. In general, the term “density separation process” refers to a process for separating materials based, at least in part, upon the respective densities of the materials into at least a higher-density output and a lower-density output and includes both sink-float separation and centrifugal density separation.

When sink-float separation is used, the liquid medium can comprise water. Salts, saccharides, and/or other additives can be added to the liquid medium, for example to increase the density of the liquid medium and adjust the target separation density of the sink-float separation stage. The liquid medium can comprise a concentrated salt solution. In one or more such embodiments, the salt is sodium chloride. In one or more other embodiments, however, the salt is a non-halogenated salt, such as acetates, carbonates, citrates, nitrates, nitrites, phosphates, and/or sulfates. The liquid medium can comprise a concentrated salt solution comprising sodium bromide, sodium dihydrogen phosphate, sodium hydroxide, sodium iodide, sodium nitrate, sodium thiosulfate, potassium acetate, potassium bromide, potassium carbonate, potassium hydroxide, potassium iodide, calcium chloride, cesium chloride, iron chloride, strontium chloride, zinc chloride, manganese sulfate, magnesium sulfate, zinc sulfate, and/or silver nitrate. In an embodiment or in combination with any embodiment mentioned herein, the salt is a caustic component. The salt may comprise sodium hydroxide, potassium hydroxide, and/or potassium carbonate. The concentrated salt solution may have a pH of greater than 7, greater than 8, greater than 9, or greater than 10.

In an embodiment or in combination with any embodiment mentioned herein, the liquid medium can comprise a saccharide, such as sucrose. The liquid medium can comprise carbon tetrachloride, chloroform, dichlorobenzene, dimethyl sulfate, and/or trichloro ethylene. The particular components and concentrations of the liquid medium may be selected depending on the desired target separation density of the separation stage. The centrifugal density separation process may also utilize a liquid medium as described above to improve separation efficiency at the target separation density.

In an embodiment or in combination with any embodiment mentioned herein, the waste plastic separation methods comprise at least two density separation stages. In certain such embodiments, the methods generally comprise introducing waste plastic particulates into the first density separation stage and feeding an output from the first density separation stage into the second density separation stage. The density separation stages can be any system or unit operation that performs a density separation process, as defined herein. At least one of the density separation stages comprises a centrifugal force separation stage or a sink-float separation stage. Each of the first and second density separation stages comprises a centrifugal force separation stage and/or a sink-float separation stage.

To produce a PET-enriched material stream, one of the density separation stages may comprise a low-density separation stage and the other generally comprises a high-density separation stage. As defined herein, the low-density separation stage has a target separation density less than the target separation density of the high-density separation stage. The low-density separation stage has a target separation density less than the density of PET, and the high-density separation stage has a target separation density greater than the density of PET.

As used herein, the term “target separation density” refers to a density above which materials subjected to a density separation process are preferentially separated into the higher-density output and below which materials are separated in the lower-density output. The target separation density specifies a density value, wherein it is intended that all plastics and other solid materials having a density higher than the value are separated into the higher-density output and all plastics and other solid materials having a density lower than the value are separated into the lower-density output. However, the actual separation efficiency of the materials in a density separation process may depend on various factors, including residence time and relative closeness of the density of a particular material to the target density separation value, as well as factors related to the form of the particulate such as, for example, area-to-mass ratio, degree of sphericity, and porosity.

In an embodiment or in combination with any embodiment mentioned herein, the low-density separation stage has a target separation density that is less than 1.35, less than 1.34, less than 1.33, less than 1.32, less than 1.31, or less than 1.30 g/cc and/or at least 1.25, at least 1.26, at least 1.27, at least 1.28, or at least 1.29 g/cc. The high-density separation stage has a target separation density that is at least 0.01, at least 0.025, at least 0.05, at least 0.075, at least 0.1, at least 0.15, or at least 0.2 g/cc greater than the target separation density of the low-density separation stage. The target separation density of the high-density separation stage is at least 1.31, at least 1.32, at least 1.33, at least 1.34, at least 1.35, at least 1.36, at least 1.37, at least 1.38, at least 1.39, or at least 1.40 g/cc and/or not more than 1.45, not more than 1.44, not more than 1.43, not more than 1.42, or not more than 1.41 g/cc. The target separation density of the low-density separation stage is in the range of 1.25 to 1.35 g/cc and the target separation density of said high-density separation stage is in the range of 1.35 to 1.45 g/cc.

Referring again to FIG. 1, both the PET-enriched stream 112 and the PO-enriched stream 114 may be introduced into one or more downstream processing facilities (or undergo one or more downstream processing steps) within the chemical recycling facility 10. In an embodiment or in combination with any embodiment mentioned herein, at least a portion of the PET-enriched stream 112 may be introduced into a solvolysis facility 30, while at least a portion of the PO-enriched stream 114 may be directly or indirectly introduced into one or more of a pyrolysis facility 60 and a partial oxidation (PDX) gasification facility 50. Additional details of each step and type of facility, as well as the general integration of each of these steps or facilities with one or more of the others according to one or more embodiments of the present technology are discussed in further detail below.

### Solvolysis

In an embodiment or in combination with any embodiment mentioned herein, at least a portion of a PET-enriched stream 112 from the preprocessing facility 20 may be introduced into a solvolysis facility 30. As used herein, the term “solvolysis” or “ester solvolysis” refers to a reaction by which an ester-containing feed is chemically decomposed in the presence of a solvent to form a principal carboxyl product and a principal glycol product. A “solvolysis facility” is a facility that includes all equipment, lines, and controls necessary to carry out solvolysis of waste plastic and feedstocks derived therefrom.

As shown in FIG. 1, the solvolysis facility can be operated to provide a recycle content principal glycol stream 106, a recycle content principal terephthalyl stream 108 and one or more solvolysis coproduct streams, shown as stream 110, which may also be withdrawn from one or more locations within the solvolysis facility. As used herein, the term “coproduct” or “solvolysis coproduct” refers to any compound from a solvolysis facility that is not the principal carboxyl (terephthalyl) product of the solvolysis facility, the principal glycol product of the solvolysis facility, or the principal solvent fed to the solvolysis facility. The solvolysis coproduct stream 110 can be optionally integrated into various locations within facility 10. For example, stream 110 can be combined with the polyolefin-enriched stream 114 (or stream 117), added directed to a liquification/dehalogenation process 40, combined with an output stream from process 40, directed to a partial oxidation gasification process 50, or directed to another on-site or off-site chemical recycling facility.

### Liquification/Dehalogenation

As shown in FIG. 1, the PO-enriched waste plastic stream 114 (with or without being combined with a solvolysis coproduct stream 110) may optionally be introduced into a liquification zone or step prior to being introduced into one or more of the downstream processing facilities. As used herein, the term “liquification” zone or step refers to a chemical processing zone or step in which at least a portion of the incoming plastic is liquefied. The step of liquefying plastic can include chemical liquification, physical liquification, or combinations thereof. Exemplary methods of liquefying the polymer introduced into the liquification zone can include (i) heating/melting; (ii) dissolving in a solvent; (iii) depolymerizing; (iv) plasticizing, and combinations thereof. Additionally, one or more of options (i) through (iv) may also be accompanied by the addition of a blending or liquification agent to help facilitate the liquification (reduction of viscosity) of the polymer material. As such, a variety of rheology modification agents (e.g., solvents, depolymerization agents, plasticizers, and blending agents) can be used the enhance the flow and/or dispersibility of the liquified waste plastic.

When added to the liquification zone 40, at least 50, at least 55, at least 60, at least 65, at least 70, at least 75, at least 80, at least 85, at least 90, at least 95, or at least 99 weight percent of the plastic (usually waste plastic) undergoes a reduction in viscosity. In some cases, the reduction in viscosity can be facilitated by heating (e.g., addition of steam directly or indirectly contacting the plastic), while, in other cases, it can be facilitated by combining the plastic with a solvent capable of dissolving it. Examples of suitable solvents can include, but are not limited to, alcohols such as methanol or ethanol, glycols such as ethylene glycol, diethylene glycol, triethylene glycol, neopentyl glycol, cyclohexanedimethanol, glycerin, pyrolysis oil, motor oil, and water. As shown in FIG. 1, the solvent stream 141 can be added directly to the liquification zone 40, or it can be combined with one or more streams fed to the liquification zone 40 (not shown in FIG. 1).

In an embodiment or in combination with any embodiment mentioned herein, the solvent can comprise a stream withdrawn from one or more other facilities within the chemical recycling facility. For example, the solvent can comprise a stream withdrawn from at least one of the solvolysis facility 30 and the pyrolysis facility 60. The solvent can be or comprise at least one of the solvolysis coproducts described herein or can be or comprise pyrolysis oil.

In some cases, the plastic can be depolymerized such that, for example, the number average chain length of the plastic is reduced by contact with a depolymerization agent. In an embodiment or in combination with any embodiment mentioned herein, at least one of the previously-listed solvents may be used as a depolymerization agent, while, in one or more other embodiments, the depolymerization agent can include an organic acid (e.g., acetic acid, citric acid, butyric acid, formic acid, lactic acid, oleic acid, oxalic, stearic acid, tartaric acid, and/or uric acid) or inorganic acid such as sulfuric acid (for polyolefin). The depolymerization agent may reduce the melting point and/or viscosity of the polymer by reducing its number average chain length.

Alternatively, or additionally, a plasticizer can be used in the liquification zone to reduce the viscosity of the plastic. Plasticizers for polyethylene include, for example, dioctyl phthalate, dioctyl terephthalate, glyceryl tribenzoate, polyethylene glycol having molecular weight of up to 8,000 Daltons, sunflower oil, paraffin wax having molecular weight from 400 to 1,000 Daltons, paraffinic oil, mineral oil, glycerin, EPDM, and EVA. Plasticizers for polypropylene include, for example, dioctyl sebacate, paraffinic oil, isooctyl tallate, plasticizing oil (Drakeol 34), naphthenic and aromatic processing oils, and glycerin. Plasticizers for polyesters include, for example, polyalkylene ethers (e.g., polyethylene glycol, polytetramethylene glycol, polypropylene glycol or their mixtures) having molecular weight in the range from 400 to 1500 Daltons, glyceryl monostearate, octyl epoxy soyate, epoxidized soybean oil, epoxy tallate, epoxidized linseed oil, polyhydroxyalkanoate, glycols (e.g., ethylene glycol, pentamethylene glycol, hexamethylene glycol, etc.), phthalates, terephthalates, trimellitate, and polyethylene glycol di-(2-ethylhexoate). When used, the plasticizer may be present in an amount of at least 0.1, at least 0.5, at least 1, at least 2, or at least 5 weight percent and/or not more than 10, not more than 8, not more than 5, not more than 3, not more than 2, or not more than 1 weight percent, based on the total weight of the stream, or it can be in a range of from 0.1 to 10 weight percent, 0.5 to 8 weight percent, or 1 to 5 weight percent, based on the total weight of the stream.

Further, one or more of the methods of liquifying the waste plastic stream can also include adding at least one blending agent to the plastic before, during, or after the liquification process. Such blending agents may include for example, emulsifiers and/or surfactants, and may serve to more fully blend the liquified plastic into a single phase, particularly when differences in densities between the plastic components of a mixed plastic stream result in multiple liquid or semi-liquid phases. When used, the blending agent may be present in an amount of at least 0.1, at least 0.5, at least 1, at least 2, or at least 5 weight percent and/or not more than 10, not more than 8, not more than 5, not more than 3, not more than 2, or not more than 1 weight percent, based on the total weight of the stream, or it can be in a range of from 0.1 to 10 weight percent, 0.5 to 8 weight percent, or 1 to 5 weight percent, based on the total weight of the stream.

When combined with the PO-enriched plastic stream 114 as generally shown in FIG. 1, the solvolysis coproduct stream (which can include one or more solvolysis coproducts described herein) may be added before introduction of the PO-enriched waste plastic stream 114 into the liquification zone 40 (as shown by line 113) and/or after removal of the liquified plastic stream from the liquification zone 40 (as shown by line 115). In an embodiment or in combination with any embodiment mentioned herein, at least a portion or all of one or more coproduct streams may also be introduced directly into the liquification zone, as shown in FIG. 1. In an embodiment or in combination with any embodiment mentioned herein, at least a portion of the PO-enriched waste plastic stream 114 can bypass the liquification zone 40 altogether in line 117 and may optionally combined with at least one solvolysis coproduct stream 110 as also shown in FIG. 1.

Additionally, as shown in FIG. 1, a portion of the pyrolysis oil stream 143 withdrawn from the pyrolysis facility 60 can be combined with the PO-enriched plastic stream 114 to form a liquified plastic. Although shown as being introduced directly into the liquification zone 40, all or a portion of the pyrolysis oil stream 143 may be combined with the PO-enriched plastic stream 114 prior to introduction into the liquification zone 40, or after the PO-enriched plastic stream 114 exits the liquification zone 40. When used, the pyrolysis oil can be added at one or more locations described herein, alone or in combination with one or more other solvent streams.

In an embodiment or in combination with any embodiment mentioned herein, the feed stream to one or more of the downstream chemical recycling facilities from the liquification zone 40 can comprise at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 weight percent of one or more solvolysis coproduct streams, based on the total weight of the feed stream introduced into the downstream processing facility or facilities. For example, the feed streams 116 and 118 to each of the PDX facility 50 and/or the pyrolysis facility 60 of the chemical recycling facility 10 may include PO-enriched waste plastic and an amount of one or more solvolysis coproducts described herein.

Additionally, or in the alternative, the feed stream to the pyrolysis facility 60 or the PDX facility 50, can comprise not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 5, not more than 2, or not more than 1 weight percent of one or more solvolysis coproduct streams, based on the total weight of the feed stream introduced into the downstream processing facility or facilities.

Alternatively, or in addition, the liquified (or reduced viscosity) plastic stream withdrawn from the liquification zone 40 can include at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 weight percent and/or not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 5, not more than 2, or not more than 1 weight percent of PO, based on the total weight of the stream, or the amount of PO can be in the range of from 1 to 95 weight percent, 5 to 90 weight percent, or 10 to 85 weight percent, based on the total weight of the stream.

In an embodiment or in combination with any embodiment mentioned herein, the liquified plastic stream exiting the liquification zone 40 can have a viscosity of less than 3,000, less than 2,500, less than 2,000, less than 1,500, less than 1,000, less than 800, less than 750, less than 700, less than 650, less than 600, less than 550, less than 500, less than 450, less than 400, less than 350, less than 300, less than 250, less than 150, less than 100, less than 75, less than 50, less than 25, less than 10, less than 5, or less than 1 poise, measured using a Brookfield R/S rheometer with V80-40 vane spindle operating at a shear rate of 10 rad/s and a temperature of 350° C. In an embodiment or in combination with any embodiment mentioned herein, the viscosity (measured at 350° C. and 10 rad/s and expressed in poise) of the liquified plastic stream exiting the liquification zone is not more than 95, not more than 90, not more than 75, not more than 50, not more than 25, not more than 10, not more than 5, or not more than 1 percent of the viscosity of the PO-enriched stream introduced into the liquification zone.

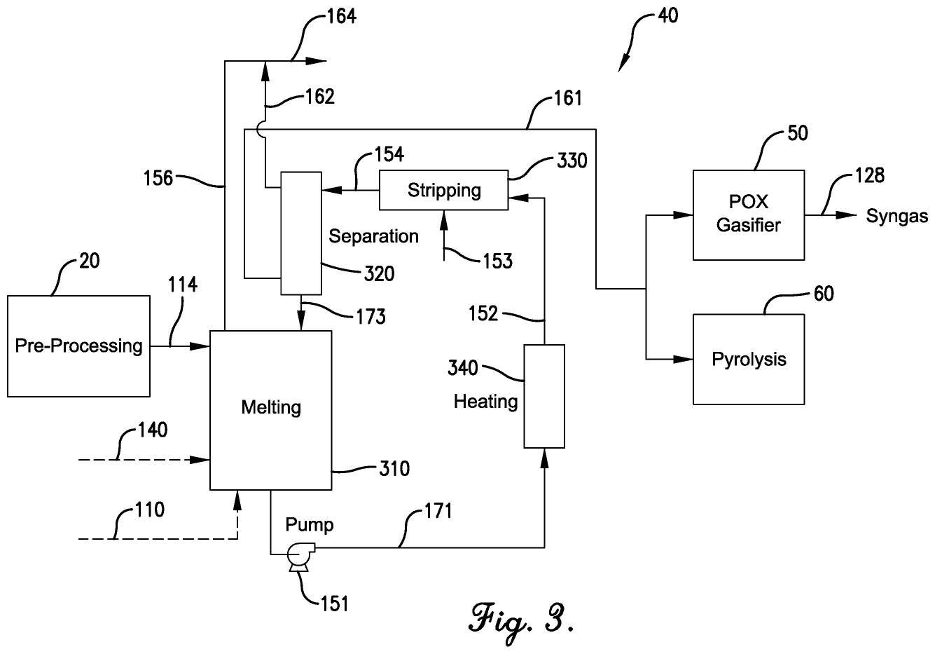

FIG. 3 shows the basic components in a liquification system that may be used as the liquification zone 40 in the chemical recycling facility illustrated in FIG. 1. It should be understood that FIG. 3 depicts one exemplary embodiment of a liquification system. Certain features depicted in FIG. 3 may be omitted and/or additional features described elsewhere herein may be added to the system depicted in FIG. 3.

As shown in FIG. 3, a waste plastic feed, such as the PO-enriched waste plastic stream 114, may be derived from a waste plastic source, such as the preprocessing facility 20 discussed herein. The waste plastic feed, such as the PO-enriched waste plastic stream 114, may be introduced into the liquification zone 40, which FIG. 3 depicts as containing at least one melt tank 310, at least one circulation loop pump 312, at least one external heat exchanger 340, at least one stripping column 330, and at least one disengagement vessel 320. These various exemplary components and their functionality in the liquification zone 40 are discussed in greater detail below.

In an embodiment or in combination with any embodiment mentioned herein, and as shown in FIG. 3, the liquification zone 40 includes a melt tank 310 and a heater. The melt tank 310 receives the waste plastic feed, such as PO-enriched waste plastic stream 114, and the heater heats the waste plastic. In an embodiment or in combination with any embodiment mentioned herein, the melt tank 310 can include one or more continuously stirred tanks. When one or more rheology modification agents (e.g., solvents, depolymerization agents, plasticizers, and blending agents) are used in the liquification zone, such rheology modification agents can be added to and/or mixed with the PO-enriched plastic in or prior to the melt tank 310.

In an embodiment or in combination with any embodiment mentioned herein (not shown in FIG. 3), the heater of the liquification zone 40 can take the form of internal heat exchange coils located in the melt tank 310, a jacketing on the outside of the melt tank 310, a heat tracing on the outside of the melt tank 310, and/or electrical heating elements on the outside of the melt tank 310. Alternatively, as shown in FIG. 3, the heater of the liquification zone 40 can include an external heat exchanger 340 that receives a stream of liquified plastic 171 from the melt tank 310, heats it, and returns at least a portion of the heated liquified plastic stream 173 to the melt tank 310.

As shown in FIG. 3, when an external heat exchanger 340 is used to provide heat for the liquification zone 40, a circulation loop can be employed to continuously add heat to the PO-enriched material. In an embodiment or in combination with any embodiment mentioned herein, the circulation loop includes the melt tank 310, the external heat exchanger 340, conduits, shown as line 171, connecting the melt tank and the external heat exchanger, and a pump 151 for circulating liquified waste plastic in the circulation loop. When a circulation loop is employed, the liquified PO-enriched material produced can be continuously withdrawn from the liquification zone 40 as a fraction of the circulating PO-enriched stream via conduit 161 shown in FIG. 3.

In an embodiment or in combination with any embodiment mentioned herein, the liquification zone 40 may optionally contain equipment for removing halogens from the PO-enriched material. When the PO-enriched material is heated in the liquification zone 40, halogen enriched gases can evolve. By disengaging the evolved halogen-enriched gasses from the liquified PO-enriched material, the concentration of halogens in the PO-enriched material can be reduced.

In an embodiment or in combination with any embodiment mentioned herein, dehalogenation can be promoted by sparging a stripping gas (e.g., steam) into the liquified PO-enriched material either in the melt tank 310 or at another location in the circulation loop. As shown in FIG. 3, a stripper 330 and a disengagement vessel 320 can be provided in the circulation loop downstream of the external heat exchanger 340 and upstream of the melt tank 310. As shown in FIG. 3, the stripper 330 can receive the heated liquified plastic stream 173 from the external heat exchanger 340 and provide for the sparging of a stripping gas 153 into the liquified plastic. Sparging of a stripping gas 153 into the liquified plastic can create a two-phase medium in the stripper 330.

This two-phase medium introduced into the disengagement vessel 320 via stream 175 can then be flowed (e.g., by gravity) through the disengagement vessel 320, where a halogen-enriched gaseous phase is disengaged from a halogen-depleted liquid phase and removed from the disengagement vessel 320 via stream 162. Alternatively, a portion of the heated liquefied plastic 173 from the external heat exchanger 340 may bypass the stripper 330 and be introduced directly into the disengagement vessel 320. In an embodiment or in combination with any embodiment mentioned herein, a first portion of the halogen-depleted liquid phase discharged from an outlet of the disengagement vessel can be returned to the melt tank 310 in line 159, while a second portion of the halogen-depleted liquid phase can be discharged from the liquification zone as the dehalogenated, liquified, PO-enriched product stream 161. The disengaged halogen-enriched gaseous stream from the disengagement vessel 162 and from the melt tank 310 in line 164 can be removed from the liquification zone 40 for further processing and/or disposal.

In an embodiment or in combination with any embodiment mentioned herein, the dehalogenated liquified waste plastic stream 161 exiting the liquification zone 40 can have a halogen content of less than 500, less than 400, less than 300, less than 200, less than 100, less than 50, less than 10, less than 5, less than 2, less than 1, less than 0.5, or less than 0.1 ppmw. The halogen content of the liquified plastic stream 161 exiting the liquification zone 40 is not more than 95, not more than 90, not more than 75, not more than 50, not more than 25, not more than 10, or not more than 5 percent by weight of the halogen content of the PO-enriched stream introduced into the liquification zone.

As shown in FIG. 3, at least a portion of the dehalogenated liquified waste plastic stream 161 may be introduced into a downstream PDX gasifier at a PDX gasification facility 50 to produce a syngas composition and/or a downstream pyrolysis reactor at a pyrolysis facility 60 to produce pyrolysis vapors (i.e., pyrolysis gas and pyrolysis oil) and pyrolysis residue.

In an embodiment or in combination with any embodiment mentioned herein, the chemical recycling facility 10 may not include a liquification zone 40. Alternatively, the chemical recycling facility may include a liquification zone 40 but may not include any type of dehalogenation zone or equipment.

Referring again to FIG. 1, at least a portion of a PO-enriched plastic stream 114 from the preprocessing facility 20 and/or from liquification zone 40 (alone or in combination with one or more solvolysis coproduct streams 110) may be introduced into one or more of the downstream processing facilities including, for example, the pyrolysis facility 60 and the PDX gasification facility 50, as discussed in detail below.

### Pyrolysis

In an embodiment or in combination with any embodiment mentioned herein, the chemical recycling facility 10 generally depicted in FIG. 1 may comprise a pyrolysis facility 60. As used herein the term “pyrolysis” refers to the thermal decomposition of one or more organic materials at elevated temperatures in an inert (i.e., substantially oxygen free) atmosphere. A “pyrolysis facility” is a facility that includes all equipment, lines, and controls necessary to carry out pyrolysis of waste plastic and feedstocks derived therefrom. Pyrolysis facility 60 can be configured for converting a waste plastic stream 118, such as the liquefied waste plastic from a liquification zone, into a pyrolysis gas, a pyrolysis oil, and a pyrolysis residue. Optionally, at least a portion of any one of these products can be fed to the partial oxidation gasifier process 50, or recycled to the liquidfication/dehalogen process 40 via stream 143.

### Partial Oxidation (PDX) Gasification

In an embodiment or in combination with any embodiment mentioned herein, the chemical recycling facility may also comprise a partial oxidation (PDX) gasification facility. As used herein, the term “partial oxidation” to high temperature conversion of a carbon-containing feed into syngas (carbon monoxide, hydrogen, and carbon dioxide), where the conversion is carried out in the presence of a sub-stoichiometric amount of oxygen. The conversion can be of a hydrocarbon-containing feed and can be carried out with an amount of oxygen that is less than the stoichiometric amount of oxygen needed for complete oxidation of the feed—i.e., all carbon oxidized to carbon dioxide and all hydrogen oxidized to water. The reactions occurring within a partial oxidation (PDX) gasifier include conversion of a carbon-containing feed into syngas, and specific examples include, but are not limited to partial oxidation, water gas shift, water gas—primary reactions, Boudouard, oxidation, methanation, hydrogen reforming, steam reforming, and carbon dioxide reforming. The feed to PDX gasification can include solids, liquids, and/or gases. A “partial oxidation facility” or “PDX gasification facility” is a facility that includes all equipment, lines, and controls necessary to carry out PDX gasification of waste plastic and feedstocks derived therefrom.

In one or more embodiments, the present technology is generally directed to a method of producing synthesis gas (syngas) from a plastic material. The method generally comprises feeding the plastic material and an oxidizing agent comprising molecular oxygen (O2) into a PDX gasifier and performing a partial oxidation reaction within the gasifier by reacting at least a portion of the plastic material and the molecular oxygen. The plastic material feedstock may be in a solid or liquid form prior to being fed to the PDX gasifier. In one or more embodiments, the plastic material may be fed to the PDX gasifier in a liquid stream (as a solid or liquified plastic), a liquified plastic stream, and/or a plastic-containing slurry. In one or more embodiments, an atomization enhancing fluid, other than the oxidizing agent, is fed to the PDX gasifier along with the plastic material and oxidizing agent or added to (or mixed with) the plastic material before feeding the plastic material to the PDX gasifier. However, in one or more embodiments, no atomization enhancing fluid is fed to the PDX gasifier along with the plastic material and oxidizing agent or separately added to (or mixed with) the plastic material before feeding the plastic material to the PDX gasifier.

In the PDX gasification facility, the feed stream may be converted to syngas in the presence of a sub-stoichiometric amount of oxygen. In an embodiment or in combination with any embodiment mentioned herein, the feed stream to the PDX gasification facility may comprise one or more of a PO-enriched waste plastic, at least one solvolysis coproduct stream, a pyrolysis stream (including pyrolysis gas, pyrolysis oil, and/or pyrolysis residue), and at least one stream from the cracking facility. One or more of these streams may be introduced into the PDX gasification facility continuously or one or more of these streams may be introduced intermittently. When multiple types of feed streams are present, each may be introduced separately, or all or a portion of the streams may be combined so that the combined stream may be introduced into the PDX gasification facility. The combining, when present, may take place in a continuous or batch manner. The feed stream can be in the form of a gas, a liquid or liquified plastic, solids (usually comminuted), or a slurry.

The feed stream(s) can be in the form of a gas, a liquid or liquified plastic, solids (usually comminuted), and/or a slurry, and will generally include at least one plastic material or plastic material-containing feedstock. In an embodiment or in combination with any embodiment mentioned herein, the gasification feedstock stream may also comprise at least 1, at least 5, at least 10, at least 15, at least 20, at least 25, at least 30, at least 35, at least 40, at least 45, or at least 50 weight percent of one or more optional fossil fuels, based on the total weight of the gasification feedstock stream. Additionally, or in the alternative, the gasification feedstock stream may also comprise not more than 99, not more than 90, not more than 80, not more than 70, not more than 60, not more than 50, not more than 40, not more than 30, not more than 20, not more than 10, not more than 5, not more than 4, not more than 3, not more than 2, or not more than 1 weight percent of one or more optional fossil fuels, based on the total weight of the gasification feedstock stream. In one or more embodiments, the gasification feed stock stream may comprise from 1 to 99, from 5 to 90, from 10 to 80, from 15 to 70, from 20 to 60, from 30 to 50, or from 35 to 40 weight percent of one or more optional fossil fuels. Such fossil fuels may, for example, comprise solid fuels. Such fossil fuels may, for example, comprise organic materials that are short chain, such as those with a carbon number of less than 12, and are typically oxygenated. Exemplary fossil fuels include, but are not limited to, solid fuels (e.g., coal, pet coke, waste plastics, etc.) such as coal, liquid fuels (e.g., liquid hydrocarbons, liquefied plastics, etc.), gas fuels (e.g., natural gas, organic hydrocarbons, etc.) and/or other traditional fuel(s) having a positive heating value including products derived from a chemical synthesis process utilizing a traditional fossil fuel as a feedstock. Other possible fossil fuels may include, but are not limited to, fuel oil and liquid organic waste streams. The fossil fuels may include or contain one or more vitrification materials. As used herein, a “gasification feedstock” or “gasifier feed” refers to all components fed into the gasifier except oxygen.

In an embodiment or in combination with any embodiment mentioned herein, the plastic may be added to a coal (or pet coke) slurry and/or added to dry coal or pet coke and formed into a coal/plastic slurry before being fed to the gasifier. In one or more embodiments, dry coal or pet coke may be added to a plastic-containing slurry being fed to said PDX gasifier. However, in one or more embodiments, the plastic feed is introduced to the gasifier without being combined with coal and/or without any coal being fed separately to the gasifier. As used herein, the term “dry coal” refers to a quantity of coal having a liquid content of less than 20% by weight, the liquid content including both inherent liquid (inherent moisture or equilibrium moisture) and surface liquid (surface moisture). In one or more embodiments, dry coal comprises a greater amount of inherent liquid than surface liquid. In one or more embodiments, dry coal is not in the form of a slurry. In one or more embodiments, the dry coal may have a liquid content of less than 20%, less than 15%, less than 10%, or less than 5% by weight. The coal feedstock may include peat, lignite, sub-bituminous, bituminous, anthracite, and/or petroleum coke (pet coke) coal types. In one or more embodiments, the coal feedstock comprises anthracite and/or pet coke.

In an embodiment or in combination with any embodiment mentioned herein, the plastic feed stream can comprise at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 weight percent of one or more solvolysis coproduct streams, based on the total weight of the plastic feed stream(s) introduced into the gasification zone. Additionally, or in the alternative, the plastic feed stream can comprise not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 5, not more than 2, or not more than 1 weight percent of one or more solvolysis coproduct streams, based on the total weight of the plastic feed stream(s) introduced into the gasification zone. In one or more embodiments, the plastic feed stream can comprise from 1 to 95, from 5 to 90, from 10 to 85, from 15 to 80, from 20 to 75, from 25 to 70, from 30 to 65, from 35 to 60, from 40 to 55, or from 45 to 50 weight percent of one or more solvolysis coproduct streams, based upon the total weight of the plastic feed stream(s) introduced into the gasification zone.

In an embodiment or in combination with any embodiment mentioned herein, one or more of the feed stream(s) are in the form of a liquified plastic. In one or more embodiments, the liquified plastic feedstock comprises one or more molten, solvated, depolymerized, plasticized, and/or blended plastic materials, which may be derived from and/or include similar compositions and/or properties as the plastic-containing streams produced from the liquification/dehalogenation processes described herein.

In an embodiment or in combination with any embodiment mentioned herein, the liquid and/or liquified plastic feed can have a viscosity of less than 3,000, less than 2,500, less than 2,000, less than 1,500, less than 1,000, less than 800, less than 750, less than 700, less than 650, less than 600, less than 550, less than 500, less than 450, less than 400, less than 350, less than 300, less than 250, less than 150, less than 100, less than 75, less than 50, less than 40, less than 30, less than 25, less than 20, less than 10, less than 5, less than 4, less than 3, less than 2, or less than 1 poise, measured using a Brookfield R/S rheometer with V80-40 vane spindle operating at a shear rate of 10 rad/s and a temperature of 350° C. In one or more embodiments, the viscosity (measured at 350° C. and 10 rad/s and expressed in poise) of the liquid and/or liquified plastic feed is not more than 95, not more than 90, not more than 75, not more than 50, not more than 25, not more than 10, not more than 5, or not more than 1 percent of the viscosity of the waste plastic stream introduced into the liquification system (measured at 350° C. and 10 rad/s and expressed in poise).

In an embodiment or in combination with any embodiment mentioned herein, the liquid and/or liquified plastic feed can have a halogen content of less than 500, less than 400, less than 300, less than 200, less than 100, less than 50, less than 10, less than 5, less than 2, less than 1, less than 0.5, or less than 0.1 ppmw. Alternatively, or in addition, the liquid and/or liquified plastic feed can include at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 weight percent and/or not more than 99.9, not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 5, not more than 2, or not more than 1 weight percent of one or more polyolefins, based on the total weight of the stream. In one or more embodiments, the liquid and/or liquified plastic feed can comprise from 1 to 99.9, from 5 to 95, from 10 to 90, from 15 to 85, from 20 to 80, from 25 to 75, from 30 to 70, from 35 to 65, from 40 to 60, or from 45 to 55 weight percent of one or more polyolefins, based on the total weight of the stream. In one or more embodiments, the liquid and/or liquified plastic feed can comprise at least 0.25, at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 weight percent and/or not more than 99.9, not more than 99, not more than 98, not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 5, not more than 2, or not more than 1 weight percent PET on a dry basis. In one or more embodiments, the liquid and/or liquified plastic feed can comprise from 0.25 to 99.9, from 1 to 99, from 5 to 98, from 10 to 95, from 15 to 90, from 20 to 85, from 25 to 80, from 30 to 75, from 35 to 70, from 40 to 65, from 45 to 60, or from 50 to 55 weight percent PET on a dry basis. In one or more embodiments, the liquid and/or liquified plastic feed can comprise at least 0.1, at least 1, at least 2, at least 4, or at least 6 and/or not more than 50, not more than 40, not more than 30, not more than 20, or not more than 10 weight percent PVC on a dry basis. In one or more embodiments, the liquid and/or liquified plastic feed can comprise from 0.1 to 50, from 1 to 40, from 2 to 30, from 4 to 20, or from 6 to 10 weight percent PVC on a dry basis.

In an embodiment or in combination with any embodiment mentioned herein, the plastic material feedstock is fed into the gasifier at a flow rate of greater than 453 kg/hr (1000 lbs/hr), greater than 2,268 kg/hr (5000 lbs/hr), greater than 4,530 kg/hr (10,000 lbs/hr), greater than 9,072 kg/hr (20,000 lbs/hr), greater than 18,144 kg/hr (40,000 lbs/hr), greater than 36,287 kg/hr (80,000 lbs/hr), or greater than 54,431 kg/hr (120,000 lbs/hr) and not more than not more than 226, 800 kg/hr (500,000 lbs/hr), not more than 181,437 kg/hr (400,000 lbs/hr), not more than 136,078 kg/hr (300,000 lbs/hr), not more than 90,720 kg/hr (200,000 lbs/hr), or not more than 68,039 kg/hr (150,000 lbs/hr). In one or more embodiments, the plastic material feedstock comprises at least 20, at least 30, at least 40, at least 50, at least 60, at least 70, at least 80, or at least 90 weight percent of the streams being fed to the PDX gasifier.

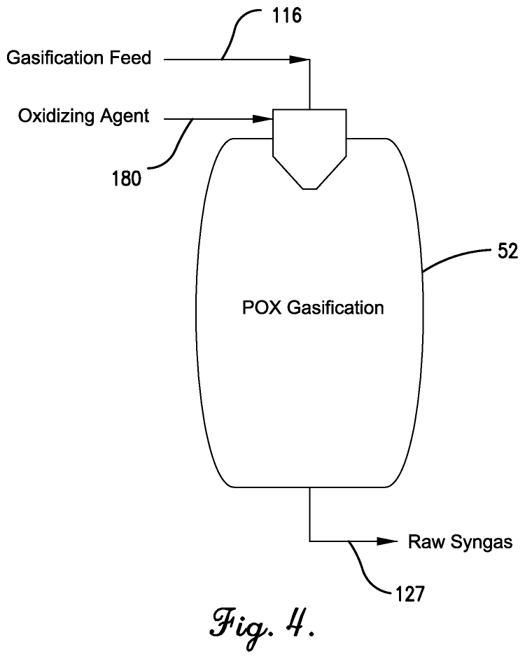

The PDX gasification facility includes at least one PDX gasification reactor. An exemplary PDX gasification reactor 52 is shown in FIG. 4. The PDX gasification unit may comprise a gas-fed, a liquid-fed, or a solid-fed reactor (or gasifier). In an embodiment or in combination with any embodiment mentioned herein, the PDX gasification facility may perform liquid-fed PDX gasification. As used herein, “liquid-fed PDX gasification” refers to a PDX gasification process where the feed to the process comprises predominately (by weight) components that are liquid at 25° C. and 1 atm. Additionally, or alternatively, PDX gasification unit may perform gas-fed PDX gasification. As used herein, “gas-fed PDX gasification” refers to a PDX gasification process where the feed to the process comprises predominately (by weight) components that are gaseous at 25° C. and 1 atm.

Additionally, or alternatively, PDX gasification unit may conduct solid-fed PDX gasification. As used herein, “solid-fed PDX gasification” refers to a PDX gasification process where the feed to the process comprises predominately (by weight) components that are solid at 25° C. and 1 atm.

Gas-fed, liquid-fed, and solid-fed PDX gasification processes can be co-fed with lesser amounts of other components having a different phase at 25° C. and 1 atm. Thus, gas-fed PDX gasifiers can be co-fed with liquids and/or solids, but only in amounts that are less (by weight) than the amount of gasses fed to the gas-phase PDX gasifier; liquid-fed PDX gasifiers can be co-fed with gasses and/or solids, but only in amounts (by weight) less than the amount of liquids fed to the liquid-fed PDX gasifier; and solid-fed PDX gasifiers can be co-fed with gasses and/or liquids, but only in amounts (by weight) less than the amount of solids fed to the solid-fed PDX gasifier.

In an embodiment or in combination with any embodiment mentioned herein, the total feed to a gas-fed PDX gasifier can comprise at least 60, at least 70, at least 80, at least 90, or at least 95 weight percent of components that are gaseous at 25° C. and 1 atm; the total feed to a liquid-fed PDX gasifier can comprise at least 60, at least 70, at least 80, at least 90, or at least 95 weight percent of components that are liquid at 25° C. and 1 atm; and the total feed to a solid-fed PDX gasifier can comprise at least 60, at least 70, at least 80, at least 90, or at least 95 weight percent of components that are solids at 25° C. and 1 atm.

As generally shown in FIG. 4, the gasification feeds stream 116 may be introduced into a gasification reactor along with an oxidizing agent stream 180. The feedstock stream 116 and the oxidizing agent stream 180 may be sprayed through an injector assembly into a pressurized gasification zone having, for example, a pressure, typically at least 500, at least 600, at least 800, or at least 1,000 psig, (or at least 35, at least 40, at least 55, or at least 70 barg).

In an embodiment or in combination with any embodiment mentioned herein, the oxidizing agent in stream 180 comprises an oxidizing gas that can include air, oxygen-enriched air, or molecular oxygen (O2). The oxidizing agent can comprise at least 25, at least 35, at least 40, at least 50, at least 60, at least 70, at least 80, at least 90, at least 95, at least 97, at least 99, or at least 99.5 mole percent of molecular oxygen based on the total moles of all components in the oxidizing agent stream 180 injected into the reaction (combustion) zone of the gasification reactor 52. The particular amount of oxygen as supplied to the reaction zone can be sufficient to obtain near or maximum yields of carbon monoxide and hydrogen obtained from the gasification reaction relative to the components in the feed stream 116, considering the amount relative to the feed stream, and the amount of feed charged, the process conditions, and the reactor design.

The oxidizing agent can include other oxidizing gases or liquids, in addition to or in place of air, oxygen-enriched air, and molecular oxygen. Examples of such oxidizing liquids suitable for use as oxidizing agents include water (which can be added as a liquid or as steam) and ammonia. Examples of such oxidizing gases suitable for use as oxidizing agents include carbon monoxide, carbon dioxide, and sulfur dioxide.

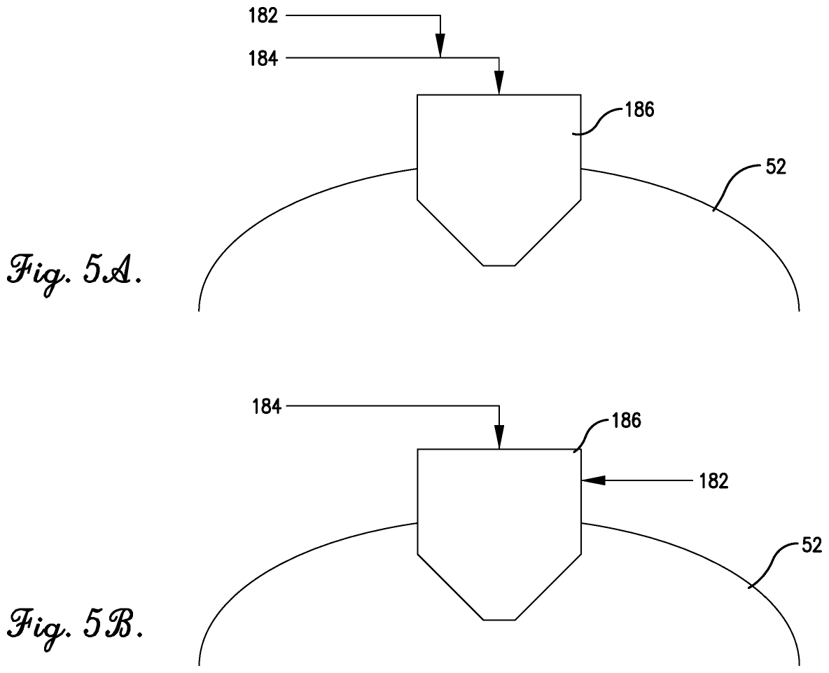

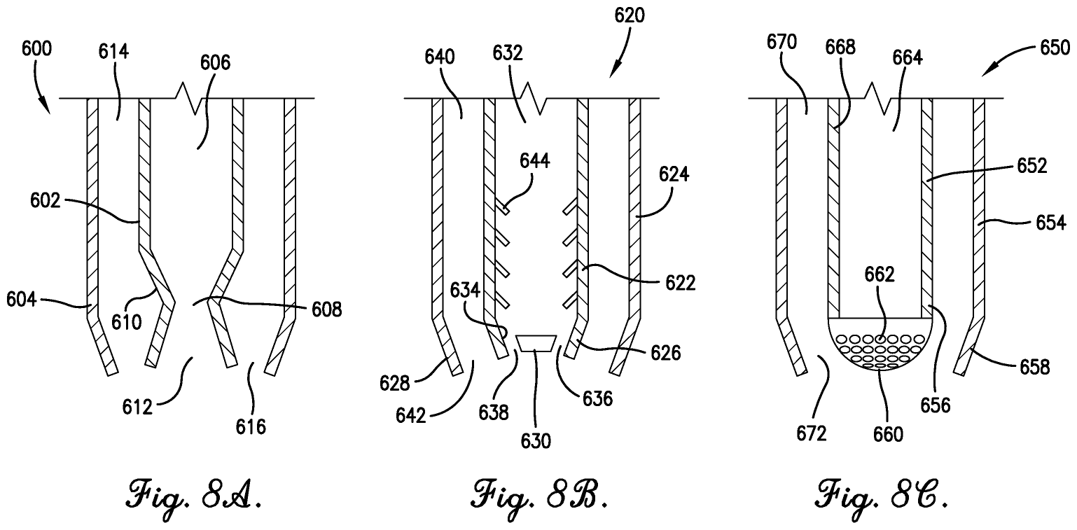

In an embodiment or in combination with any embodiment mentioned herein, an atomization enhancing fluid is fed to the gasification zone along with the feedstock and oxidizing agent. Exemplary embodiments of this arrangement are shown in FIGS. 8a and 8b. As used herein, the term “atomization enhancing fluid” refers to a liquid or gas operable to reduce viscosity to decrease dispersion energy, or increase energy available to assist dispersion. As illustrated in FIG. 5a, the atomization enhancing fluid 182 may be mixed with the plastic-containing feedstock 184 before the feedstock is fed into the gasification zone of the gasification reactor 52. In one embodiment, mixing of the atomization enhancing fluid 182 and plastic-containing feedstock 184 occurs upstream from an injection assembly 186 of the gasification reactor 52. FIG. 5b illustrates an alternative embodiment in which the atomization enhancing fluid 182 and plastic-containing feedstock 184 are separately added to the gasification reactor 52. In one embodiment, the atomization enhancing fluid 182 and the plastic-containing feedstock 184 are separately fed to the injection assembly 186 of the gasification reactor 52.

In an embodiment or in combination with any embodiment mentioned herein, the atomization enhancing fluid may comprise a single fluid or a mixture of two or more fluids, and may be in a liquid, gas, or two-phase state. In one or more embodiments, the atomization enhancing fluid may comprise water, steam, carbon dioxide, hydrogen, inerts (e.g., nitrogen, alone or as a component of air), sulfur dioxide, carbon monoxide, ammonia, ammonium lignin sulfonate, caustic compounds (e.g., sodium hydroxide, calcium hydroxide, potassium hydroxide), hydrocarbon fuels (e.g., natural gas, propane, butane, etc.) ethylene glycol, diethylene glycol, triethylene glycol, methyl acetate, and/or any one or more of the solvents, depolymerizing agents, plasticizers, and/or liquification agents described herein (see Liquification/Dehalogenation section above). In one or more embodiments, the atomization enhancing fluid comprises water, steam, and/or carbon dioxide (which may or may not be provided with a quantity of hydrogen and/or carbon monoxide).

In an embodiment or in combination with any embodiment mentioned herein, the atomization enhancing fluid is water and/or steam. In one or more embodiments, water is added to a liquid plastic feed stream to form a mixed feed stream. When the mixed feed stream is introduced into the gasifier, the water expands to assist in the atomization of the plastic material within the mixed feed stream. In one or more embodiments, a gas (e.g., steam, carbon dioxide, hydrogen, etc.) is added to a liquid plastic stream to form a two-phase feed stream. When the two-phase feed stream is introduced into the gasifier, the gas expands and adds energy to assist in the atomization of the plastic material within the two-phase stream. In one or more embodiments, the mixed stream and/or the two-phase stream comprises at least 1, at least 2, at least 3, at least 4, or at least 5 weight percent and/or not more than 30, not more than 25, not more than 20, not more than 15, or not more than 10 weight percent or water and/or steam. In one or more embodiments, the mixed stream and/or the two-phase stream comprises from 1 to 30, from 2 to 25, from 3 to 20, from 4 to 15, or from 5 to 10 weight percent water and/or steam. However, in one or more embodiments, separately added steam and/or water (i.e., steam and/or water not present in the plastic feedstock stream from upstream processing such as any of those upstream processes described herein) is not supplied to the gasification zone, fed to the PDX gasifier, and/or mixed with the plastic material before the plastic material is introduced to the gasification zone. In one or more embodiments, the atomization enhancing fluid participates in the partial oxidation reaction(s) and/or any side reactions within the PDX gasifier.

In an embodiment or in combination with any embodiment mentioned herein, the atomization enhancing fluid and plastic material feedstock are fed to the PDX gasifier at a ratio of 0.01 to 0.25 (or 0.05 to 0.1). In one or more embodiments, the atomization enhancing fluid comprises at least 1, at least 2, at least 3, at least 4, or at least 5 weight percent and/or not more than 50, not more than 40, not more than 30, or not more than 25 weight percent of the streams being fed to the PDX gasifier. In one or more embodiments, the atomization enhancing fluid comprises from 1 to 50, from 2 to 40, from 3 to 30, or from 4 to 25 weight percent of the streams being fed to the PDX gasifier. In one or more embodiments, and particularly when coal is fed to the PDX gasifier in combination with the plastic feed, water comprises 25 to 50 (or 30 to 40) weight percent of the streams being fed to the PDX gasifier. In one or more embodiments, and particularly when coal is not fed to the PDX gasifier in combination with the plastic feed, water comprises 1 to 25 (or 5 to 10) weight percent of the streams being fed to the PDX gasifier.

In an embodiment or in combination with any embodiment mentioned herein, a gas stream enriched in carbon dioxide or nitrogen (e.g., greater than the molar quantity found in air, or at least 2, at least 5, at least 10, or at least 40 mole percent) is charged into the gasifier. These gases may serve as carrier gases to propel a feedstock to a gasification zone. Due to the pressure within the gasification zone, these carrier gases may be compressed to provide the motive force for introduction into the gasification zone. This gas stream may be compositionally the same as or different than the atomization enhancing fluid. In one or more embodiments, this gas stream also functions as the atomization enhancing fluid.

However, in an embodiment or in combination with any embodiment mentioned herein, the gas stream may be fed into the gasifier separately from and/or as a separate component than the atomization enhancing fluid. The carbon dioxide may be added to affect the water-gas shift reaction (of the partial oxidation reactions as defined herein) so as to control the resulting syngas composition, and particularly to push equilibrium toward a more carbon monoxide-heavy syngas composition. The carbon dioxide (and water or steam) may also act as a heat sink or “moderator” for the gasifier reactions. In one or more embodiments, carbon dioxide comprises at least 1, at least 2, at least 3, at least 4, or at least 5 weight percent and/or not more than 30, not more than 20, not more than 15, or not more than 10 weight percent of the streams being fed to the PDX gasifier. In one or more embodiments, carbon dioxide comprises from 1 to 30, from 2 to 20, from 3 to 15, or from 4 to 10 weight percent of the streams being fed to the PDX gasifier.

In an embodiment or in combination with any embodiment mentioned herein, a gas stream enriched in hydrogen (H2) (e.g., at least 1, at least 2, at least 5, at least 10, at least 20, at least 30, at least 40, at least 50, at least 60, at least 70, at least 80, or at least 90 mole percent is charged into the gasifier. Similar to carbon dioxide, hydrogen may also be added to affect the partial oxidation reactions, primarily the water-gas shift reaction, so as to control the resulting syngas composition.

In an embodiment or in combination with any embodiment mentioned herein, no gas stream containing more than 0.01 or more than 0.02 mole percent of carbon dioxide is charged to the gasifier or gasification zone. Alternatively, no gas stream containing more than 77, more than 70, more than 50, more than 30, more than 10, more than 5, or more than 3 mole percent nitrogen is charged to the gasifier or gasification zone. Furthermore, a gaseous hydrogen stream more than 0.1, more than 0.5, more than 1, or more than 5 mole percent hydrogen is not charged to the gasifier or to the gasification zone. Moreover, a stream of methane gas containing more than 0.1, more than 0.5, more than 1, or more than 5 mole percent methane is not charged to the gasifier or to the gasification zone. In certain embodiments, the only gaseous stream introduced to the gasification zone is the oxidizing agent.

The gasification process can be a partial oxidation (PDX) gasification reaction, as described previously. Generally, to enhance the production of hydrogen and carbon monoxide, the oxidation process involves partial, rather than complete, oxidization of the gasification feedstock and, therefore, may be operated in an oxygen-lean environment, relative to the amount needed to completely oxidize 100 percent of the carbon and hydrogen bonds. In an embodiment or in combination with any embodiment mentioned herein, the total oxygen requirements for the gasifier may be at least 5, at least 10, at least 15, or at least 20 percent in excess of the amount theoretically required to convert the carbon content of the gasification feedstock to carbon monoxide. In general, satisfactory operation may be obtained with a total oxygen supply of 10 to 80 percent in excess of the theoretical requirements. For example, examples of suitable amounts of oxygen per pound of carbon may be in the range of 0.4 to 3.0, 0.6 to 2.5, 0.9 to 2.5, or 1.2 to 2.5 pounds free oxygen per pound of carbon.

Mixing of the feedstock stream and the oxidizing agent may be accomplished entirely within the reaction zone by introducing the separate streams of feedstock and oxidizing agent so that they impinge upon each other within the reaction zone. In an embodiment or in combination with any embodiment mentioned herein, the oxidizing agent stream is introduced into the reaction zone of the gasifier as high velocity to both exceed the rate of flame propagation and to improve mixing with the feedstock stream. In an embodiment or in combination with any embodiment mentioned herein, the oxidant may be injected into the gasification zone in the range of 25 to 500, 50 to 400, or 100 to 400 feet per second. These values would be the velocity of the gaseous oxidizing agent stream at the injector-gasification zone interface, or the injector tip velocity. Mixing of the feedstock stream and the oxidizing agent may also be accomplished outside of the reaction zone. For example, in an embodiment or in combination with any embodiment mentioned herein, the feedstock, oxidizing agent, and/or atomization enhancing fluid can be combined in a conduit upstream of the gasification zone or in an injection assembly coupled with the gasification reactor.

In an embodiment or in combination with any embodiment mentioned herein, the gasification feedstock stream, the oxidizing agent, and/or the atomization enhancing fluid can optionally be preheated to a temperature of at least 200° C., at least 300° C., or at least 400° C. However, the gasification process employed does not require preheating the feedstock stream to efficiently gasify the feedstock and a pre-heat treatment step may result in lowering the energy efficiency of the process.

As noted above, in an embodiment or in combination with any embodiment mentioned herein, the gasification feedstock and oxidizing agent are fed to the gasification zone in separate streams configured to impinge upon each other within the reaction zone. The impingement may contribute to atomization of all or part of the feedstock stream. In one or more embodiments, the gasification feedstock stream comprises liquefied plastic and, optionally, one or more atomization enhancing fluid(s), such as liquid water and/or steam. In one or more embodiments, one or more additional streams may be fed to the gasification zone other than the feedstock, oxidizing agent, and atomization enhancing fluid, including, but not limited to, carbon dioxide and hydrogen gas streams.

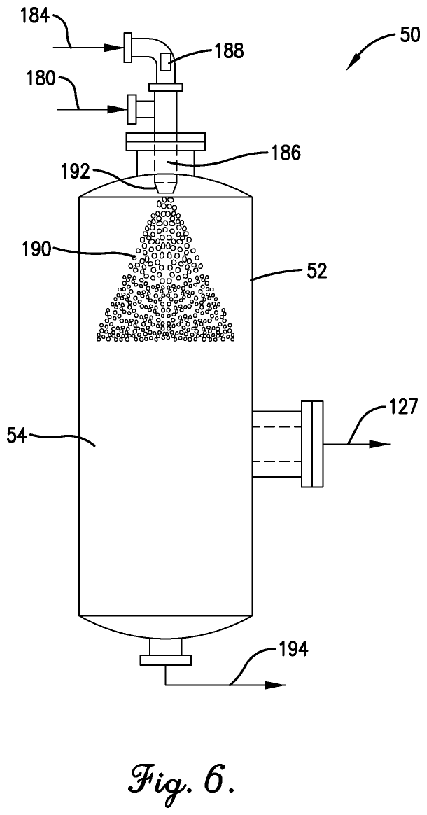

As illustrated in FIG. 6, the gasification feedstock 184 and oxidizer gas 180 streams may be fed through the gasifier feed injector 186 assembly to the reaction zone or chamber 54 of a gasifier reactor vessel 52.

In an embodiment or in combination with any embodiment mentioned herein, the gasifier 50 is a PDX gasifier. In one or more embodiments, the PDX gasifier is an entrained flow gasifier that generates a raw syngas stream 127, under slagging or non-slagging conditions. The PDX gasifier 50 may include a sensor 188 for measuring conditions of one or more reactant or product streams of the PDX gasifier 50, such as by measuring a viscosity of the gasification feedstock stream 184, a composition of the syngas 127, a composition of the gasification feedstock stream 184, a flow rate of one or both of the gasification feedstock 184 and oxidizer gas 180 streams, and/or other conditions. The sensor 188 illustrated in FIG. 6 is located on an inlet feed stream (i.e., stream 184); however, the sensor position may be adjusted as necessary to measure conditions such as those outlined above. Sensor output may be utilized in operation of the feed injector assembly 186 as described in more detail below.

In an embodiment or in combination with any embodiment mentioned herein, the feed injector assembly 186 may be configured to atomize a liquid gasification feedstock stream 184 for introduction into the reaction chamber 54. For example, impingement of the oxidizer gas stream 180 on the liquid gasification feedstock stream 184 may contribute to such atomization.

In an embodiment or in combination with any embodiment mentioned herein, the liquid gasification feedstock stream 184 introduced into the gasification reactor vessel 52 comprises liquefied plastic cohered into three-dimensional masses of variable shape. The masses may be in the form of a plurality of generally spherical globules or droplets 190 due to the surface tension of the liquefied plastic and other factors, but may take and transition between other shapes as well. For example, the masses may be injected from an injector assembly 186 in the form of a ribbon or film or the like before breaking into increasingly smaller, spherical or semi-spherical globules or droplets 190 as the distance from an injector tip 192 increases.

The three-dimensional masses may be characterized by a maximum chord, which spans the longest distance between any two points of the mass in any dimension. In one or more embodiments, the maximum chord of each mass can be referred to as the diameter or particle size of that mass.

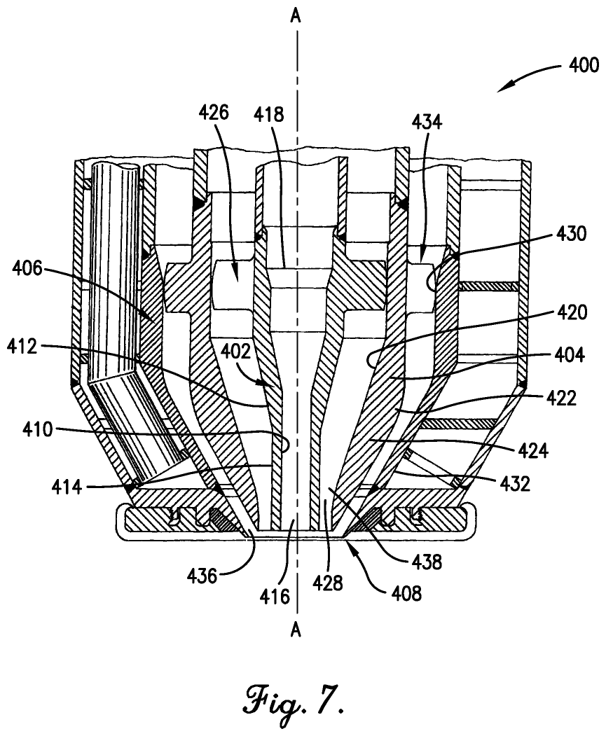

FIGS. 7, 8A, 8B, and 8C illustrate exemplary injector assemblies that may be used to introduce a gasifier feedstock stream and oxidizing agent stream into a gasifier vessel. Referring to FIG. 7, the injector assembly 400 comprises a longitudinal central axis A-A, which may bifurcate the injector assembly 400 and/or bifurcate or run generally parallel to the flowpath of the feedstock at its point of discharge from the injector assembly 400. In one or more embodiments, the D90 particle (or droplet) size for the masses of liquefied plastic of the liquid gasification feedstock stream are determined immediately prior to discharge from the injector assembly 400, at the point of discharge from the injector assembly, and/or at varying distances from the point of discharge along the axis A-A.

In an embodiment or in combination with any embodiment mentioned herein, the D90 particle size of the liquefied plastic of the liquid gasification feedstock stream in the reaction chamber may decrease with distance from the injector assembly. The D90 particle size of the liquefied plastic may be at or below seven millimeters (7 mm), six millimeters (6 mm), five millimeters (5 mm), four millimeters (4 mm), or three millimeters (3 mm) at a distance of 0.25, 0.5, 0.75, or 1 m (meter) from the point of discharge of the feedstock stream from the injector assembly along the axis A-A.

In an embodiment or in combination with any embodiment mentioned herein, the liquid gasification feedstock stream is atomized upon being discharged from the injector assembly. This atomization progresses as the masses discharged from the injector assembly 400 traverse deeper into the gasifier reaction vessel. In one or more embodiments, the mass of the liquid gasification feedstock stream is at least ninety percent (90%), at least ninety-five percent (95%), or at least ninety-nine percent (99%) atomized at a distance of one meter (1 m) from the point of discharge of the feedstock stream from the injector assembly (e.g., 1 m from the injector tip). In one or more embodiments, this means that at least 90%, 95%, or 99% of the mass of the liquefied plastic present in the liquid gasification feedstock discharged from the injector assembly comprises a plurality droplets having a D90 particle size at or below 7 mm, 6 mm, 5 mm, 4 mm, or 3 mm at a distance of 0.25, 0.5, 0.75, or 1 m (meter) from the injector tip.

In an embodiment or in combination with any embodiment mentioned herein, the feed injector assembly 400 may be constructed substantially as shown in U.S. Pat. No. 6,892,654 (the “'654 patent”), the entire disclosure of which is incorporated herein by reference to the extent not inconsistent with the present disclosure. However, in one or more embodiments, other types of feed injector assemblies, such as those illustrated in FIGS. 11A, 11B, and 11C and described in more detail below, may also be used within the scope of the present technology.

Referring to FIG. 7, the feed injector assembly 400 comprises a multi-lumen injector nozzle including an inner nozzle 402, optionally one or more intermediate nozzles 404, at least one outer nozzle 406, and an injector tip 408.

In an embodiment or in combination with any embodiment mentioned herein, the inner nozzle 402 comprises a tapered, tubular member having inner and outer wall surfaces 410, 412 and an end segment 414 defining an axial or inner outlet 416. The inner wall surface 410 of the inner nozzle 402 defines an inner passage 418. In one or more embodiments, a first gas stream (e.g., oxidizer gas stream) may pass through the inner passage 418 for injection into a reaction chamber via the inner outlet 416 of the inner nozzle 402. In one or more alternate embodiments, the liquid gasification feedstock may be fed through the inner passage 418 for injection into the reaction chamber. In still one or more other embodiments, no materials are introduced into the reaction chamber through the inner passage 418 (e.g., the inner passage may be plugged). The illustrated inner nozzle 402 is a center lance nozzle. However, in one or more embodiments, the inner nozzle 402 may be of alternative shape or configuration.

Further, the one or more intermediate nozzles 404 comprise a tapered, tubular member having inner and outer wall surfaces 420, 422 and an end segment 424. The inner wall surface 420 of the intermediate nozzle 404 cooperates with the outer wall surface 412 of the inner nozzle 402 to define an intermediate passage 426 terminating in an intermediate outlet 428. The illustrated intermediate outlet 428 comprises a circumferentially-extending annular opening of substantially consistent annular opening width. A liquid gasification feedstock stream may pass through the intermediate passage 426 for injection into the reaction chamber via the annular intermediate outlet 428 of the intermediate nozzle 404. However, in one or more embodiments, the intermediate passage 426 may carry an oxidizer gas stream or another process stream.

Still further, the outer nozzle 406 likewise comprises a tapered, tubular member having an inner wall surface 430 and an end segment 432. The inner wall surface 430 of the outer nozzle 406 cooperates with the outer wall surface 422 of the intermediate nozzle 404 to define an outer passage 434 terminating in an outer outlet 436 having an annular opening width. The illustrated outer outlet 436 comprises a circumferentially-extending annular opening of substantially consistent annular opening width. An oxidizer gas stream may pass through the outer passage 434 for injection into the reaction chamber via the annular outer outlet 436. However, in an embodiment or in combination with any embodiment mentioned herein, the outer passage 434 may carry a liquid gasification feedstock stream or another process stream.

As noted previously, in an embodiment or in combination with any embodiment mentioned herein, the gasification feedstock and oxidizing agent are fed to the gasification zone in separate streams configured to impinge upon each other within the reaction zone. The impingement may contribute to atomization of all or part of the feedstock stream. In the embodiment of the injector assembly 400 of FIG. 7, the gasification feedstock may be injected from the injector tip with a velocity vector essentially parallel to the central axis A-A of the injector assembly. At least a portion of the oxidizing agent may be injected with a velocity vector at an oblique angle to the central axis A-A, resulting in impingement on the stream of gasification feedstock and enhancement of atomization.

Moreover, as described in greater detail in the '654 patent and U.S. Pat. No. 4,502,633, the entire disclosure of which is incorporated herein by reference, in one or more embodiments the inner nozzle 402 and the intermediate nozzle 404 are both axially adjustable relative to the outer nozzle 406 to selectively narrow or widen one or more passages, outlets and/or constrictions 438 of the injector assembly 400.

As the intermediate nozzle 406 is axially displaced from the conically-tapered internal surface of the outer nozzle 430, the annular opening width of the outer outlet 436 is enlarged. Similarly, as the outer wall surface 412 of the inner nozzle 402 is axially drawn toward the inner wall surface 420 of the intermediate nozzle 404, the annular opening width of the intermediate outlet 428, which defines the liquid gasification feedstock stream discharge area, is reduced.

In an embodiment or in combination with any embodiment mentioned herein, the liquefied plastic and/or the liquid gasification feedstock stream may comprise a shear-thinning fluid. Shear-thinning fluids generally exhibit reduced viscosity under shear strain. The feed injector assembly may be configured to include one or more features, aspects or dimensions that subject the liquid gasification feedstock stream to increased shear strain in order to reduce the viscosity of the stream.

In an embodiment or in combination with any embodiment mentioned herein, a liquid gasification feedstock stream containing liquefied plastic is injected from an injector assembly outlet into a reaction chamber of a gasifier. For example, the injection of the feedstock stream may be from the intermediate outlet 428 illustrated in FIG. 7. Further, an oxidizer gas stream may be injected into the reaction chamber from a surrounding outlet of the injector assembly. For example, the injection of the oxidizing gas stream may be from the outer outlet 436. The gasifier may comprise an entrained flow PDX gasifier, as discussed in more detail elsewhere herein.

In an embodiment or in combination with any embodiment mentioned herein, one or more nozzles of the injector assembly are configured so that at least a portion of the passage through which the liquid gasification feedstock stream flows includes a constriction along or near the end segment. In the embodiment illustrated in FIG. 7, the inner and intermediate nozzles 402, 404 are configured to define the intermediate passage 426 with a constriction 438 along the end segment.

In an embodiment or in combination with any embodiment mentioned herein, the smallest distance between adjacent inner and outer wall surfaces defining the passage defines a minimum dimension of the constriction. In the embodiment illustrated in FIG. 7, the smallest distance between the outer wall surface 412 of the inner nozzle 402 and the inner wall surface 420 of the intermediate nozzle 404 defines the minimum dimension of the constriction 438 along the end segment.

In an embodiment or in combination with any embodiment mentioned herein, the minimum dimension of the constriction corresponds to the opening width at the corresponding outlet. In the embodiment illustrated in FIG. 7, the minimum dimension of the constriction 438 corresponds to the annular opening width of the intermediate outlet 428. However, in one or more embodiments, the passage may widen downstream of the constriction, as described in more detail below.

In an embodiment or in combination with any embodiment mentioned herein, one or more nozzles of the injector assembly are configured to carry the oxidizer gas stream through a passage to an outlet. In one or more embodiments, the smallest distance or dimension between adjacent inner and outer wall surfaces defining the passage defines a minimum dimension or distance of the passage. In the embodiment illustrated in FIG. 7, the smallest distance between the outer wall surface 422 of the intermediate nozzle 404 and the inner wall surface 430 of the outer nozzle 406 defines the minimum dimension or distance of the passage carrying a first oxidizer gas stream. In the embodiment illustrated in FIG. 7, the minimum dimension of the passage corresponds to the annular opening width of the outer outlet 436. However, other segment(s) of the passage may define the minimum dimension of the passage.

The embodiment illustrated in FIG. 7 further includes an inner passage 418, which may be used for carrying a second gas stream, such as an oxidizer gas stream, an atomization enhancing fluid gas stream, and/or other gas stream. The minimum dimension or distance of the inner passage 418 is defined by the smallest inner diameter of the inner nozzle 402.

In an embodiment or in combination with any embodiment mentioned herein, the outlet configured to inject the liquid gasification feedstock stream into the reaction chamber may be referred to as the “liquid outlet.” Likewise, the one or more outlets configured to inject gas oxidizer gas stream(s) may be referred to as “gas outlet(s).”

In an embodiment or in combination with any embodiment mentioned herein, the nozzles of the injector assembly are configured or configurable so that the minimum dimension of the constriction in the passage feeding the liquid outlet, and/or of the liquid outlet, is less than the minimum dimension of the passage feeding one or more of the gas outlet(s) and/or of the gas outlet(s). The minimum dimension of the passage feeding the liquid outlet and/or of the liquid outlet itself may be at least 1%, at least 2%, at least 3%, at least 5%, at least 7%, at least 10%, or at least 15%, but no more than 99%, no more than 98%, no more than 97%, no more than 95%, no more than 93%, no more than 90%, or no more than 85% of the minimum dimension of one or more of the passage(s) feeding the one or more gas outlet(s). In one or more embodiments, the minimum dimension of the passage feeding the liquid outlet and/or of the liquid outlet itself may be from 1% to 99%, from 2% to 98%, from 3% to 97%, from 5% to 95%, from 7% to 93%, from 10% to 90%, or from 15% to 85% of the minimum dimension of one or more of the passage(s) feeding the one or more gas outlet(s).

The minimum dimension of the passage feeding the liquid outlet and/or of the liquid outlet may impart shear strain on the liquid gasification feedstock stream to reduce viscosity. The reduced viscosity of the liquid gasification feedstock stream immediately following passage through the minimum dimension may be at least 0.1, at least 1, at least 2, at least 5, at least 10, at least 15, at least 20, at least 25, at least 30, at least 35, at least 40, or at least 45 poise, but not more than 2500, not more than 2000, not more than 1500, not more than 1000, not more than 750, not more than 500, not more than 250, not more than 100, or not more than 50 poise (measured at 10 radians/second and 350° C.). In one or more embodiments, the reduced viscosity of the liquid gasification feedstock stream immediately following passage through the minimum dimension may be from 0.1 to 2500, from 1 to 2000, from 2 to 1500, from 5 to 1000, from 10 to 750, from 15 to 500, from 20 to 250, from 25 to 100, or from 30 to 50 poise (measured at 10 radians/second and 350° C.). It should be noted that certain viscous materials, e.g., polymers and gels, may possess a “memory” and return to and/or approximate an original state possessed prior to passing through a constriction. This phenomenon, which in one or more embodiments is undesirable, can be mitigated by elongating the constricted passage through which the viscous materials are directed. However, elongation of the constriction may negatively affect the pressure drop across the constriction. Therefore, these variables may be optimized to achieve a desired degree of atomization of the liquid gasification feedstock without suffering too great of a pressure drop within the injector assembly.

In an embodiment or in combination with any embodiment mentioned herein, the minimum dimensions of the passages and/or outlets of the injector assembly are fixed and not adjustable. In one or more other embodiments, however, the minimum dimensions of the passages and/or outlets of the injector assembly are adjustable, whether manually, remotely and/or automatically. For example, as discussed above, axial adjustment of one or both of the inner and intermediate nozzles may enlarge or shrink the minimum dimensions of the gas and liquid outlets. In one or more embodiments, one or more sensors associated with the gasifier may output data regarding, for example, a viscosity of the gasification feedstock stream, a composition of the syngas, a composition of the gasification feedstock stream, a flow rate of one or both of the gasification feedstock and gas stream(s), and/or other conditions. The sensor output may be used to inform manual adjustment of the nozzle(s) to achieve optimal conditions and/or fed to a control algorithm for automatically performing such adjustment(s).

In an embodiment or in combination with any embodiment mentioned herein, the linear velocity of the liquid gasification feedstock stream at the injector tip is greater than the linear velocity of one or more (or all) of the gas stream(s) at the injector tip. The liquid gasification feedstock stream may have a linear velocity that is at least 1%, at least 2%, at least 4%, at least 6%, at least 8%, at least 10%, at least 25%, at least 50%, at least 75%, at least 100%, or at least 200% greater than the linear velocity of the one or more (e.g., all of the) oxidizing gas stream(s). In one or more embodiments, the liquid gasification feedstock stream may have a linear velocity that is no more than 500%, no more than 400%, no more than 300%, no more than 200%, no more than 150%, no more than 100%, no more than 75%, or no more than 50% greater than the linear velocity of the one or more oxidizer gas stream(s). In one or more embodiments, the liquid gasification feedstock stream may have a linear velocity that is from 1% to 500%, from 2% to 400%, from 4% to 300%, from 6% to 200%, from 8% to 150%, from 10% to 100%, or from 25% to 75% of the linear velocity of the one or more oxidizer gas stream(s). In one or more embodiments, the linear velocity of the liquid gasification feedstock stream at the injector tip may be at least 60 m/s, at least 75 m/s, at least 100 m/s, at least 125 m/s, at least 150 m/s, at least 175 m/s, or at least 200 m/s. In one or more embodiments, the liquid gasification feedstock stream is introduced to the gasifier through the injector assembly at a velocity sufficient to prevent propagation of a flame front into the injector assembly.

The decreased viscosity and increased velocity of the liquid gasification feedstock stream may enhance atomization of the stream being fed into the reaction chamber. Enhanced atomization may permit sufficient distribution of liquefied plastic to react and consume substantially all free oxygen within the reaction chamber. In one or more embodiments, the atomization is sufficiently distributed to provide a mass of char removed from the reaction chamber that is no more than 15%, no more than 12%, no more than 10%, no more than 8%, or no more than 6% of the total mass of the liquefied plastic in the liquefied plastic-containing stream that is fed to the reaction chamber over a predetermined time period during which the gasifier is being operated. Moreover, the pressure within the reaction chamber may be at least 100, at least 500, at least 750, at least 1000, at least 1500, at least 2000, at least 2500, at least 3000, at least 3500, or at least 4000 psi lower than the pressure of the liquid gasification feedstock stream in the injector assembly at the injector tip.

Alternate embodiments of injector assemblies are illustrated in cross section in FIGS. 11A, 11B, and 11C. The injector assembly 600 of FIG. 8A includes inner and outer nozzles 602, 604, the inner nozzle 602 carrying a liquid gasification feedstock stream through a liquid passage 606. The liquid passage 606 defined by the inner nozzle 602 includes a constriction 608 along an end segment 610 and upstream of a liquid outlet 612. Further, the inner and outer nozzles 602, 604 cooperate to define a gas passage 614 tapering into a gas outlet 616 having an annular opening width. The minimum dimension of the constriction 608 within the inner nozzle 602 is less than an annular opening width of the gas outlet 616. It should be noted that, in injector assembly 600, the opening width of the liquid outlet 612 is greater than the minimum dimension of the constriction 608 because the end segment 610 of the inner nozzle 602 flares after the constriction.

The injector assembly 620 of FIG. 8B comprises inner and outer nozzles 622, 624 having tapered end segments 626, 628. The inner nozzle 622 includes a central plug 630 positioned along the terminus of the inner nozzle end segment 626 that blocks or covers a portion of the inner nozzle passage 632. The central plug 630 and an inner wall surface 634 of the end segment 626 of the inner nozzle 622 cooperatively define a constriction 636 having a minimum dimension therebetween. The central plug 630 and the inner wall surface 634 of the end segment 626 of the inner nozzle 622 also cooperatively define a liquid outlet 638 that has an annular opening width. The annular opening width of the liquid outlet 638 corresponds to the minimum dimension of the constriction 636. Further, the inner and outer nozzles 622, 624 cooperate to define a gas passage 640 tapering into a gas outlet 642. The minimum dimension of the inner nozzle constriction 636 is less than an annular opening width of the gas outlet 642.

The inner nozzle 622 may include structures 644 associated with the inner wall surface 634 configured to induce rotation or swirling of the liquid gasification feedstock stream as it passes through the inner passage 632. These structures 644 may include baffles, projections, grooves, ridges, channels, rifling, or the like. The induced rotation or swirling may assist with atomization of the stream as it exits the nozzle 622 due to shear and centrifugal forces provided by the induced rotation of the stream that cause the masses of liquefied plastic to break apart. It should be noted that the rotation-inducing structures 644 are optional and need not be utilized in any of the injector assemblies described herein. Conversely, the rotation-inducing structures 644 may be incorporated into any of the injector assembly embodiments described herein.

In an embodiment or in combination with any embodiment mentioned herein, the rotation-inducing structures 644 may be incorporated into inner and/or outer wall surface(s) of any combination of liquid and/or gas passages 632, 640 to optimize atomization or other flow characteristics. In one or more embodiments, a liquid gasification feedstock stream may be swirled and an oxidizer gas stream may not. In one or more embodiments, the liquid gasification feedstock stream may not be swirled and the oxidizer gas stream may be swirled. In one or more embodiments, both liquid gasification feedstock and oxidizer gas streams may be swirled. In one or more embodiments, the liquid gasification feedstock may be swirled in the same direction as the oxidizer gas stream. In one or more embodiments, the liquid gasification feedstock may be swirled in an opposing direction to the oxidizer gas stream, for example to add turbulence when the stream impinge one another in a reaction chamber.

FIG. 8C illustrates yet another injector assembly embodiment. Injector assembly 650 also comprises inner and outer nozzles 652, 654 having end segments 656, 658 and respective inner and outer wall surfaces. The inner nozzle 652 includes a screen 660 fixed to the inner nozzle end segment 656. The screen 660 is perforated to define a plurality of liquid outlets or apertures 662, with each of the apertures comprising a constriction relative to the upstream portions of the liquid passage 664 defined by the inner wall surface 668 of the inner nozzle 652. The inner diameter of each such aperture 662 corresponds to a minimum dimension of the constriction. Further, the inner and outer nozzles 652, 654 cooperate to define a gas passage 670 tapering into a gas outlet 672 having an annular opening width. The minimum dimension of one or more (or all) of the constrictions within the inner nozzle 652 is less than an annular opening width of the gas outlet 672.

In an embodiment or in combination with any embodiment mentioned herein, the type of gasification technology employed may be a partial oxidation entrained flow gasifier that generates syngas. This technology is distinct from fixed bed (alternatively called moving bed) gasifiers and from fluidized bed gasifiers. An exemplary gasifier that may be used in depicted in U.S. Pat. No. 3,544,291, the entire disclosure of which is incorporated herein by reference to the extent not inconsistent with the present disclosure. However, in an embodiment or in combination with any embodiment mentioned herein, other types of gasification reactors may also be used within the scope of the present technology.

In an embodiment or in combination with any embodiment mentioned herein, the gasifier/gasification reactor can be non-catalytic, meaning that the gasifier/gasification reactor does not contain a catalyst bed and the gasification process is non-catalytic, meaning that a catalyst is not introduced into the gasification zone as a discrete unbound catalyst. Furthermore, in an embodiment or in combination with any embodiment mentioned herein, the gasification process may not be a slagging gasification process; that is, operated under slagging conditions (well above the fusion temperature of ash) such that a molten slag 194 (FIG. 6) is formed in the gasification zone and runs along and down the refractory walls.

In an embodiment or in combination with any embodiment mentioned herein, the gasification zone, and optionally all reaction zones in the gasifier/gasification reactor, may be operated at a temperature of at least 1000° C., at least 1100° C., at least 1200° C., at least 1250° C., or at least 1300° C. and/or not more than 2500° C., not more than 2000° C., not more than 1800° C., or not more than 1600° C. The reaction temperature may be autogenous. Advantageously, the gasifier operating in steady state mode may be at an autogenous temperature and does not require application of external energy sources to heat the gasification zone.

In an embodiment or in combination with any embodiment mentioned herein, the gasifier is a predominately gas fed gasifier.

In an embodiment or in combination with any embodiment mentioned herein, the gasifier is a non-slagging gasifier or operated under conditions not to form a slag.

In an embodiment or in combination with any embodiment mentioned herein, the gasifier may not be under negative pressure during operations, but rather can be under positive pressure during operation.

In an embodiment or in combination with any embodiment mentioned herein, the gasifier may be operated at a pressure within the gasification zone (or combustion chamber) of at least 200 psig (1.38 MPa), 300 psig (2.06 MPa), 350 psig (2.41 MPa), 400 psig (2.76 MPa), 420 psig (2.89 MPa), 450 psig (3.10 MPa), 475 psig (3.27 MPa), 500 psig (3.44 MPa), 550 psig (3.79 MPa), 600 psig (4.13 MPa), 650 psig (4.48 MPa), 700 psig (4.82 MPa), 750 psig (5.17 MPa), 800 psig (5.51 MPa), 900 psig (6.2 MPa), 1000 psig (6.89 MPa), 1100 psig (7.58 MPa), or 1200 psig (8.2 MPa). Additionally or alternatively, the gasifier may be operated at a pressure within the gasification zone (or combustion chamber) of not more than 1300 psig (8.96 MPa), 1250 psig (8.61 MPa), 1200 psig (8.27 MPa), 1150 psig (7.92 MPa), 1100 psig (7.58 MPa), 1050 psig (7.23 MPa), 1000 psig (6.89 MPa), 900 psig (6.2 MPa), 800 psig (5.51 MPa), or 750 psig (5.17 MPa).

Examples of suitable pressure ranges include 300 to 1000 psig (2.06 to 6.89 MPa), 300 to 750 psig (2.06 to 5.17 MPa), 350 to 1000 psig (2.41 to 6.89 MPa), 350 to 750 psig (2.06 to 5.17 MPa), 400 to 1000 psig (2.67 to 6.89 MPa), 420 to 900 psig (2.89 to 6.2 MPa), 450 to 900 psig (3.10 to 6.2 MPa), 475 to 900 psig (3.27 to 6.2 MPa), 500 to 900 psig (3.44 to 6.2 MPa), 550 to 900 psig (3.79 to 6.2 MPa), 600 to 900 psig (4.13 to 6.2 MPa), 650 to 900 psig (4.48 to 6.2 MPa), 400 to 800 psig (2.67 to 5.51 MPa), 420 to 800 psig (2.89 to 5.51 MPa), 450 to 800 psig (3.10 to 5.51 MPa), 475 to 800 psig (3.27 to 5.51 MPa), 500 to 800 psig (3.44 to 5.51 MPa), 550 to 800 psig (3.79 to 5.51 MPa), 600 to 800 psig (4.13 to 5.51 MPa), 650 to 800 psig (4.48 to 5.51 MPa), 400 to 750 psig (2.67 to 5.17 MPa), 420 to 750 psig (2.89 to 5.17 MPa), 450 to 750 psig (3.10 to 5.17 MPa), 475 to 750 psig (3.27 to 5.17 MPa), 500 to 750 psig (3.44 to 5.17 MPa), or 550 to 750 psig (3.79 to 5.17 MPa).

Generally, the average residence time of gases in the gasifier reactor can be very short to increase throughput. Since the gasifier may be operated at high temperature and pressure, substantially complete conversion of the feedstock to gases can occur in a very short time frame. In an embodiment or in combination with any embodiment mentioned herein, the average residence time of the gases in the gasifier can be not more than 30, not more than 25, not more than 20, not more than 15, not more than 10, or not more than 7 seconds.

To avoid fouling downstream equipment from the gasifier, and the piping in-between, the resulting raw syngas stream 127 may have a low or no tar content. In an embodiment or in combination with any embodiment mentioned herein, the syngas stream discharged from the gasifier may comprise not more than 4, not more than 3, not more than 2, not more than 1, not more than 0.5, not more than 0.2, not more than 0.1, or not more than 0.01 weight percent of tar based on the weight of all condensable solids in the syngas stream. For purposes of measurement, condensable solids are those compounds and elements that condense at a temperature of 15° C. and 1 atm. Examples of tar products include naphthalenes, cresols, xylenols, anthracenes, phenanthrenes, phenols, benzene, toluene, pyridine, catechols, biphenyls, benzofurans, benzaldehydes, acenaphthylenes, fluorenes, naphthofurans, benzanthracenes, pyrenes, acephenanthrylenes, benzopyrenes, and other high molecular weight aromatic polynuclear compounds. The tar content can be determined by GC-MSD.

Generally, the raw syngas stream 127 discharged from the gasification vessel includes such gases as hydrogen, carbon monoxide, and carbon dioxide and can include other gases such as methane, hydrogen sulfide, and nitrogen depending on the fuel source and reaction conditions. As used herein, the term “raw syngas” refers to a synthesis gas composition comprising carbon monoxide (CO) and hydrogen (H2) discharged from a partial oxidation (PDX) gasifier and before any further treatment, for example, by way of scrubbing, shift, or acid gas removal. In an embodiment or in combination with any embodiment mentioned herein, the raw syngas is discharged from the PDX gasifier at a temperature of 200 to 1500 (or 220 to 400)° C. and/or a pressure of 101 kPa to 8.27 MPa (6.21 to 7.58 MPa) (14.7 to 1200 (or 900 to 1100) psig).

Generally, the raw syngas stream 127 discharged from the gasification vessel includes such gases as hydrogen, carbon monoxide, and carbon dioxide and can include other gases such as methane, hydrogen sulfide, and nitrogen depending on the fuel source and reaction conditions.

In an embodiment or in combination with any embodiment mentioned herein, the raw syngas stream 127 (the stream discharged from the gasifier and before any further treatment by way of scrubbing, shift, or acid gas removal) can have the following composition in mole percent on a dry basis and based on the moles of all gases (elements or compounds in gaseous state at 25° C. and 1 atm) in the raw syngas stream 127:
a hydrogen content in the range of 32 to 50 percent, or at least 33, at least 34, or at least 35 and/or not more than 50, not more than 45, not more than 41, not more than 40, or not more than 39 percent, or it can be in the range of 33 to 50 percent, 34 to 45 percent, or 35 to 41 percent, on a dry volume basis; and/or a carbon monoxide content of at least 35, at least 40, at least 41, at least 42, or at least 43 and/or not more than 55, not more than 54, not more than 53, or not more than 52 weight percent, based on the total weight of the stream, or in the range of from 35 to 55 weight percent, 40 to 55 weight percent, 41 to 54 weight percent, or 42 to 53 weight percent, based on the total weight of the stream on a dry basis; and/or
a carbon dioxide content of at least 1%, at least 1.5%, at least 2%, at least 3%, at least 4%, at least 5%, at least 6%, or at least 7% by volume and/or not more than 25%, not more than 20%, not more than 18%, not more than 15%, not more than 12%, not more than 11%, not more than 10%, not more than 9%, not more than 8%, or not more than 7% by volume on a dry basis; and/or
a methane content of not more than 5000, not more than 2500, not more than 2000, or not more than 1000 ppm by volume methane on a dry basis; and/or
a sulfur content of not more than 1000, not more than 500, nor more than 100, not more than 50, or nor more than 10, or nor more than 5, or not more than 1 ppm by weight (ppmw); and/or
a soot content of at least 1000, or at least 5000 ppm and/or not more than 50,000, not more than 20,000, or not more than 15,000 ppmw; and/or
a halides content of not more than 1000, not more than 500, not more than 200, not more than 100, or not more than 50 ppmw; and/or
a mercury content of not more than 0.01, not more than 0.005, or not more than 0.001 ppmw; and/or
an arsine content of not more than 0.1 ppm, not more than 0.05, or not more than 0.01 ppmw; and/or
a nitrogen content of not more than 10,000, not more than 3000, not more than 1000, or not more than 100 ppmw nitrogen; and/or
an antimony content of at least 10 ppmw, at least 20 ppmw, at least 30 ppmw, at least 40 ppmw, or at least 50 ppmw, and/or not more than 200 ppmw, not more than 180 ppmw, not more than 160 ppmw, not more than 150 ppmw, or not more than 130 ppmw; and/or
a titanium content of at least 10 ppmw, at least 25 ppmw, at least 50 ppmw, at least 100 ppmw, at least 250 ppmw, at least 500 ppmw, or at least 1000 ppmw, and/or not more than 40,000 ppmw, not more than 30,000 ppmw, not more than 20,000 ppmw, not more than 15,000 ppmw, not more than 10,000 ppmw, not more than 7,500 ppmw, or not more than 5,000 ppmw; and/or
an inorganic matter (e.g. ash) content of not more than 3000, not more than 2000, or not more than 1000 ppmw; and/or
not more than 4, not more than 3, not more than 2, or not more than 1 weight percent unconverted carbon on a dry basis.

As used herein, the term “unconverted carbon” refers to carbon-containing compounds from the gasifier feed(s) that are not converted to carbon monoxide or carbon dioxide.

In an embodiment or in combination with any embodiment mentioned herein, the syngas comprises a molar hydrogen/carbon monoxide ratio of 0.7 to 2, 0.7 to 1.5, 0.8 to 1.2, 0.85 to 1.1, or 0.9 to 1.05.

In an embodiment or in combination with any embodiment mentioned herein, the raw syngas composition comprises sulfur, soot, and either carbon dioxide or methane in any amount specified herein. For example, the raw syngas composition can contain sulfur in an amount of not more than 500 ppmw, soot in an amount of at least 1000 ppmw and not more than 20,000 ppmw, and either carbon dioxide in an amount of at least 5% and not more than 15% by volume or methane in an amount of not more than 2000 ppm by volume.

In an embodiment or in combination with any embodiment mentioned herein, the raw syngas composition comprises a molar ratio of hydrogen to carbon monoxide and carbon dioxide in any amount specified herein.

In an embodiment or in combination with any embodiment mentioned herein, the raw syngas composition comprises methane and either sulfur or soot in any amount specified herein. For example, the raw syngas composition can contain methane in an amount of not more than 2000 ppm by volume and either sulfur in an amount of not more than 500 ppmw or soot in an amount of at least 1000 ppmw and not more than 20,000 ppmw.

In an embodiment or in combination with any embodiment mentioned herein, the raw syngas composition comprises a molar ratio of hydrogen to carbon monoxide, halides, mercury, and/or arsine in any amount specified herein. For example, the raw syngas composition can contain a molar ratio of hydrogen to carbon monoxide of 1.0 to 1.4, halides in an amount of no more than 100 ppmw, mercury in an amount of no more than 0.001 ppmw, and/or arsine in an amount of no more than 0.5 ppmw.

In an embodiment or in combination with any embodiment mentioned herein, the raw syngas composition comprises methane, antimony and/or titanium in any amount specified herein. For example, the raw syngas composition can contain methane in an amount of not more than 2000 ppm by volume, antimony in an amount of at least 20 ppmw but not more than 150 ppmw, and/or titanium in an amount of at least 20 ppmw but not more than 10,000 ppmw.

In an embodiment or in combination with any embodiment mentioned herein, the raw syngas composition comprises soot, antimony and/or titanium, and halides in any amount specified herein. For example, the raw syngas composition can contain soot in an amount of at least 1000 ppmw and not more than 20,000 ppmw, antimony in an amount of at least 20 ppmw but not more than 150 ppmw, and/or titanium in an amount of at least 20 ppmw but not more than 10,000 ppmw, and halides in an amount of no more than 100 ppmw.

In an embodiment or in combination with any embodiment mentioned herein, the raw syngas composition comprises a molar ratio of hydrogen to carbon monoxide, antimony and/or titanium, and halides in any amount specified herein. For example, the raw syngas composition can contain a molar ratio of hydrogen to carbon monoxide of 1.0 to 1.4, antimony in an amount of at least 20 ppmw but not more than 150 ppmw, and/or titanium in an amount of at least 20 ppmw but not more than 10,000 ppmw, and halides in an amount of no more than 100 ppmw.

In an embodiment or in combination with any embodiment mentioned herein, the raw syngas composition comprises not more than 5, not more than 4, not more than 3, not more than 2, or not more than 1 weight percent of arsine (AsH₃), nitrogen, mercury, and inorganic matter (ash), collectively.

The gas components can be determined by Flame Ionization Detector Gas Chromatography (FID-GC) and Thermal Conductivity Detector Gas Chromatography (TCD-GC) or any other method recognized for analyzing the components of a gas stream.

In an embodiment or in combination with any embodiment mentioned herein, the recycle content syngas can have a recycle content of at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, or at least 99 weight percent, based on the total weight of the syngas stream.

Weight percentages expressed on the MPW are the weight of the MPW as fed to the first stage separation and prior to addition of any diluents/solutions such as salt or caustic solutions.

In another aspect, the present technology pertains to a method of producing synthesis gas from a plastic material. The method comprises: (a) feeding the plastic material, molecular oxygen (O2), and an atomization enhancing fluid other than the molecular oxygen into a partial oxidation (PDX) gasifier; and (b) performing a partial oxidation reaction within the gasifier by reacting at least a portion of the plastic material and the molecular oxygen to form the synthesis gas.

In another aspect, the present technology pertains to a method of producing synthesis gas from a plastic material comprising: (a) adding water to a liquid plastic stream comprising the plastic material to form a mixed stream; (b) feeding the mixed stream into a gasifier feed injection assembly coupled with a partial oxidation gasifier and introducing the mixed stream into the partial oxidation gasifier, the water within the mixed stream expanding to assist in atomization of the plastic material within the mixed stream upon introduction into the gasifier; and (c) performing a partial oxidation reaction within the gasifier by reacting at least a portion of the plastic material and molecular oxygen (O2) to form the synthesis gas.

In another aspect, the present technology pertains to a method of producing synthesis gas from a plastic material comprising: (a) adding a gas to a liquid plastic stream comprising the plastic material to form a two-phase stream; (b) feeding the two-phase stream into a gasifier feed injection assembly coupled with a partial oxidation gasifier and introducing the two-phase stream into the partial oxidation gasifier, the gas adding energy to assist in atomization of the plastic material within the two-phase stream upon introduction into the gasifier; and (c) performing a partial oxidation reaction within the gasifier by reacting at least a portion of the plastic material and the oxidizing gas to form the synthesis gas.

In another aspect, the present technology pertains to a method of forming a syngas product from a plastic material comprising: (a) feeding the plastic material and an oxidizing gas into a partial oxidation (PDX) gasifier; and (b) performing a partial oxidation reaction within the gasifier by reacting at least a portion of the plastic material and the oxidizing gas to form the synthesis gas, wherein the plastic material being fed into the gasifier comprises no added water or steam.

In one embodiment or in combination with any embodiment mentioned herein the present technology may further comprise one or more of the following:
wherein the atomization enhancing fluid comprises water, steam, carbon dioxide, hydrogen, inerts, sulfur dioxide, carbon monoxide, ammonia, ammonium lignin sulfonate, caustic compounds, hydrocarbon fuels, ethylene glycol, triethylene glycol, methyl acetate, solvents, depolymerizing agents, plasticizers, and/or liquification agents;
wherein the atomization enhancing fluid participates in the partial oxidation reaction and/or a side reaction within the PDX gasifier;
wherein the plastic material is in a liquified state;
wherein the liquified plastic material comprises a molten plastic material, a solvated plastic material, a depolymerized plastic material, a plasticized plastic material, and/or a plastic material that has been liquified with a viscosity reducing agent;
wherein the oxidizing agent does not comprise oxygen present in, derived from, or liberated from the plastic material;
wherein the oxidizing agent comprises an oxidzing gas;
   wherein the oxidizing gas comprises air or oxygen-enriched air;
wherein the plastic material is added to a coal or pet coke slurry before being fed to the PDX gasifier;
wherein the plastic material is added to dry coal or pet coke and formed into a slurry being fed to the PDX gasifier, and/or wherein dry coal or pet coke is added to a plastic-containing slurry being fed to the PDX gasifier;
wherein the plastic material is introduced to the PDX gasifier without being combined with coal or pet coke and/or without any coal being fed separately to the PDX gasifier;
wherein the atomization enhancing fluid comprises at least 1, 2, 3, 4, or 5 weight percent and/or not more than 50, 40, 30, or 25 weight percent of the streams being fed to the PDX gasifier;
wherein the atomization enhancing fluid and the plastic material are fed to the PDX gasifier at a ratio of 0.01 to 0.25 (or 0.05 to 0.1) atomization enhancing fluid-to-plastic material;
wherein the mixed stream and/or the two-phase stream comprises not more than 25% (20%, 15%, 10%) by weight of water and/or steam;
wherein the synthesis gas has a H₂:CO ratio of 0.7 to 2 (or 0.8 to 1.2, or 0.85 to 1.1, or 0.9 to 1.05);
wherein the H₂:CO ratio is adjustable between 0.7 to 2 (or 1.0 to 0.85) by adjusting the amount of atomization enhancement fluid, water, and/or steam fed into the gasifier;
further comprising feeding carbon dioxide into the gasifier as a separate component than the atomization enhancing fluid;
wherein the partial oxidation (PDX) gasifier is an entrained flow gasifer;
wherein the plastic material comprises a halogen content of less than 500, 400, 300, 200, 100, 50, 10, 5, 2, 1, 0.5, or 0.1 ppmw;
wherein the plastic material comprises at least 1 (5, 10, 15, 20, 25, 30, 35, 40, 45, 50, 55, 60, 65, 70, 75, 80, 85, 90, or 95) weight percent and/or not more than 99.9 (95, 90, 85, 80, 75, 70, 65, 60, 55, 50, 45, 40, 35, 30, 25, 20, 15, 10, 5, 2, or 1) weight percent of one or more polyolefins, based on the total weight of the stream;
wherein the flow rate of the plastic material into the gasifier is greater than 453, 2,268, 4,530, 9,072, 18,144, 36,287, or 54,431 kg/hr (1000 5000, 10,000, 20,000, 40,000, 80,000, or 120,000 lbs/hr) and not more than 226, 800, 181,437, 136,078, 90,720, or 68,039 kg/hr (500,000, 400,000, 300,000, 200,000, or 150,000 lbs/hr); and
wherein the gasification zone, and optionally all reaction zones, in the PDX gasifier are operated at a temperature of at least 1000° C. (1100° C., 1200° C., 1250° C., or 1300° C.) and/or not more than 2500° C. (2000° C., 1800° C., or 1600° C.).

In another aspect, the present technology concerns a synthesis gas formed by any method described herein.

In another aspect, the present technology concerns a gasifier injector assembly comprising: a gas outlet having a first annular opening width; and a liquid outlet surrounded by the gas outlet and having a second annular opening width, wherein the second annular opening width is less than the first annular opening width.

In another aspect, the present technology concerns a gasifier unit comprising a reaction chamber; and a gasifier feed injector assembly for injecting at least one gas stream and at least one liquid stream into the reaction chamber, the gasifier feed injector assembly comprising—a gas outlet having a first annular opening width; and a liquid outlet surrounded by the gas outlet and having a second annular opening width, wherein the second annular opening width is less than the first annular opening width.

In another aspect, the present technology concerns a method of producing synthesis gas comprising: introducing an oxidizer gas and a liquefied plastic-containing stream into a reaction chamber of a partial oxidation gasifier, the introducing step comprising—feeding the oxidizer gas through a gas passage defined at least in part by a gas nozzle of a gasifier feed injector assembly, the gas nozzle having a first annular opening width; feeding the liquefied plastic-containing stream through a liquid passage defined at least in part by a liquid nozzle of the gasifier feed injector assembly, the liquid nozzle being surrounded by the gas nozzle and having a second annular opening width, wherein the second annular opening width is less than the first annular opening width; and reacting the oxidizer gas and the liquid plastic-containing stream within the reaction chamber to produce the synthesis gas.

In another aspect, the present technology concerns a method of producing synthesis gas comprising: introducing an oxidizer gas and a liquefied plastic-containing stream into a reaction chamber of a partial oxidation gasifier, the introducing step comprising—feeding the oxidizer gas through a gas outlet of a gas nozzle of a gasifier feed injector assembly, feeding the liquefied plastic-containing stream through a liquid outlet of a liquid nozzle of the gasifier feed injector assembly, the liquid outlet being surrounded by the gas outlet, wherein the velocity of the liquefied plastic-containing stream exiting the liquid outlet is greater than the velocity of the oxidizer gas exiting the gas outlet; and reacting the oxidizer gas and the liquefied plastic-containing stream within the reaction chamber to produce the synthesis gas.

In another aspect, the present technology concerns a method of producing synthesis gas comprising: introducing a liquefied plastic and an oxidizing gas through a gasifier feed injector assembly and into a reaction chamber of a partial oxidation gasifier; and partially oxidizing at least a portion of the liquefied plastic in the reaction chamber to produce the synthesis gas.

In one embodiment or in combination with any embodiment mentioned herein the present technology may further comprise one or more of the following:
wherein the gas nozzle and the liquid nozzle (or gas outlet and liquid outlet) together comprise a multi-lumen injector nozzle;
wherein at least one of the gas nozzle and the liquid nozzle are selectively adjustable to vary a dimension of at least one of the outlets thereby affecting a flow characteristic of at least one of the first oxidizer gas stream and the plastic stream;
further comprising adjusting the dimension of at least one of the outlets;
wherein the adjustment is automatically performed (or the nozzle(s) is/are adjustable) based at least in part on sensor output;
wherein the sensor output reflects at least one of: a viscosity of the plastic stream, a composition of the synthesis gas, a composition of the plastic stream, a flow rate of the plastic or oxidizer stream, etc.; wherein a first tubular member defines at least in part one of the gas and the liquid outlets and a second tubular member defines at least in part the other of the gas and the liquid outlets, and at least one of the first and second tubular members comprises a constriction of reduced diameter relative to the remainder of the one of the first and second tubular members;
wherein the one of the first and second tubular members is tapered; wherein the adjustment comprises translatory movement of a first tubular member defining at least in part one of the gas and liquid outlets relative to a second tubular member defining at least in part one other of the gas and liquid outlets;
wherein the translatory movement results in a decrease in the viscosity of (a/the) liquefied plastic stream at the liquid outlet;
wherein the decreased viscosity of the plastic stream is at least 0.1, 1, 2, 5, 10, 15, 20, 25, 30, 35, 40, or 45 poise, but not more than 2500, 2000, 1500, 1000, 750, 500, 250, 100, or 50 poise (measured at 10 radians/second and 350° C.);
wherein the liquefied plastic stream comprises a molten plastic stream;
wherein the liquefied plastic stream comprises a solvated plastic;
wherein the liquefied plastic stream comprises a solvent for the solvated plastic comprising a glycol, an acid, and/or an oil (motor oil, plant based, and/or animal based);
wherein the liquefied plastic stream comprises a depolymerized plastic;
wherein the liquefied plastic stream comprises a depolymerization agent for the depolymerized plastic comprising water, an acid or a strong base;
wherein the first oxidizer gas stream comprises molecular oxygen; further comprising introducing a second gas stream into the partial oxidation gasifier through a second gas outlet surrounded by the liquid outlet;
wherein a composition of the second gas stream is not the same as the first oxidizer gas stream;
wherein the second gas stream includes one or more of oxygen, CO2, steam, and hydrogen;
wherein the second gas stream comprises oxygen;
wherein the liquid passage is configured to conduct a liquefied plastic stream;
wherein the gas outlet is defined at least in part by a first end segment of a first tubular member and the liquid outlet is defined at least in part between the first tubular end segment and a second tubular end segment of a second tubular member;
wherein the gasifier feed injector assembly includes a center lance nozzle surrounded by the liquid nozzle;
wherein the liquid outlet is at least in part defined by a liquid nozzle also defining a liquid passage terminating in the liquid outlet and the liquid passage is configured to conduct liquefied plastic;
wherein the liquefied plastic stream comprises an atomization enhancing fluid;
wherein the atomization enhancing fluid comprises at least one of liquid water and steam;
wherein the liquid gasification feedstock stream comprises liquefied plastic, the liquefied plastic being injected by the injector assembly into the reaction chamber and having a D90 particle droplet size at or below 5 mm at 0.25, 0.5, 0.75, or 1 m from the injector tip of the injector assembly (measured along a central axis A of the the injector assembly);
wherein a linear velocity of the liquid gasification feedstock stream at the injector tip is 1%, 2%, 4%, 6%, 8%, 10%, 25%, 50%, 75%, 100% or 200% greater than the linear velocity of the oxidizer gas stream;
wherein a linear velocity of the liquid gasification feedstock stream at the injector tip is at least 60 m/s, 75 m/s, 100 m/s, 125 m/s, 150 m/s, 175 m/s, or 200 m/s;
wherein the liquefied plastic stream is introduced to the partial oxidation gasifier through the injector nozzle at a velocity sufficient to prevent propagation of a flame front into the injector nozzle;
wherein atomization of the liquefied plastic stream is sufficiently distributed to react and consume substantially all free oxygen within the reaction chamber;
wherein the atomization is sufficiently distributed to provide a mass of char removed from the reaction chamber that is no more than 15%, 12%, 10%, 8%, or 6% of the total mass of the liquefied plastic in the liquefied plastic-containing stream that is fed to the reaction chamber over a predetermined time period during which the gasifier is being operated;
wherein the oxidizer gas stream directly impinges upon the liquefied plastic stream exiting the first outlet to at least partially effect the atomization;
wherein the pressure within the partial oxidation gasifier is at least 0.689, 3.45, 5.17, 6.89, 10.3, 13.8, 17.2, 20.7, 24.1, or 27.6 MPa (100, 500, 750, 1000, 1500, 2000, 2500, 3000, 3500, or 4000 psi) lower than the pressure of the liquefied plastic stream within the injector assembly;
including a first rotation-inducing structure, further comprising—a gas nozzle surrounding the liquid nozzle; the gas nozzle including an inner wall surface comprising a second rotation-inducing structure; the rotation-inducing structures being configured to induce rotation in opposite directions;
including a first rotation-inducing structure, further comprising—a gas nozzle surrounding the liquid nozzle; the gas nozzle including an inner wall surface comprising a second rotation-inducing structure; the rotation-inducing structures being configured to induce spiraling flow in the same direction.

In one aspect, the present technology concerns a method of producing synthesis gas comprising: introducing a liquefied plastic stream into a partial oxidation gasifier through a first outlet of an injector nozzle; atomizing the liquefied plastic stream into a plurality of liquefied plastic droplets; and
performing a partial oxidation reaction with the plurality of liquefied plastic droplets to produce the synthesis gas.

In one embodiment or in combination with any embodiment mentioned herein the present technology may further comprise one or more of the following:
wherein the gas nozzle and the liquid nozzle (or gas outlet and liquid outlet) together comprise a multi-lumen injector nozzle;
wherein at least one of the gas nozzle and the liquid nozzle are selectively adjustable to vary a dimension of at least one of the outlets thereby affecting a flow characteristic of at least one of the first oxidizer gas stream and the plastic stream;
further comprising adjusting the dimension of at least one of the outlets;
wherein the adjustment is automatically performed (or the nozzle(s) is/are adjustable) based at least in part on sensor output;
wherein the sensor output reflects at least one of: a viscosity of the plastic stream, a composition of the synthesis gas, a composition of the plastic stream, a flow rate of the plastic or oxidizer stream, etc.;
wherein a first tubular member defines at least in part one of the gas and the liquid outlets and a second tubular member defines at least in part the other of the gas and the liquid outlets, and at least one of the first and second tubular members comprises a constriction of reduced diameter relative to the remainder of the one of the first and second tubular members;
wherein the one of the first and second tubular members is tapered;
wherein the adjustment comprises translatory movement of a first tubular member defining at least in part one of the gas and liquid outlets relative to a second tubular member defining at least in part one other of the gas and liquid outlets;
wherein the translatory movement results in a decrease in the viscosity of (a/the) liquefied plastic stream at the liquid outlet;
wherein the decreased viscosity of the plastic stream is at least 0.1, 1, 2, 5, 10, 15, 20, 25, 30, 35, 40, or 45 poise, but not more than 2500, 2000, 1500, 1000, 750, 500, 250, 100, or 50 poise (measured at 10 radians/second and 350° C.); wherein the liquefied plastic stream comprises a molten plastic stream;
wherein the liquefied plastic stream comprises a solvated plastic;
wherein the liquefied plastic stream comprises a solvent for the solvated plastic comprising a glycol, an acid, and/or an oil (motor oil, plant based, and/or animal based);
wherein the liquefied plastic stream comprises a depolymerized plastic;
wherein the liquefied plastic stream comprises a depolymerization agent for the depolymerized plastic comprising water, an acid or a strong base;
wherein the first oxidizer gas stream comprises molecular oxygen; further comprising introducing a second gas stream into the partial oxidation gasifier through a second gas outlet surrounded by the liquid outlet wherein a composition of the second gas stream is not the same as the first oxidizer gas stream;
wherein the second gas stream includes one or more of oxygen, CO2, steam, and hydrogen;
wherein the second gas stream comprises oxygen;
wherein the liquid passage is configured to conduct a liquefied plastic stream;
wherein the gas outlet is defined at least in part by a first end segment of a first tubular member and the liquid outlet is defined at least in part between the first tubular end segment and a second tubular end segment of a second tubular member;
wherein the gasifier feed injector assembly includes a center lance nozzle surrounded by the liquid nozzle;
wherein the liquid outlet is at least in part defined by a liquid nozzle also defining a liquid passage terminating in the liquid outlet and the liquid passage is configured to conduct liquefied plastic;
wherein the liquefied plastic stream comprises an atomization enhancing fluid;
wherein the atomization enhancing fluid comprises at least one of liquid water and steam;
wherein the liquid gasification feedstock stream comprises liquefied plastic, the liquefied plastic being injected by the injector assembly into the reaction chamber and having a D90 particle droplet size at or below 5 mm at 0.25, 0.5, 0.75, or 1 m from the injector tip of the injector assembly (measured along a central axis A of the the injector assembly);
wherein a linear velocity of the liquid gasification feedstock stream at the injector tip is 1%, 2%, 4%, 6%, 8%, 10%, 25%, 50%, 75%, 100%, or 200% greater than the linear velocity of the oxidizer gas stream;
wherein a linear velocity of the liquid gasification feedstock stream at the injector tip is at least 60 m/s, 75 m/s, 100 m/s, 125 m/s, 150 m/s, 175 m/s, or 200 m/s;
wherein the liquefied plastic stream is introduced to the partial oxidation gasifier through the injector nozzle at a velocity sufficient to prevent propagation of a flame front into the injector nozzle;
wherein atomization of the liquefied plastic stream is sufficiently distributed to react and consume substantially all free oxygen within the reaction chamber;
wherein the atomization is sufficiently distributed to provide a mass of char removed from the reaction chamber that is no more than 15%, 12%, 10%, 8%, or 6% of the total mass of the liquefied plastic in the liquefied plastic-containing stream that is fed to the reaction chamber over a predetermined time period during which the gasifier is being operated;
wherein the oxidizer gas stream directly impinges upon the liquefied plastic stream exiting the first outlet to at least partially effect the atomization;
wherein the pressure within the partial oxidation gasifier is at least 0.689, 3.45, 5.17, 6.89, 10.3, 13.8, 17.2, 20.7, 24.1, or 27.6 MPa (100, 500, 750, 1000, 1500, 2000, 2500, 3000, 3500, or 4000 psi) lower than the pressure of the liquefied plastic stream within the injector assembly;
including a first rotation-inducing structure, further comprising—a gas nozzle surrounding the liquid nozzle; the gas nozzle including an inner wall surface comprising a second rotation-inducing structure; the rotation-inducing structures being configured to induce rotation in opposite directions; and
including a first rotation-inducing structure, further comprising—a gas nozzle surrounding the liquid nozzle; the gas nozzle including an inner wall surface comprising a second rotation-inducing structure; the rotation-inducing structures being configured to induce spiraling flow in the same direction.

In one aspect, the present technology concerns a gasifier feed injector assembly comprising: a gas nozzle having an inner wall surface and a gas outlet having a first open annular width; a liquid nozzle surrounded by the gas nozzle and having an outer wall surface and at least one passage including a constriction having a minimum dimension, the constriction being configured to increase the shear of a liquid flowing therethrough; the first open annular width being defined as a minimum distance between the gas nozzle inner wall surface and the liquid nozzle outer wall surface, wherein the minimum dimension of the constriction is less than the first open annular width.

In one aspect, the present technology concerns a gasifier unit comprising: a reaction chamber; and a gasifier feed injector assembly for injecting at least one gas stream and at least one liquid stream into the reaction chamber, the gasifier feed injector assembly comprising—a gas nozzle having an inner wall surface and a gas outlet having a first open annular width; a liquid nozzle surrounded by the gas nozzle and having an outer wall surface and at least one passage including a constriction having a minimum dimension, the constriction being configured to increase the shear of a liquid flowing therethrough; the first open annular width being defined as a minimum distance between the gas nozzle inner wall surface and the liquid nozzle outer wall surface, wherein the minimum dimension of the constriction is less than the first open annular width.

In one aspect, the present technology concerns a gasifier unit comprising: a reaction chamber; and a gasifier feed injector assembly for injecting at least one liquid stream into the reaction chamber, the gasifier feed injector assembly comprising a liquid nozzle having an inner wall surface at least partly defining a liquid passage; the inner wall surface comprising a rotation-inducing structure configured to induce rotation in the at least one liquid stream.

In one embodiment or in combination with any embodiment mentioned herein the present technology may further comprise one or more of the following:
wherein the gas nozzle and the liquid nozzle (or gas outlet and liquid outlet) together comprise a multi-lumen injector nozzle;
wherein at least one of the gas nozzle and the liquid nozzle are selectively adjustable to vary a dimension of at least one of the outlets thereby affecting a flow characteristic of at least one of the first oxidizer gas stream and the plastic stream;
further comprising adjusting the dimension of at least one of the outlets;
wherein the adjustment is automatically performed (or the nozzle(s) is/are adjustable) based at least in part on sensor output;
wherein the sensor output reflects at least one of: a viscosity of the plastic stream, a composition of the synthesis gas, a composition of the plastic stream, a flow rate of the plastic or oxidizer stream, etc.;
wherein a first tubular member defines at least in part one of the gas and the liquid outlets and a second tubular member defines at least in part the other of the gas and the liquid outlets, and at least one of the first and second tubular members comprises a constriction of reduced diameter relative to the remainder of the one of the first and second tubular members;
wherein the one of the first and second tubular members is tapered;
wherein the adjustment comprises translatory movement of a first tubular member defining at least in part one of the gas and liquid outlets relative to a second tubular member defining at least in part one other of the gas and liquid outlets;
wherein the translatory movement results in a decrease in the viscosity of (a/the) liquefied plastic stream at the liquid outlet;
wherein the decreased viscosity of the plastic stream is at least 0.1, 1, 2, 5, 10, 15, 20, 25, 30, 35, 40, or 45 poise, but not more than 2500, 2000, 1500, 1000, 750, 500, 250, 100, or 50 poise (measured at 10 radians/second and 350° C.);
wherein the liquefied plastic stream comprises a molten plastic stream;
wherein the liquefied plastic stream comprises a solvated plastic;
wherein the liquefied plastic stream comprises a solvent for the solvated plastic comprising a glycol, an acid, and/or an oil (motor oil, plant based, and/or animal based);
wherein the liquefied plastic stream comprises a depolymerized plastic;
wherein the liquefied plastic stream comprises a depolymerization agent for the depolymerized plastic comprising water, an acid or a strong base;
wherein the first oxidizer gas stream comprises molecular oxygen; further comprising introducing a second gas stream into the partial oxidation gasifier through a second gas outlet surrounded by the liquid outlet;
wherein a composition of the second gas stream is not the same as the first oxidizer gas stream;
wherein the second gas stream includes one or more of oxygen, CO2, steam, and hydrogen;
wherein the second gas stream comprises oxygen;
wherein the liquid passage is configured to conduct a liquefied plastic stream;
wherein the gas outlet is defined at least in part by a first end segment of a first tubular member and the liquid outlet is defined at least in part between the first tubular end segment and a second tubular end segment of a second tubular member;
wherein the gasifier feed injector assembly includes a center lance nozzle surrounded by the liquid nozzle;
wherein the liquid outlet is at least in part defined by a liquid nozzle also defining a liquid passage terminating in the liquid outlet and the liquid passage is configured to conduct liquefied plastic;
wherein the liquefied plastic stream comprises an atomization enhancing fluid;
wherein the atomization enhancing fluid comprises at least one of liquid water and steam;
wherein the liquid gasification feedstock stream comprises liquefied plastic, the liquefied plastic being injected by the injector assembly into the reaction chamber and having a D90 particle droplet size at or below 5 mm at 0.25, 0.5, 0.75 or 1 m from the injector tip of the injector assembly (measured along a central axis A of the the injector assembly);
wherein a linear velocity of the liquid gasification feedstock stream at the injector tip is 1%, 2%, 4%, 6%, 8%, 10%, 100% or 200% greater than the linear velocity of the oxidizer gas stream;
wherein a linear velocity of the liquid gasification feedstock stream at the injector tip is at least 60 m/s, 75 m/s, 100 m/s, 125 m/s, 150 m/s, 175 m/s, or 200 m/s;
wherein the liquefied plastic stream is introduced to the partial oxidation gasifier through the injector nozzle at a velocity sufficient to prevent propagation of a flame front into the injector nozzle;
wherein atomization of the liquefied plastic stream is sufficiently distributed to react and consume substantially all free oxygen within the reaction chamber;
wherein the atomization is sufficiently distributed to provide a mass of char removed from the reaction chamber that is no more than 15%, 12%, 10%, 8%, or 6% of the total mass of the liquefied plastic in the liquefied plastic-containing stream that is fed to the reaction chamber over a predetermined time period;
wherein the oxidizer gas stream directly impinges upon the liquefied plastic stream exiting the first outlet to at least partially effect the atomization;
wherein the pressure within the partial oxidation gasifier is at least 0.689, 3.45, 5.17, 6.89, 10.3, 13.8, 17.2, 20.7, 24.1, or 27.6 MPa (100, 500, 750, 1000, 1500, 2000, 2500, 3000, 3500, or 4000 psi) lower than the pressure of the liquefied plastic stream within the injector assembly;
including a first rotation-inducing structure, further comprising—a gas nozzle surrounding the liquid nozzle; the gas nozzle including an inner wall surface comprising a second rotation-inducing structure; the rotation-inducing structures being configured to induce rotation in opposite directions; and
including a first rotation-inducing structure, further comprising—a gas nozzle surrounding the liquid nozzle; the gas nozzle including an inner wall surface comprising a second rotation-inducing structure; the rotation-inducing structures being configured to induce spiraling flow in the same direction.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the term “atomization enhancing fluid” refers to a liquid or gas operable to reduce viscosity to decrease dispersion energy, or increases energy available to assist dispersion

As used herein, the term “caustic” refers to any basic solution (e.g., strong bases, concentrated weak bases, etc.) that can be used in the technology as a cleaning agent, for killing pathogens, and/or reducing odors.

As used herein, the term “centrifugal density separation” refers to a density separation process where the separation of materials is primarily cause by centrifugal forces.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and propylene) that are useful by themselves and/or are useful as feedstocks to another chemical production process(es).

As used herein, the term “chemical recycling facility” refers to a facility for producing a recycle content product via chemical recycling of waste plastic. A chemical recycling facility can employ one or more of the following steps: (i) preprocessing, (ii) solvolysis, (iii) pyrolysis, (iv) cracking, and/or (v) PDX gasification.

As used herein, the term “co-located” refers to the characteristic of at least two objects being situated on a common physical site, and/or within 1.6 kilometer (one mile) of each other.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the term “conducting” refers to the transport of a material in a batchwise and/or continuous manner.

As used herein, the term “cracking” refers to breaking down complex organic molecules into simpler molecules by the breaking of carbon-carbon bonds.

As used herein, the term “D90” refers to a specified diameter where ninety percent of a distribution of particles has a smaller diameter than the specified diameter and ten percent has a larger diameter than the specified diameter. To ensure that a representative D90 value is obtained, the sample size of the particles should be at least one pound. To determine a D90 for particles in a continuous process, testing should be performed on at least 5 samples that are taken at equal time intervals over at least 24 hours. Testing for D90 is performed using high-speed photography and computer algorithms to generate a particle size distribution. One suitable particle size analyzer for determining D90 values is the Model CPA 4-1 Computerized Particle Analyzer from W.S Tyler of Mentor, Ohio.

As used herein, the term “diameter” means the maximum chord length of a particle (i.e., its largest dimension).

As used herein, the term “density separation process” refers to a process for separating materials based, at least in part, upon the respective densities of the materials. Moreover, the terms “low-density separation stage” and “high-density separation stage” refer to relative density separation processes, wherein the low-density separation has a target separation density less than the target separation density of the high-density separation stage.

As used herein, the term “depleted” refers to having a concentration (on a dry weight basis) of a specific component that is less than the concentration of that component in a reference material or stream.

As used herein, the term “directly derived” refers to having at least one physical component originating from waste plastic.

As used herein, the term “enriched” refers to having a concentration (on a dry weight basis) of a specific component that is greater than the concentration of that component in a reference material or stream.

As used herein, a “gasification feedstock” or “gasifier feed” refers to all components fed into the gasifier except oxygen.

As used herein, the term “halide” refers to a composition comprising a halogen atom bearing a negative charge (i.e., a halide ion).

As used herein, the term “halogen” or “halogens” refers to organic or inorganic compounds, ionic, or elemental species comprising at least one halogen atom.

As used herein, the terms “having,” “has,” and “have” have the same open-ended meaning as “comprising,” “comprises,” and “comprise” provided above.

As used herein, the term “heavy organic methanolysis coproduct” refers to a methanolysis coproduct with a boiling point greater than DMT.

As used herein, the term “heavy organic solvolysis coproduct” refers to a solvolysis coproduct with a boiling point greater than the principal terephthalyl product of the solvolysis facility.

As used herein, the terms “including,” “include,” and “included” have the same open-ended meaning as “comprising,” “comprises,” and “comprise” provided above.

As used herein, the term “indirectly derived” refers to having an assigned recycle content i) that is attributable to waste plastic, but ii) that is not based on having a physical component originating from waste plastic.

As used herein, the term “isolated” refers to the characteristic of an object or objects being by itself or themselves and separate from other materials, in motion or static.

As used herein, the term “light organic methanolysis coproduct” refers to a methanolysis coproduct with a boiling point less than DMT.

As used herein, the term “light organics solvolysis coproduct” refers to a solvolysis coproduct with a boiling point less than the principal terephthalyl product of the solvolysis facility.

As used herein, the term “methanolysis coproduct” refers to any compound withdrawn from a methanolysis facility that is not dimethyl terephthalate (DMT), ethylene glycol (EG), or methanol.

As used herein, the terms “mixed plastic waste” and “MPW” refer to a mixture of at least two types of waste plastics including, but not limited to the following plastic types: polyethylene terephthalate (PET), one or more polyolefins (PO), and polyvinylchloride (PVC).

As used herein, the term “partial oxidation (PDX)” or “PDX” refers to high temperature conversion of a carbon-containing feed into syngas, (carbon monoxide, hydrogen, and carbon dioxide), where the conversion is carried out in the presence of a less than stoichiometric amount of oxygen. The feed to PDX gasification can include solids, liquids, and/or gases.

As used herein, the term “partial oxidation (PDX) reaction” refers to all reactions occurring within a partial oxidation (PDX) gasifier in the conversion of a carbon-containing feed into syngas, including but not limited to partial oxidation, water gas shift, water gas—primary reactions, Boudouard, oxidation, methanation, hydrogen reforming, steam reforming, and carbon dioxide reforming.

As used herein, “PET” means a homopolymer of polyethylene terephthalate, or polyethylene terephthalate modified with modifiers or containing residues or moieties of other than ethylene glycol and terephthalic acid, such as isophthalic acid, 1,4-cyclohexanedicarboxylic acid, diethylene glycol, TMCD (2,2,4,4-tetramethyl-1,3-cyclobutanediol), CHDM (cyclohexanedimethanol), propylene glycol, isosorbide, 1,4-butanediol, 1,3-propane diol, and/or NPG (neopentyl glycol), or polyesters having repeating terephthalate units (and whether or not they contain repeating ethylene glycol based units) and one or more residues or moieties of TMCD (2,2,4,4-tetramethyl-1,3-cyclobutanediol), CHDM (cyclohexanedimethanol), propylene glycol, or NPG (neopentyl glycol), isosorbide, isophthalic acid, 1,4-cyclohexanedicarboxylic acid, 1,4-butanediol, 1,3-propane diol, and/or diethylene glycol, or combinations thereof.

As used herein, the term “overhead” refers to the physical location of a structure that is above a maximum elevation of quantity of particulate plastic solids within an enclosed structure.

As used herein, the term “oxidizing agent” refers to a substance that is capable of oxidizing another substance, such as in the partial oxidation reaction(s) defined herein. The oxidizing agent generally comprises a quantity of molecular oxygen (O2).

As used herein, the term “oxidizing gas” refers to a gaseous compound comprising a quantity of molecular oxygen (O2).

As used herein, the term “partial oxidation (PDX) gasification facility” or “PDX Facility” refers to a facility that includes all equipment, lines, and controls necessary to carry out PDX gasification of waste plastic and feedstocks derived therefrom.

As used herein, the term “partially processed waste plastic” means waste plastic that has been subjected to at least on automated or mechanized sorting, washing, or comminuted step or process. Partially processed waste plastics may originate from, for example, municipal recycling facilities (MRFs) or reclaimers. When partially processed waste plastic is provided to the chemical recycling facility, one or more preprocessing steps may me skipped.

As used herein, the term “PET solvolysis” refers to a reaction by which a polyester terephthalate-containing plastic feed is chemically decomposed in the presence of a solvent to form a principal terephthalyl product and/or a principal glycol product.

As used herein, the term “physical recycling” (also known as “mechanical recycling”) refers to a waste plastic recycling process that includes a step of melting waste plastic and forming the molten plastic into a new intermediate product (e.g., pellets or sheets) and/or a new end product (e.g., bottles). Generally, physical recycling does not substantially change the chemical structure of the plastic, although some degradation is possible.

As used herein, the term “predominantly” means more than 50 percent by weight. For example, a predominantly propane stream, composition, feedstock, or product is a stream, composition, feedstock, or product that contains more than 50 weight percent propane.

As used herein, the term “preprocessing” refers to preparing waste plastic for chemical recycling using one or more of the following steps: (i) comminuting, (ii) particulating, (iii) washing, (iv) drying, and/or (v) separating.

As used herein, the term “pyrolysis” refers to thermal decomposition of one or more organic materials at elevated temperatures in an inert (i.e., substantially oxygen free) atmosphere.

As used herein, the term “pyrolysis char” refers to a carbon-containing composition obtained from pyrolysis that is solid at 200° C. and 1 atm.

As used herein, the term “pyrolysis gas” refers to a composition obtained from pyrolysis that is gaseous at 25° C.

As used herein, the term “pyrolysis heavy waxes” refers to C20+ hydrocarbons obtained from pyrolysis that are not pyrolysis char, pyrolysis gas, or pyrolysis oil.

As used herein, the terms “pyrolysis oil” or “pyoil” refers to a composition obtained from pyrolysis that is liquid at 25° C. and 1 atm.

As used herein, the term “pyrolysis residue” refers to a composition obtained from pyrolysis that is not pyrolysis gas or pyrolysis oil and that comprises predominantly pyrolysis char and pyrolysis heavy waxes.

As used herein, the term “raw syngas” refers to a synthesis gas composition comprising carbon monoxide (CO) and hydrogen (H₂) discharged from a partial oxidation (PDX) gasifier and before any further treatment, for example, by way of scrubbing, shift, or acid gas removal.

As used herein, the term “recycle content” and “r-content” refer to being or comprising a composition that is directly and/or indirectly derived from waste plastic.

As used herein, the term “resin ID code” refers to the set of symbols and associated number (1 through 7) appearing on plastic products that identify the plastic resin out of which the product is made, developed originally in 1988 in the United States but since 2008 has been administered by ASTM International.

As used herein, the term “resin ID code 1” refers to plastic products made from polyethylene terephthalate (PET). Such plastic products may include soft drink bottles, mineral water bottles, juice containers, and cooking oil containers.

As used herein, the term “resin ID code 2” refers to plastic products made from high-density polyethylene (HDPE). Such plastic products may include milk jugs, cleaning agent and laundry detergent containers, shampoo bottles, and soap containers.

As used herein, the term “resin ID code 3” refers to plastic products made from polyvinyl chloride (PVC). Such plastic products may include fruit and sweets trays, plastic packing (bubble foil), and food wrap.

As used herein, the term “resin ID code 4” refers to plastic products made from low-density polyethylene (LDPE). Such plastic products may include shopping bags, light weight bottles, and sacks.

As used herein, the term “resin ID code 5” refers to plastic products made from polypropylene (PP). Such plastic products may include furniture, auto parts, industrial fibers, luggage, and toys.

As used herein, the term “resin ID code 6” refers to plastic products made from polystyrene (PS). Such plastic products may include toys, hard packing, refrigerator trays, cosmetic bags, costume jewelry, CD cases, vending cups, and clamshell containers.

As used herein, the term “resin ID code 7” refers to plastic products made from plastics other than those defined as resin ID codes 1-6, including but not limited to, acrylic, polycarbonate, polyactic fibers, nylon, and fiberglass. Such plastic products may include bottles, headlight lenses, and safety glasses.

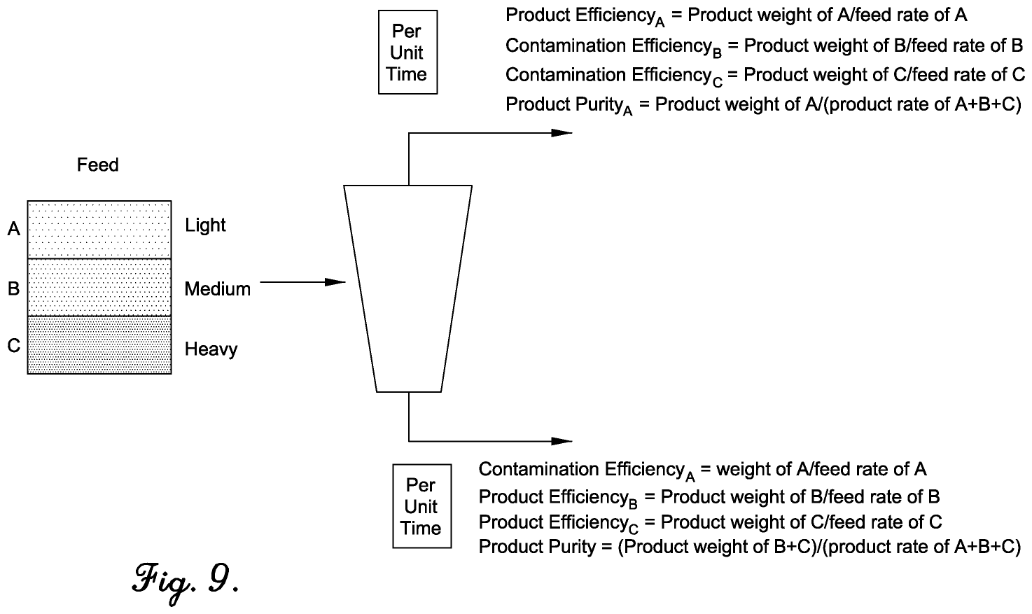

As used herein, the term “separation efficiency” refers to the degree of separation between at two or more phases or components as defined in FIG. 9.

As used herein, the term “sink-float density separation” refers to a density separation process where the separation of materials is primarily caused by floating or sinking in a selected liquid medium.

As used herein, the term “solvolysis” or “ester solvolysis” refers to a reaction by which an ester-containing feed is chemically decomposed in the presence of a solvent to form a principal carboxyl product and/or a principal glycol product. Examples of solvolysis include, hydrolysis, alcoholysis, and ammonolysis.

As used herein, the term “solvolysis coproduct” refers to any compound withdrawn from a solvolysis facility that is not the principal carboxyl (terephthalyl) product of the solvolysis facility, the principal glycol product of the solvolysis facility, or the principal solvent fed to the solvolysis facility.

As used herein, the term “terephthalyl” refers to a molecule including the following group:

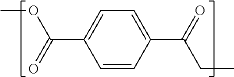

As used herein, the term “principal terephthalyl” refers to the main or key terephthalyl product being recovered from the solvolysis facility.

As used herein, the term “glycol” refers to a component comprising two or more —OH functional groups per molecule.

As used herein, the term “principal glycol” refers to the main glycol product being recovered from the solvolysis facility.

As used herein, the term “target separation density” refers to a density above which materials subjected to a density separation process are preferentially separated into the higher-density output and below which materials are separated in the lower-density output. As used herein, the term “unconverted carbon” refers to the carbon in carbon-containing compounds from the gasifier feed(s) that is not converted to carbon monoxide or carbon dioxide.

As used herein, the terms “waste plastic” and “plastic waste” refer to used, scrap, and/or discarded plastic materials. The waste plastic fed to the chemical recycling facility may be unprocessed or partially processed.

As used herein, the term “unprocessed waste plastic” means waste plastic that has not be subjected to any automated or mechanized sorting, washing, or comminuting. Examples of unprocessed waste plastic include waste plastic collected from household curbside plastic recycling bins or shared community plastic recycling containers.

As used herein, the phrase “at least a portion” includes at least a portion and up to and including the entire amount or time period.

As used herein, the term “waste plastic particulates” refers to waste plastic having a D90 of less than 2.54 cm (1 inch).

As used herein, the term “predominantly” means at least 50 weight percent of something, based on its total weight. For example, a composition comprising “predominantly” component A includes at least 50 weight percent of component A, based on the total weight of the composition.

As used herein, “downstream” means a target unit operation, vessel, or equipment that:
a. is in fluid (liquid or gas) communication, or in piping communication, with an outlet stream from the radiant section of a cracker furnace, optionally through one or more intermediate unit operations, vessels, or equipment, or
b. was in fluid (liquid or gas) communication, or in piping communication, with an outlet stream from the radiant section of a cracker furnace, optionally through one or more intermediate unit operations, vessels, or equipment, provided that the target unit operation, vessel, or equipment remains within the battery limits of the cracker facility (which includes the furnace and all associated downstream separation equipment).

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A raw syngas composition comprising:
not more than 1000 ppmw sulfur;
at least 1000 ppmw of soot and not more than 50,000 ppmw of soot; and
either:
(a) not more than 11% by volume carbon dioxide on a dry basis, or
(b) not more than 5000 ppm by volume methane on a dry basis.

2. A raw syngas composition comprising:
a molar ratio of hydrogen (H₂) to carbon monoxide of 0.7 to 1.5; and
not more than 11% by volume carbon dioxide on a dry basis.

3. A raw syngas composition comprising:
not more than 1000 ppm by volume methane on a dry basis; and
either:
(a) not more than 1000 ppmw sulfur, or
(b) not more than 50,000 ppmw soot.

4. A raw syngas composition comprising:
a molar ratio of hydrogen (H₂) to carbon monoxide of 0.7 to 1.5;
not more than 200 ppmw halides; and
not more than 0.01 ppmw mercury (Hg) and/or not more than 1 ppmw arsine (AsH₃).

5. A raw syngas composition comprising:
not more than 1000 ppm by volume of methane on a dry basis; and
at least 10 ppmw and not more than 200 ppmw antimony on a dry basis and/or at least 5 ppmw and not more than 40,000 ppmw titanium on a dry basis.

6. A raw syngas composition comprising:
at least 1000 ppmw of soot and not more than 50,000 of soot on a dry basis;
at least 10 ppmw and not more than 200 ppmw antimony on a dry basis and/or at least 5 ppmw and not more than 40,000 ppmw titanium on a dry basis; and
not more than 200 ppmw halides.

7. A raw syngas composition comprising:
a molar ratio of hydrogen (H₂) to carbon monoxide of 0.7 to 1.5;
at least 10 ppmw and not more than 200 ppmw antimony on a dry basis and/or at least 5 ppmw and not more than 40,000 ppmw titanium on a dry basis; and
not more than 200 ppmw halides.

8. The raw syngas composition of claim 1, wherein the raw syngas composition comprises from 35 to 55 weight percent carbon monoxide and/or from 32 to 50 weight percent hydrogen (H₂).

9. The raw syngas composition of claim 1, wherein the raw syngas composition comprises at least 1% by volume and/or not more than 18% by volume carbon dioxide on a dry basis.

10. The raw syngas composition of claim 1, wherein the raw syngas composition comprises not more than 5 weight percent of arsine (AsH₃), nitrogen, mercury, and inorganic matter (ash), collectively.

11. The raw syngas composition of claim 4, wherein the raw syngas composition comprises not more than 0.01 ppmw mercury and/or not more than 1 ppmw arsine.

12. The raw syngas composition of claim 1, wherein the raw syngas composition comprises not more than 3000 ppmw of inorganic matter (ash).

13. The raw syngas composition of claim 1, wherein the raw syngas composition comprises not more than 4 weight percent of unconverted carbon components.

14. The raw syngas composition of claim 5, wherein the raw syngas composition comprises not more than 200 ppmw halides.

15. The raw syngas composition of claim 7, wherein the raw syngas composition comprises not more than 1000 ppmw sulfur.

16. The raw syngas composition of claim 2, wherein the raw syngas composition comprises at least 1000 ppmw and/or not more than 50,000 ppmw of soot.

17. The raw syngas composition of claim 1, wherein the raw syngas composition comprises a molar ratio of hydrogen (H₂) to carbon monoxide of 0.7 to 1.5.

18. The raw syngas composition of claim 4, wherein the raw syngas composition comprises not more than 5000 ppm by volume methane on a dry basis.

19. A method of forming a raw syngas composition from a plastic material, the method comprising:
(a) introducing a feedstock comprising said plastic material and molecular oxygen into a partial oxidation (PDX) gasifier; and
(b) performing a partial oxidation reaction, and optionally, one or more side reactions, within said gasifier by reacting at least a portion of said plastic material and molecular oxygen to form the raw syngas composition according to claim 1.

20-21. (canceled)

22. The method of claim 19, wherein said raw syngas composition is discharged from said gasifier at a temperature of 200 to 1500° C. and/or a pressure of 0.101 to 8.27 MPa (gauge) (14.7 to 1200 psig).
